(19) United States
(12) Patent Application Publication
(10) Pub. No.: US 2026/0262141 A1
(43) Pub. Date: Sep. 3, 2026

(54) Wave Energy Systems

(71) Applicant: Foret Plasma Labs, LLC, The Woodlands, TX (US)

(72) Inventor: Todd Foret, The Woodlands, TX (US)

(21) Appl. No.: 19/124,918

(22) PCT Filed: Oct. 30, 2023
(86) PCT No.: PCT/US2023/078254

§ 371 Date: Apr. 28, 2025

Related U.S. Application Data
(60) Provisional application No. 63/420,425, filed on Oct. 28, 2022.

(51) Int. Cl. H05B 6/10; C02F 1/04; C02F 103/08; F23C 99/00; H05B 6/36

(52) U.S. Cl. CPC H05B 6/107; C02F 1/041; F23C 99/001; H05B 6/108; H05B 6/36; C02F 2103/08

(57) ABSTRACT

Many wave energy systems and methods are described herein. For example, an apparatus includes a wave energy source having a cylindrical hole and a cylindrical susceptor at least partially disposed within the cylindrical hole of the wave energy source such that a gap is formed between an outside wall of the cylindrical susceptor and an inside wall of the cylindrical hole. An exterior of the cylindrical susceptor is coated or impregnated with a non-oxidizing material. The wave energy source generates a wave energy, and the cylindrical susceptor absorbs the wave energy and converts the wave energy to heat.

### CROSS-REFERENCE TO RELATED APPLICATIONS

This patent application is a non-provisional patent application of U.S. provisional patent application 63/420,425 filed on Oct. 28, 2022 and entitled “Wave Energy Systems.” All of the foregoing applications are hereby incorporated by reference in their entirety.

### TECHNICAL FIELD OF THE INVENTION

The present invention relates in general to the field of wave energy systems.

### STATEMENT OF FEDERALLY FUNDED RESEARCH

None.

### BACKGROUND OF THE INVENTION

Without limiting the scope of the invention, its background is described in connection with energy systems.

The Electric Power Research Institute (EPRI) has stated in its report titled Grid Frequency Control Using Nuclear Power Plants: Evaluation of Potential Opportunity, “Nuclear power plants (NPPs) have historically been baseload generating units that operate at steady-state, full-rated electrical output. The high capital cost of NPP construction—combined with a low fuel cost—has traditionally made baseload operation the most economic mode of operation. However, with changes in U.S. natural gas prices, as well as ever increasing amount of renewable generation (e.g., wind and solar) worldwide, the need has developed for some NPPs to transition from a baseload to a flexible mode of operation conducive to providing a growing list of reliability services.”

An up and coming reliability service for NPPs is clean hydrogen and clean ammonia. The US has defined “Clean Hydrogen” as hydrogen produced with no greater than 2 kgs of CO₂ per kg of hydrogen. A definition for Clean Ammonia may fall within the same parameters as “Clean Hydrogen”. A modular multi-mode system, method and apparatus for the production of Clean Hydrogen and/or Clean Ammonia while providing Grid Frequency Control with NPPs using natural gas, water or any hydrogen containing molecule would be a windfall for NPPs. In addition, if the same system, method or apparatus could be used for dynamic/regenerative braking for the production of Clean H₂ or Clean NH₃, then that opens the door for energy storage at a point of use, for example subways and trains making hydrogen for use in Fuel Cell Electric Buses.

Likewise, the military in particularly the US Navy and US Army are in dire need of decarbonization. The present invention allows for decarbonization at sea utilizing nuclear power ships and submarines to fuel planes, destroyers, frigates, missiles and even torpedoes with hydrogen and/or ammonia made at sea from nuclear power. This also allows for ship to shore hydrogen use in Army vehicles as well as fueling future aircraft with hydrogen. As the US ARMY transitions to electrification it is in dire need of an Electric Combat Vehicle Tactical Battlefield Recharger (TBR) System.

Although the hydrogen economy is up and coming, if hydrogen cannot be stored onsite, then one particularly ideal use is for the production of silicon from silica. Fracking (“frac”) sand, in particularly Northern White Sand is 99% quartz. If a technology existed for eliminating flaring, by converting flare gas to hydrogen for reducing silica to silicon with hydrogen, then that opens the door for an inexpensive system, method and apparatus for manufacturing silicon. In addition, local production of clean power at any facility, for example a Data Center, can be achieved by cracking a relatively pure hydrocarbon to hydrogen and solid carbon, then reacting the hydrogen with silica to produce silicon and high temperature steam. The steam would then be used to drive a turbine for power production. This allows for a zero carbon emission silicon and power production system, method and apparatus.

For the purposes of this invention pure or relatively pure hydrocarbons include but is not limited to methane, ethane, propane, butane, pentane, hexane, gasoline, diesel and plastics made from ethylene, propylene, polyethylene, polypropylene, etc. and specifically any molecule or mixtures thereof containing only hydrogen and carbon as defined by USPTO's patent classification 585. For the purposes of this invention, “electrical and wave energy” includes radiation as well as wave energy transmitted by various mediums and embraces electromagnetic wave energy or radiation, sonic and supersonic waves, neutron, proton, deutron, and other types of corpuscular radiation. This definition can be found in USPTO's patent classification 204.

For the purposes of this invention dynamic means “change” which includes but is not limited to a change of flow in electrical and wave energy for example, a change of electron flow from DC photovoltaic cells, as well as a change by means of acceleration or deceleration equipment such as a linear electric rail (maglev train), motor/generator, wind turbine, wheels on a vehicle, train, subway, truck, plane and even change of a marine vessel's propeller. Dynamic braking can be rheostatic and regenerative. In rheostatic braking, the energy is dissipated as heat in a resistor. Quite simply, the heat is usually dissipated as wasted energy in the form of hot air. In regenerative braking, the electric power is fed back into the system. However, there is a third type of dynamic braking—plasma dynamic braking (PDB)—in which the electric power is fed to a plasma system, method or apparatus. Plasma is the fourth state of matter and is an infinite conductor. Hence, not being bound by theory, a plasma dynamic brake would not be limited by the amount of current fed to it such as a resistor, batteries or capacitors. Thus, plasma dynamic braking allows for energy storage and also frequency control (load leveling) for both small and large applications. Since plasma is an ionized gas, then selecting appropriate matter that plays a dual role for example forming plasma but also aids in decarbonization is critical to adopting plasma dynamic braking.

The world is in a dire need for decarbonization. This may occur with rapid electrification of transportation and stationary power utilizing battery electric vehicles (BEVs), Fuel Cells (FCs) and Fuel Cell Electric Vehicles (FCEVs). However, therein lies at least four major problems associated with decarbonization or electrification for both transportation and stationary power generation.

First, a lack of crucial components for making batteries exists and one of which is anode graphite. Likewise, graphite can also be used to make carbon-carbon composites to provide high strength and lightweight modes of transportation. Second, a lack of clean hydrogen (no CO₂ emissions) and third, a lack of silicon for producing many devices utilized for electrical devices, such as solar panels and microchips as well as alloys and silicone. The fourth problem is energy storage in the form of batteries or hydrogen. Batteries have a low energy storage density while hydrogen has many problems associated with leaks as well as expensive carbon fiber tanks.

If a process intensification system could be made to produce hydrogen, anode graphite, silicon and steam from a pure or relatively pure molecule containing hydrogen, for example natural gas or water, then that helps push decarbonization forward, while allowing the oil and gas industry to decarbonize, but stay in business. This is a windfall for several major industries-oil and gas, hydrogen, Li ion batteries and silicon.

Methane (Natural Gas) is the fastest path towards reducing CO₂ emissions. Steam Methane Reforming (SMR) is the predominant method for producing hydrogen accounting for about 95%. The other methods such as methane pyrolysis, biomass gasification, splitting water via electrolysis and coal gasification account for the remaining hydrogen production capacity. It is quite obvious that methane will be the predominant molecule of choice for hydrogen production in the near term. However, therein lies the major problem with SMR with respect to decarbonization—to produce one kg of H₂ the process produces 9 kgs of CO₂. It is an energy intensive process. On the other hand, if methane can be cracked with wave energy, in particularly a vacuum UV (VUV) plasma process intensification system then that opens the door for meeting the US's Clean Hydrogen definition of less than 2 kgs of CO₂ per kg of Hydrogen.

“The Amine Experiment: methane photolysis under Solar VUV irradiation on the EXPOSE-R facility of the International Space Station” proved that wave energy, specifically Vacuum UV (VUV) converted methane to hydrogen and carbon via photolysis. In short, methane was exposed to the Sun's extreme Transmitted Power Density (TPD) within the VUV spectrum.

If an apparatus capable of producing VUV could be built for photolysis of methane, then that opens the door for an inexpensive system and clean method for producing hydrogen and graphite. The VUV reactor must be capable of operating with CNG pressures exceeding 248 bars (3,600 psig). Hence, the reactor must produce a vacuum but operate with a pressurized gas or liquid (fluid). Furthermore, the reactor and the system must be capable of taking advantage of an expanding gas, since the synthesis of methane to hydrogen increases the volume by four times. Likewise, the photolytic reactor must be capable of operating at extreme transmitted power densities in order to reduce the footprint of the reactor to drive down the cost. Furthermore, if the reactor were designed to take advantage of an expanding gas or by a greater volume element such as hydrogen, via photolysis of its parent molecule, hence methane, then that opens the door for carbon free cooling. In other words, the device would combine a cracker and a thermal expansion valve into one device. This is a process intensification device with a very high transmitted power density.

The Electric Power Research Institute (EPRI) defines Transmitted Power Density (TPD) as watts per cm² (w/cm²). EPRI's Table 1-3 found in “Rapid Metal Heating: Reducing Energy Consumption and Increasing Productivity in the Thermal Processing of Metals, EPRI, Palo Alto, CA: 2000. TR-114864” is a comparison and contrast of natural gas heating to wave energy sources used for heating purposes: Gas 1 to 10 w/cm², Infrared 1 to 30 w/cm², Induction 5 to 5000 w/cm², Direct Resistance 10 to 10000 w/cm², Plasma 100 to 105 w/cm², Electron Beam 1000 to 109 w/cm², and Laser Beam 10000 to 1015 w/cm². Specifically, EPRI stated that it takes a TPD of about 1,000 w/cm² to melt most metals.

If the World will decarbonize by 2050, the quickest path is using a less intensive carbon containing hydrocarbon that is widely available-natural gas. In addition, the energy used to compress natural gas (CNG) or liquify natural gas (LNG) should be recovered at all costs. If the energy can be recuperated and converted to rotational energy for example with a turbo expander to produce electrical power, this may open the door for a simple, compact and high Net Power Density (NPD) system for making electricity, hydrogen, graphite, silicon and steam with low or zero CO₂ emissions. Herein, Net Power Density (NPD) is defined as:

NPD=TPD×Land Area Generation Power Density (GPD)

General Electric published a White Paper titled “Energy” that gives GPD for several sources. Since, turbo expanders are very compact, the calculated generation power density is greater than Small Modular Reactors (SMR). Consequently, coupling a wave energy source with a high TPD to a generation source with a high GPD that does not emit CO₂ opens the door for production of clean hydrogen, graphite, silicon and steam.

Electrification for both transportation and stationary power generation will require energy storage such as hydro, air compression, thermal and batteries (chemical). The root cause that limits transportation energy storage is not dynamic braking but how it is stored—in batteries. Battery energy storage is limited by: cold temperatures/conditions; a fully charged battery, with no more capacity for a charge; and too much energy to convert that would overload the battery.

Consequently, for both transportation and stationary power generation there exists a need for higher density energy storage means. This is especially true for recovering or regenerating energy from dynamic braking used for transportation for example, electric vehicles and train locomotives. Likewise, if a very compact device with an extreme transmitted power density could be developed for planes, then that opens the door for low or zero carbon aviation. Such a device exists in part and with modifications it can revolutionize hydrogen production via a turbo expander, dynamic braking, plasma magnetohydrodynamic generator or a combination of all three for transportation or stationary power generation. Such a system would allow NPPs to transition from a baseload to a flexible mode of operation conducive to providing a growing list of reliability services, such as producing hydrogen and grid frequency control.

Accordingly, there is a need for wave energy systems.

### SUMMARY OF THE INVENTION

In one embodiment of the present invention, an apparatus includes a wave energy source having a cylindrical hole, and a cylindrical susceptor at least partially disposed within the cylindrical hole of the wave energy source such that a gap is formed between an outside wall of the cylindrical susceptor and an inside wall of the cylindrical hole. An exterior of the cylindrical susceptor is coated or impregnated with a non-oxidizing material. The wave energy source generates a wave energy, and the cylindrical susceptor absorbs the wave energy and converts the wave energy to heat.

In one aspect, a partial hollow bore extends along a longitudinal axis of the cylindrical susceptor such that the cylindrical susceptor is open at a first end and closed at a second end. In another aspect, the first end of the cylindrical susceptor is enlarged. In another aspect, the gap comprises a first gap, and further comprising a pipe, conduit or tube partially inserted into the partial hollow bore of the cylindrical susceptor such that a second gap is formed between an inside of the partial hollow bore and the pipe, conduit or tube, and the pipe, conduit or tube does not extend to a bottom of the partial hollow bore. In another aspect, a fluid is heated by flowing the fluid into and through the pipe, conduit or tube such that the fluid exits the pipe, conduit or pipe near a bottom of the partial hollow bore, and flows through the second gap. In another aspect, the fluid is further heated by flowing the fluid through the first gap. In another aspect, the second end of the cylindrical susceptor comprises a porous tip. In another aspect, the porous tip is within or close to wave energy source; and a fuel is fed into the partial hollow bore, and a combustion air or oxidant is fed axially or in a vortex, whirl or swirl flow through the gap. In another aspect, the combustion air or oxidant is supersonic. In another aspect, a nozzle is attached to the wave energy source. In another aspect, the cylindrical susceptor comprises a first cylindrical susceptor having an enlarged first end, and further comprising a second cylindrical susceptor having an enlarged first end attached to the enlarged end of the first cylindrical susceptor. In another aspect, a nose cone is attached to the first end of the cylindrical susceptor. In another aspect, a full hollow bore extends along a longitudinal axis of the cylindrical susceptor such that the cylindrical susceptor is open at a first end and open at a second end. In another aspect, a rotary drive is coupled to the cylindrical susceptor. In another aspect, a screw feeder or ram feeder is coupled to the first end the cylindrical susceptor. In another aspect, an end piece is attached to the wave energy source such that the second end of the cylindrical susceptor extends into the end piece, wherein the end piece has a bottom outlet, and a gas outlet is connected to the gap. In another aspect, a solid material is fed into the first end of the cylindrical susceptor. In another aspect, the solid material comprises rawmix, sand, silica, metal shavings, pelletized material, wood chips, biomass, biosolids, sludge briquettes, or granular material. In another aspect, the apparatus further includes a column having a top, an upper side outlet, an upper side inlet and a bottom outlet; the wave energy source disposed within, integrated into, or attached to a portion of the column; a riser feeder partially disposed within the column and extending through the top of the column, the riser feeder having a top inlet and a bottom outlet; and the first end of the cylindrical susceptor attached to the bottom outlet of the riser feeder. In another aspect, the wave energy source and the cylindrical susceptor are position within a middle portion of the column or a lower portion of the column. In another aspect, the riser feeder is moveable within the column. In another aspect, the column further comprises a lower side inlet. In another aspect, a heat exchanger is coupled to the upper inlet of the column; and a vapor compressor having an inlet is coupled to the upper outlet of the column and an output coupled to the top inlet of the feeder riser and the heat exchanger. In another aspect, saltwater is fed into the heat exchanger, distilled water exits the heat exchanger, brine exits the lower outlet of the column, and steam exits the upper side outlet of the column. In another aspect, hydrogen is fed into the first end of the cylindrical susceptor, heated by the cylindrical susceptor and exits the porous tip of the cylindrical susceptor; and silica is fed into the gap and reacts with the heated hydrogen to produce steam and silicon.

In another embodiment of the present invention, a method includes providing a wave energy source having a cylindrical hole, and a cylindrical susceptor at least partially disposed within the cylindrical hole of the wave energy source such that a gap is formed between an outside wall of the cylindrical susceptor and an inside wall of the cylindrical hole, wherein an exterior of the cylindrical susceptor is coated or impregnated with a non-oxidizing material; generating a wave energy using the wave energy source; heating the cylindrical susceptor using the wave energy; and heating a gas, liquid or solid using the cylindrical susceptor, the wave energy or both.

In one aspect, the cylindrical susceptor further comprises a partial hollow bore along a longitudinal axis of the cylindrical susceptor such that the cylindrical susceptor is open at a first end and closed at a second end. In another aspect, the first end of the cylindrical susceptor is enlarged. In another aspect, the gap comprises a first gap, and further comprising a pipe, conduit or tube partially inserted into the partial hollow bore of the cylindrical susceptor such that a second gap is formed between an inside of the partial hollow bore and the pipe, conduit or tube, and the pipe, conduit or tube does not extend to a bottom of the partial hollow bore. In another aspect, the fluid is heated by flowing the fluid into and through the pipe, conduit or tube such that the fluid exits the pipe, conduit or pipe near a bottom of the partial hollow bore, and flows through the second gap. In another aspect, the fluid is further heated by flowing the fluid through the first gap. In another aspect, the second end of the cylindrical susceptor comprises a porous tip. In another aspect, the porous tip is within or close to wave energy source; and a fuel is fed into the partial hollow bore, and a combustion air or oxidant is fed axially or in a vortex, whirl or swirl flow through the gap. In another aspect, the combustion air or oxidant is supersonic. In another aspect, a nozzle is attached to the wave energy source. In another aspect, the cylindrical susceptor comprises a first cylindrical susceptor having an enlarged first end, and further comprising a second cylindrical susceptor having an enlarged first end attached to the enlarged end of the first cylindrical susceptor. In another aspect, a nose cone is attached to the first end of the cylindrical susceptor. In another aspect, the cylindrical susceptor further comprises a full hollow bore along a longitudinal axis of the cylindrical susceptor such that the cylindrical susceptor is open at a first end and open at a second end. In another aspect, the method further includes rotating the cylindrical susceptor using a rotary drive coupled to the cylindrical susceptor. In another aspect, the method further includes feeding the solid or a semi-solid into the first end of the cylindrical susceptor using a screw feeder or ram feeder coupled to the first end the cylindrical susceptor. In another aspect, an end piece is attached to the wave energy source such that the second end of the cylindrical susceptor extends into the end piece, wherein the end piece has a bottom outlet; and a gas outlet is connected to the gap. In another aspect, the method further includes feeding a solid material into the first end of the cylindrical susceptor. In another aspect, the solid material comprises rawmix, sand, silica, metal shavings, pelletized material, wood chips, biomass, biosolids, sludge briquettes, or granular material. In another aspect, a column having a top, an upper side outlet, an upper side inlet and a bottom outlet; the wave energy source disposed within, integrated into, or attached to a portion of the column; a riser feeder partially disposed within the column and extending through the top of the column, the riser feeder having a top inlet and a bottom outlet; and the first end of the cylindrical susceptor attached to the bottom outlet of the riser feeder. In another aspect, the wave energy source and the cylindrical susceptor are position within a middle portion of the column or a lower portion of the column. In another aspect, the method further includes moving the riser feeder within the column. In another aspect, the column further comprises a lower side inlet. In another aspect, a heat exchanger is coupled to the upper inlet of the column; and a vapor compressor having an inlet coupled to the upper outlet of the column and an output coupled to the top inlet of the feeder riser and the heat exchanger. In another aspect, saltwater is fed into the heat exchanger, distilled water exits the heat exchanger, brine exits the lower outlet of the column, and steam exits the upper side outlet of the column. In another aspect, the method further includes feeding hydrogen into the first end of the cylindrical susceptor such that the hydrogen is heated by the cylindrical susceptor and exits the porous tip of the cylindrical susceptor; and feeding silica into the gap such that the silica reacts with the heated hydrogen to produce steam and silicon.

In another embodiment of the present invention, a plasma electrolysis apparatus includes a pair of non-conductive conjoined hydrocyclones having a single inlet, an oxidant outlet and a hydrogen outlet, a first side cone side having a first electrically conductive part and a second cone side having a second electrically conductive part.

In one aspect, the first and second electrically conductive parts are wired to opposite polarities of a DC power source. In another aspect, one of the first or second electrically conductive parts is smaller than the other electrically conductive part; or one of the first or second electrically conductive parts is partially coated with an electrically non-conductive material to decrease its electrically conductive surface area as opposed to the other electrically conductive part. In another aspect, the first and second electrically conductive parts comprise a first and second electrically conductive apex valve nuts. In another aspect, the first and second electrically conductive apex valve nuts have electrically conductive threads. In another aspect, the first and second electrically conductive parts comprise a first and second electrically conductive apex valve nozzle inserts. In another aspect, the first and second electrically conductive parts comprise a first and second electrically conductive vortex finder. In another aspect, only interior surfaces of the first and second electrically conductive vortex finders are electrically conductive. In another aspect, the first and second electrically conductive parts comprise a first and second electrically conductive sleeve inserted into the first and second vortex finders. In another aspect, only interior surfaces of the first and second electrically conductive sleeves are electrically conductive.

In another embodiment of the present invention, a method for making hydrogen with plasma electrolysis includes: providing a pair of non-conductive conjoined hydrocyclones having an oxidant outlet and a hydrogen outlet, a first side cone side having a first electrically conductive part and a second cone side having a second electrically conductive part; connecting the first and second electrically conductive parts to opposite polarities of a DC power source; flowing a fluid into the single inlet; and producing hydrogen and oxidants from the fluid using the plasma electrolysis from one of the electrically conductive parts as a cathode (−) and the other of the electrically conductive parts as an anode (+).

In one aspect, the first and second electrically conductive parts are wired to opposite polarities of a DC power source. In another aspect, one of the first or second electrically conductive parts is smaller than the other electrically conductive part; or one of the first or second electrically conductive parts is partially coated with an electrically non-conductive material to decrease its electrically conductive surface area as opposed to the other electrically conductive part. In another aspect, the first and second electrically conductive parts comprise a first and second electrically conductive apex valve nuts. In another aspect, the first and second electrically conductive apex valve nuts have electrically conductive threads. In another aspect, the first and second electrically conductive parts comprise a first and second electrically conductive apex valve nozzle inserts. In another aspect, the first and second electrically conductive parts comprise a first and second electrically conductive vortex finder. In another aspect, only interior surfaces of the first and second electrically conductive vortex finders are electrically conductive. In another aspect, the first and second electrically conductive parts comprise a first and second electrically conductive sleeve inserted into the first and second vortex finders. In another aspect, only interior surfaces of the first and second electrically conductive sleeves are electrically conductive.

In another embodiment of the present invention, an offshore wind turbine power system for providing virtual inertia while producing hydrogen includes: a first riser partially filled with media covering an anode electrode; a second riser partially filled with media covering a cathode electrode; a water conduit connecting the first riser anode electrode to the second riser cathode electrode; an AC power to DC power inverter; one or more solar panels connected to the anode electrode and the cathode electrode; wherein energizing the DC circuit produces a hydrogen on the cathode electrode and produces an oxidant on the anode electrode; and virtual inertia is applied to a wind turbine of the wind power system.

In another embodiment of the present invention, a power flex mode system for providing virtual inertia while producing hydrogen includes: a first well partially filled with media covering an anode electrode; a second well partially filled with media covering a cathode electrode; a water conduit connecting the first well anode electrode to the second well cathode electrode; an AC power to DC power inverter; one or more solar panels connected to the anode electrode and the cathode electrode; and wherein energizing the DC circuit produces a hydrogen on the cathode electrode and produces an oxidant is on the anode electrode.

In another embodiment of the present invention, a solar power system for providing virtual inertia while producing hydrogen includes: a first well partially filled with media covering an anode electrode; a second well partially filled with media covering a cathode electrode; a water conduit connecting the first well anode electrode to the second well cathode electrode; one or more solar panels connected to the first well anode electrode and the second well cathode electrode; and wherein energizing the DC circuit produces a hydrogen on the cathode electrode and produces an oxidant on the anode electrode.

Other embodiments are described in the detailed description and illustrated in the figures.

Note that the invention is not limited to the embodiments described herein, instead it has the applicability beyond the embodiments described herein. The brief and detailed descriptions of this disclosure are given in the following.

### BRIEF DESCRIPTION OF THE DRAWINGS

For a more complete understanding of the features and advantages of the present invention, reference is now made to the detailed description of the invention along with the accompanying figures and in which:

FIG. 1A is a cross-sectional side view of an induction heater in accordance with one embodiment of the present invention;

FIG. 1B is a cross-sectional side view of a single pass or double pass induction heater in accordance with one embodiment of the present invention;

FIG. 1C is a cross-sectional side view of a thermal oxidizer supersonic combustor in accordance with one embodiment of the present invention;

FIGS. 1D and 1E are cross-sectional side views of an aerospike supersonic combustor in accordance with one embodiment of the present invention;

FIG. 2A is a cross-sectional side view of a rotary full-bore susceptor in accordance with one embodiment of the present invention;

FIG. 2B is a cross-sectional side view of a screw feeder inductively coupled rotary heater in accordance with one embodiment of the present invention;

FIG. 2C is a cross-sectional side view of push rod feeder inductively coupled heater in accordance with one embodiment of the present invention;

FIGS. 3A, 3B and 3C are cross-sectional side views of vertical induction crackers in accordance with various embodiments of the present invention;

FIG. 3D is a cross-sectional side view of a silica to silicon induction furnace in accordance with one embodiment of the present invention;

FIG. 3E is a cross-sectional side view of a desalination system in accordance with one embodiment of the present invention;

FIGS. 4A, 4B, 4C, 4D, 4E and 4F are a flow charts of a various methods for heating matter with wave energy in accordance with various embodiments of the present invention;

FIGS. 5A, 5B, 5C and 5D are cross-sectionals view of a virtual inertia wave energy regenerative braking load apparatus in accordance with various embodiments of the present invention;

FIGS. 6A, 6B, 6C, 6D and 6E are diagrams of virtual inertia plasma electrolysis riser systems in accordance with various embodiments of the present invention;

FIGS. 7A and 7B are cross-sectional side views of wave energy susceptor plasma ArcWhirl® reactors in accordance with various embodiments of the present invention;

FIGS. 8A and 8B are cross-sectional views of a virtual inertia DC regulation single and double plasma electrolysis systems in accordance with various embodiments of the present invention;

FIG. 9 is a cross-sectional view of a virtual inertia DC regulation dual susceptor plasma electrolysis system in accordance with one embodiment of the present invention;

FIGS. 10A and 10B are cross-sectional views of twin whirl plasma electrolysis systems for producing green hydrogen in accordance with various embodiments of the present invention;

FIGS. 10C and 10D are cross-sectional views showing the electrode surface area for the plasma electrolysis system for producing green hydrogen in accordance with various embodiments of the present invention;

FIGS. 11A, 11B and 11C are cross-sectional views of flex mode twin whirl plasma electrolysis system for producing green hydrogen in accordance with various embodiments of the present invention;

FIGS. 12A and 12B are diagrams for virtual DC regulation plasma electrolysis systems for producing green hydrogen in accordance with various embodiments of the present invention;

FIGS. 13A, 13B, 13C and 13D are diagrams for dynamic plasma braking systems in accordance with various embodiment of the present invention;

FIGS. 14A, 14B, 14C, 14D and 14E are diagrams for plasma crackers in accordance with various embodiments of the present invention;

FIG. 15 is a diagram of dual wave energy systems for hydrogen production in accordance with one embodiment of the present invention;

FIGS. 16A and 16B are diagrams of high temperature plasma electrolysis cell systems in accordance with various embodiments of the present invention;

FIG. 17 is a diagram of a CNG/LNG/LPG wave energy and turboexpander generator system in accordance with one embodiment of the present invention;

FIGS. 18A, 18B, 18C and 18D are diagrams of CNG/LNG to hydrogen conversion systems in accordance with various embodiments of the present invention;

FIGS. 19A, 19B and 19C are diagrams of PlasmaWhirl® MHD generator/rectifier and hydrogen production systems in accordance with various embodiments of the present invention;

FIGS. 20A, 20B, 20C, 20D, 20E, 20F, 20G, 20H and 20i are diagrams of radial disc plasma ArcWhirl® MHD generator and hydrogen production systems in accordance with various embodiments of the present invention;

FIGS. 21A and 21B are diagrams of onboard direct coupled transaxle recuperator electric assisted dynamic plasma brake systems in accordance with various embodiments of the present invention;

FIGS. 22A, 22B and 22C are diagrams of onboard indirect coupled transaxle recuperator electric assisted dynamic (TREAD™) plasma brake systems in accordance with various embodiments of the present invention;

FIG. 23 is a diagram of an internal combustion engine with TREAD™ plasma brake system for zero CO₂ emissions in accordance with one embodiment of the present invention; and

FIGS. 24A, 24B and 24C are diagrams of wave energy systems in accordance with various embodiments of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. Note that the size of the components shown in the figures is not to scale and does not limit the present invention in any way. The size of the components can be varied to satisfy the specific requirements of the intended use of the particular embodiments of the present invention. Moreover, the orientation or location of the components can vary in some circumstances

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various methods are described below to provide an example of each claimed embodiment. They do not limit any claimed embodiment. Any claimed embodiment may cover methods that are different from those described above and below. The drawings and descriptions are for illustrative, rather than restrictive, purposes.

Some of the figures and technologies described herein as prior art may not be prior art when a claim of priority is made to the inventor's pending application(s) upon filing one or more non-provisional patent applications.

The term “wave energy” is used herein to include radiation as well as wave energies transmitted by various mediums, and embraces electromagnetic waves or radiations; sonic, supersonic, and ultrasonic waves; and neutrons, protons, deuteron, and other corpuscular radiations. The term “electromagnetic waves” (also commonly referred to as electromagnetic radiation (“EMR”)) includes, e.g., X-ray and gamma-ray, ultraviolet, infrared, visible light rays, microwave, and both short electric and radio waves. The present invention can be operated in many different modes for treating substances. A partial list of applications for treating matter range from infrared and induction heating to chemical conversion. The term “chemical conversion” as used herein includes the terms splitting, photolysis, electrolysis, plasma electrolysis, thermolysis, cracking, reforming, gasification, combustion, oxidation, reduction, etc. Simply put a chemical conversion with respect to the present invention means a “chemical reaction.”

The term “photolytic fission” is used herein to include either homolytic fission (in the case of like atoms, such as in H₂) or heterolytic fission (in the case of dissimilar atoms, such as in CH₄ or H₂O), as applicable. It will be appreciated to those of ordinary skill that the invention may be applied to any number of other environments where the fluid to be treated is something other than hydrogen, methane or water, and that the operational parameters of the invention may be altered to suit the particular needs of the fluid being treated. However, for the sake of simplicity, the remainder of this disclosure will provide a detailed explanation of the invention as applied to treating natural gas, in particularly methane as well as water and metal oxides with a wave energy dynamic braking system, method and apparatus for producing hydrogen and silicon that can also be applied as a virtual grid inertia stabilization system.

The term Molecule Containing Hydrogen includes any molecule that contains hydrogen. Examples are hydrocarbons, water (H₂O), ammonia (NH₃)

The term “susceptor” is used herein to include any material that will absorb wave energy and in particularly electromagnetic energy.

### Susceptor and Induction Heater

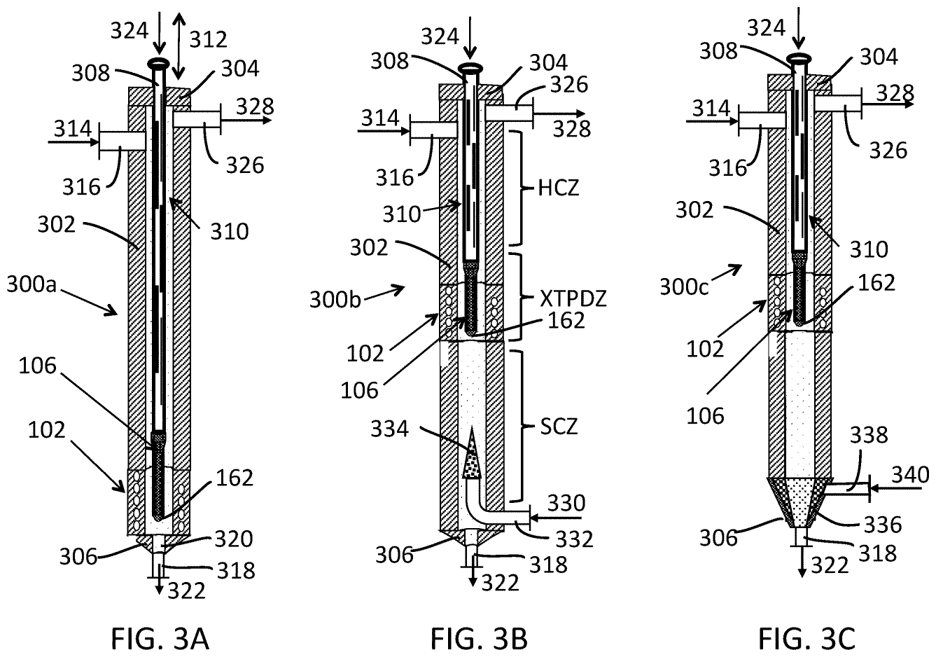

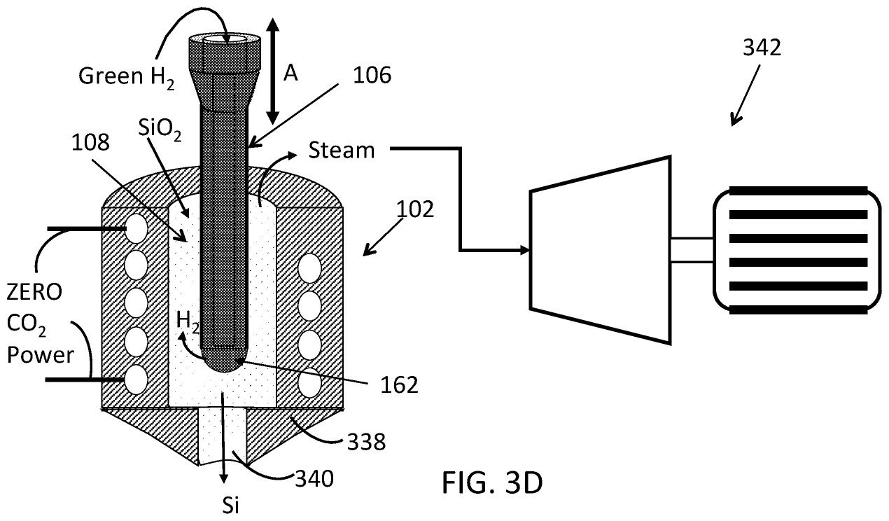

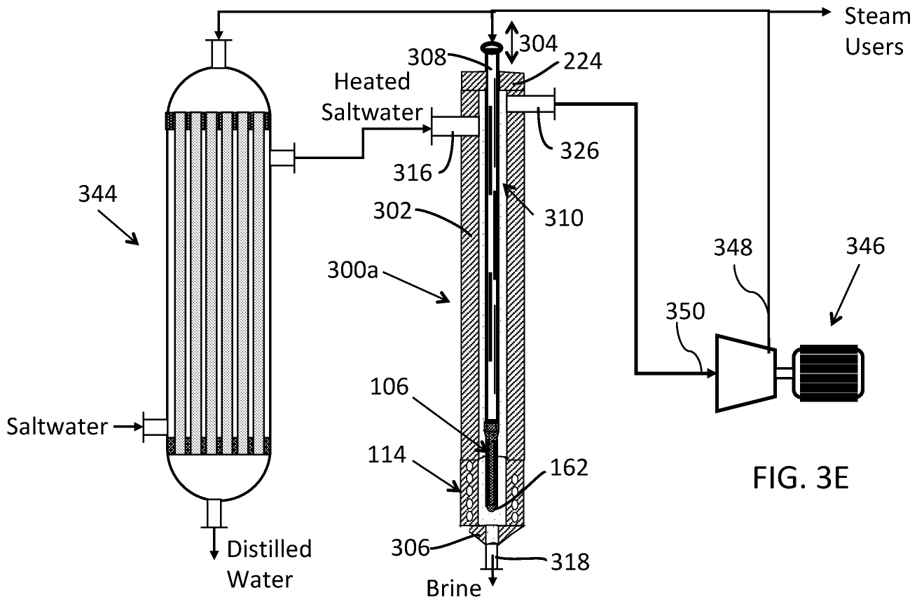

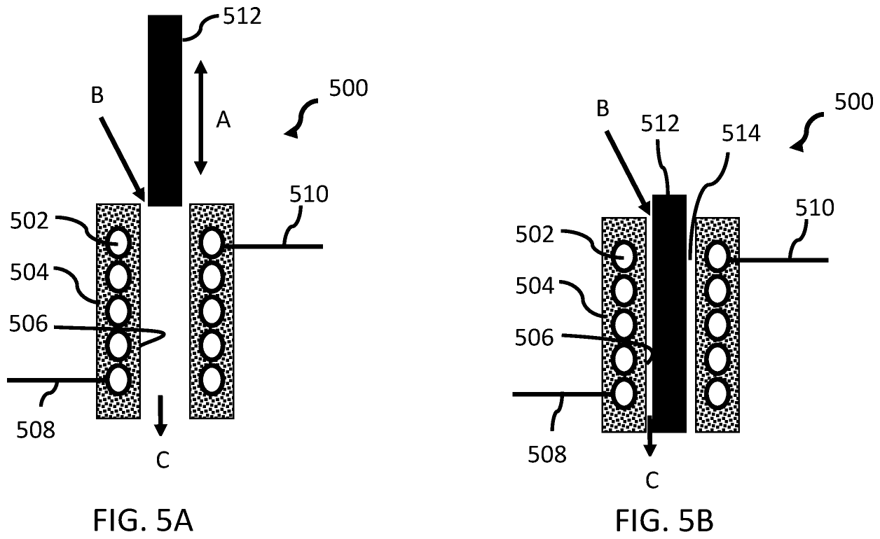

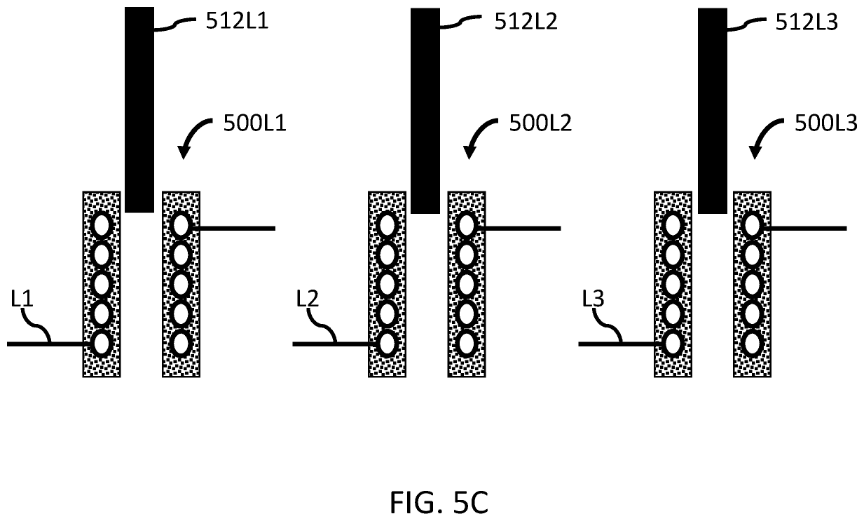

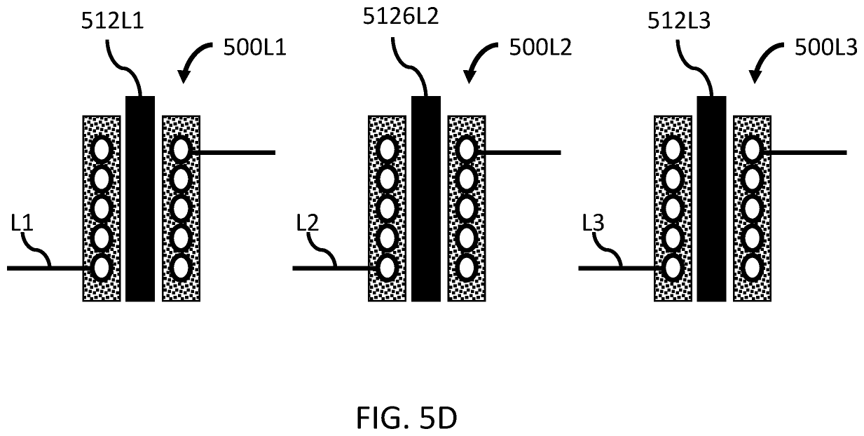

Exemplary wave energy systems, methods and apparatuses for carrying out the present invention are found in some of the present inventor's patents, such as U.S. Pat. Nos. 10,638,592, 10,472,572, 10,368,557, 10,098,191, 10,030,195, 9,869,277, 9,446,371, 9,445,488, 9,241,396, 8,904,749, 8,796,581, 8,785,808, 8,329,044, and 7,422,695, which are hereby incorporated by reference in their entirety. More specifically, U.S. Pat. No. 8,796,581 discloses an inductively coupled PlasmaWhirl® reactor (see e.g., FIG. 3). A susceptor can be inserted into the reactor. However, selecting an ideal susceptor has been a major problem in the past. For example, many inductively coupled plasma (ICP) torches utilize tungsten. Yet, tungsten will erode in an oxidizing atmosphere. Likewise, graphite will begin to oxidize at very medium temperatures, for example between temperatures ranging from 500° C. to 800° C. For example, FIG. 5 of U.S. Pat. No. 10,472,572 utilizes a graphite tube, which will oxidize when exposed to any oxidant. Consequently, a need exists for a susceptor that can operate at elevated temperatures yet not sublime nor oxidize.

Vertically moveable stopper rods are used within the foundry industry to control the molten metal flow rate within a continuous casting machine. The present inventor discovered that that a semi-conductor material commonly referred to as a stopper rod can be used as a direct replacement for the carbon electrodes used in some of the inventor's systems, such as U.S. Pat. Nos. 8,796,581 and 10,472,572. Non-limiting examples of stopper rods that can be used in the present invention are disclosed in U.S. Pat. Nos. 7,198,181, 6,913,730 and 6,367,671. Likewise, Vesuvius's Roto-Rod is another stopper rod that can be used in the present invention. Vesuvius has patented several stopper rods with novel coatings that make the graphite stopper rod non-conductive and wear resistance. U.S. Pat. No. 7,198,181 discloses a hole at the tip of the stopper rod for injecting a fluid into metal. U.S. Pat. No. 4,791,978 discloses a gas permeable stopper rod. U.S. Pat. No. 3,848,072 discloses the use of a stopper rod as a resistance heating element for molten metal within a pouring ladle. U.S. Pat. No. 3,848,072 does not disclose the use of a stopper rod as a susceptor for induction heating. All of the foregoing patents are hereby incorporated by reference in their entirety.

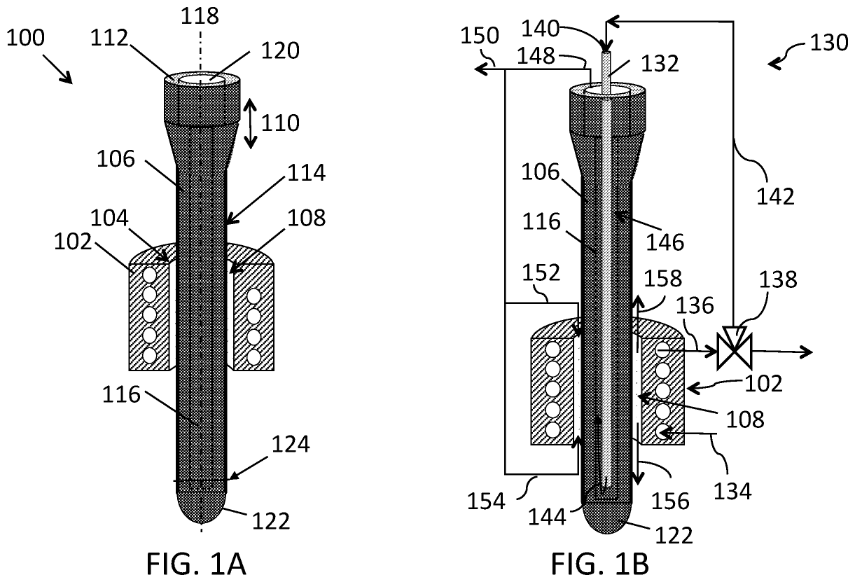

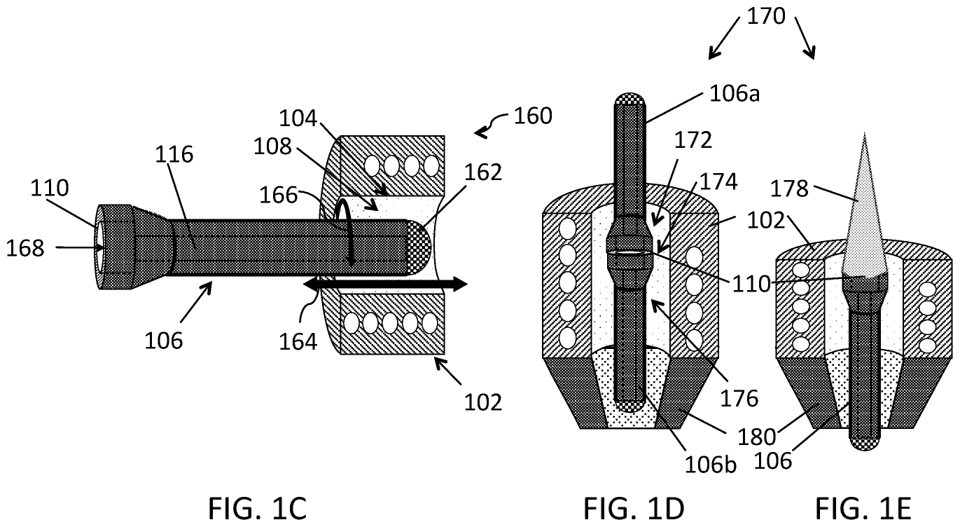

Now referring to FIG. 1A, a cross-sectional side view of an induction heater 100 in accordance with one embodiment of the present invention is shown. The induction heater 100 includes a wave energy source 102, such as a ceramic potted radio frequency (RF) induction coil, having a cylindrical hole 104, and a cylindrical susceptor 106 (also referred to as a stopper rod) at least partially disposed within the cylindrical hole 104 such that a gap 108 is formed between an outside wall of the susceptor 106 and an inside wall of the cylindrical hole 104. The wave energy source 102 generates a wave energy, and the susceptor 106 absorbs the wave energy and converts the wave energy to heat. Note that different frequencies of wave energy, such as radio waves, microwaves, etc., can be used. In some embodiments, the susceptor 106 can be moved in and out of the wave energy source 102 as shown by arrows 110.

In this embodiment, the susceptor 106 has a ceramic graphite composite body 112 coated or impregnated with a non-oxidizing material (e.g., glaze or coating) 114 and a non-continuous or partial hollow bore 116 along a longitudinal axis 118 that is open at a first end 120 and is capped or closed at a second end 122. Note that the susceptor 106 or other susceptors described herein are not limited to the shapes shown in the figures. For example, the susceptor 106 or other susceptors described herein can be entirely cylindrical without the enlarged first end 120. In other embodiments described herein, the second end 122 can be porous or open by cutting off the closed end as indicated by line 124. The susceptor 106 can be made of other materials, but the susceptor 106 should be capable of heating by absorbing wave energy and the exterior should be resistant to oxidation. As will be explained in more detail below, the induction heater 100 has many configurations and uses.

### Stopper Rod Susceptor Testing

Various types of susceptors were tested by electrically connecting an Ambrell 50 kw EkoHeat induction power supply to a RF induction coil. The power supply was set at 25.0 kw, 334 volts AC and a frequency of 22 kHz. A stopper rod as described above was used as the susceptor 100, which resulted in 99% coupling match between the induction coil or wave energy source 102 and the stopper rod susceptor 106. The stopper rod susceptor 106 was instantly heated to yellow hot. This clearly demonstrated that the stopper rod susceptor 106, which was made of 25% carbon, 70% alumina and 5% binder, such as sodium silicate and or calcium aluminate, readily couples to the RF field. Next, the power supply voltage applied to the workhead (not shown) was increased from 334 volts AC to 380 volts AC, which instantaneously increased the power input from 25 kw to 35 kw. Once again the percent match was 99%. Thereafter, the power supply voltage was decreased to 280 volts AC, which resulted in an input power of 20.2 kw at a frequency of 22 kHz for a match of 99%. As previously described, the stopper rod susceptor 106 has a ceramic glaze to prevent oxidation. Typical graphite electrodes will oxidize when placed within an induction coil and an oxidant contacts the graphite. Consequently, the stopper rod susceptor 106 gives rise to a high temperature gas heater that can be operated in an oxidizing or reducing environment.

Prior to testing with the stopper rod susceptor 106, a 6″ electric arc graphite electrode with a machined thru-bore was used as the rotary tube for the rotary induction kiln. In contrast to the stopper rod susceptor 106, the highest coupling efficiency for the graphite rotary tube was at a power of 30 kw, 380 volts AC and frequency of 21 kHz for a coupling match of 92%, as shown in the fourth test. In addition, the graphite tube oxidized at all power levels. The silicon carbide SiC tube began to bubble and fall apart and never achieved greater than 51% match. The test results from the three types of susceptors are shown below in TABLE 1. Note that only the stopper rod susceptor 106 achieved a 99% match as a rotary tube. Likewise, the stopper rod susceptor 106 did not oxidize on the outside as did the graphite tube, nor did it bubble up as did the silicon carbide susceptor did.

TABLE 1
Susceptor Test Results

| Material/Configuration | KW | VAC | KHz | % Match |
|---|---|---|---|---|
| Graphite Rotary (GR) | 20.1 | 312 | 21 | 85 |
| Graphite Rotary | 30.3 | 383 | 21 | 91 |
| Graphite Rotary | 20.1 | 305 | 21 | 85 |
| Graphite Rotary | 30.0 | 380 | 21 | 92 |
| Graphite Crucible (GC) | 44.7 | 458 | 22 | 100 |
| Graphite Crucible | 15.3 | 250 | 22 | 87 |
| Graphite Crucible | 20.1 | 290 | 22 | 91 |
| Graphite Crucible | 18.0 | 270 | 22 | 91 |
| Graphite Crucible | 15.0 | 243 | 22 | 89 |
| Graphite Crucible | 14.0 | 234 | 22 | 88 |
| Graphite Crucible | 13.0 | 224 | 22 | 88 |
| Silicon Carbide (SiC) | 14.0 | 508 | 22 | 41 |
| Silicon Carbide Rotary | 7.1 | 350 | 22 | 40 |
| Silicon Carbide Rotary | 8.0 | 374 | 22 | 40 |
| Silicon Carbide Rotary | 7.0 | 346 | 22 | 40 |
| Silicon Carbide Rotary | 5.0 | 261 | 19 | 45 |
| Silicon Carbide Rotary | 6.0 | 306 | 19 | 44 |
| Silicon Carbide Rotary | 7.0 | 338 | 19 | 42 |
| Silicon Carbide Rotary | 8.0 | 353 | 19 | 45 |
| Silicon Carbide Rotary | 10.1 | 243 | 19 | 51 |
| Graphite Crucible | 6.01 | 138 | 22 | 95 |
| Graphite Crucible | 23.4 | 303 | 22 | 103 |
| Graphite Crucible | 18.2 | 261 | 22 | 99 |
| SiC Crucible | 18.0 | 500 | 19 | 46 |
| SiC Crucible | 9.0 | 338 | 19 | 46 |
| SiC Crucible | 10.1 | 360 | 19 | 47 |
| Stopper Rod Rotary | 25.0 | 334 | 22 | 99 |
| Stopper Rod Rotary | 35.0 | 380 | 22 | 99 |
| Stopper Rod Rotary | 20.2 | 280 | 22 | 99 |

The stopper rod susceptor 106 gave completely unexpected results for use as a RF susceptor when placed within the induction coil. This is especially true given the composition of the stopper rod tested as shown in TABLE 2 below (Vesuvius ROTO-ROD (BA11466) Safety Data Sheet (SDS) Number SDS-30855 Section 3), which lends more to its use as a high temperature ceramic matrix resistor or insulator in lieu of an electrical conductor. It is well known and understood that induction heating requires the use of an electrically conductive material. However, a higher resistive electrically conductive material is easier to heat with induction in comparison to copper or aluminum. Both the graphite and silicon carbide susceptors in the aforementioned tests are considered electrical conductors.

TABLE 2
Stopper Rod Composition

| Ingredient | CAS No./Other Identifiers | % Weight |
|---|---|---|
| Fused Silica | 60676-86-0 | 2-8 |
| Coke | 64743-04-0 | 7-14 |
| Graphite | 7782-42-5 | 12-20 |
| Quartz, Crystalline Silica | 14808-60-7 | 0.1-1 |
| Aluminum Oxide, non-fibrous | 1344-28-1 | 50-60 |
| Zirconium Oxide | 1314-23-4 | 3-7 |
| Aluminosilicate | 7440-21-3 | 3-7 |
| Silicon | 7440-21-3 | 0.1-1 |
| Spinel | 12068-51-8 | 0.1-3 |

In addition, the % match of the stopper rod susceptor 106 was unexpected by the present inventor. Until all examples shown in TABLE 1 were plotted, the present inventor did not realize that the stopper rod susceptor outperformed the graphite tube. Furthermore, when comparing and contrasting the components of the stopper rod composition as shown in TABLE 2, it is completely unexpected for the stopper rod susceptor to outperform a 100% graphite susceptor. Consequently, this unobvious use for a refractory stopper rod as an induction susceptor or as an electrode within a half-cell, lends itself to many useful systems, methods or devices that can be operated in multi-modes, such as induction heating, supersonic combustion, pyrolysis, cracking, plasma, electrolysis, plasma electrolysis, glow discharge or an electric arc.

The second end 122 of a Roto-Rod stopper rod was cut off to produce a full-bore susceptor. The outside of the full-bore susceptor was tested for electrical conductivity with a multi-meter and it tested as an electrical insulator. However, the meter showed that the inside of the full-bore susceptor was electrically conductive. This is because the Roto-Rod stopper rod is covered with a very high temperature ceramic glaze, which is resistive to electrical current flow and thus acts as a resistor or actually as a transistor when placed within an electrical circuit, in particularly a magnetic field.

### Single Pass or Double Pass Induction Heater

Now referring to FIG. 1B, a single pass or double pass induction heater 130 is shown in accordance with one embodiment of the present invention. The signal or double pass induction heater 130 includes a wave energy source 102 and a susceptor 106 as previously described in reference to FIG. 1A. In this non-limiting example, the partial hollow bore 116 extends to about 10 cm from the second end 122. A pipe, conduit or tube 132 is inserted in the partial bore 116 such that the pipe, conduit or tube 132 does not extend to a bottom of the partial hollow bore 116. If superheated steam or steam plasma is used as the heating media, then cooling water as shown by arrow 134 enters the wave energy source 102 and heats up and exits the coil as shown by arrow 136 into valve 138. Valve 138 diverts the heated water into an inlet 140 of the pipe, conduit or tube 132 via line 142. Fluid flows into the pipe, conduit or tube 132 then exits the pipe, conduit or tube 132 near the end of the partial bore 116 as shown by arrow 144 and traverses back through a second gap 146 formed between the inside of the partial hollow bore 116 and the pipe or conduit or tube 132. Fluid then exits the partial hollow bore 116 of the susceptor 106 as shown by line 148 and can flow outside the system as shown by arrow 150 (single-pass induction heating), or can enter into the first gap 108 as shown by arrows 152 and/or 154 formed between the susceptor 106 and the wave energy source 102 (double-pass induction heating). The resulting vapor exits the first gap 108 as shown by arrows 156 and/or 158.

Fluids can be heated and flashed to vapors within the partial bore 116 of the susceptor 106 at a low temperature in order to not oxidize nor react with the graphite. However, when the vapor enters into the very high temperature within the first gap 108 formed between the susceptor 106 and the wave energy source 102, it will not react with the susceptor 106 due to the glazed ceramic lining on the exterior of the susceptor 106. The apparatus of FIG. 1B can be used as a combustor, burner and/or steam methane reformer.

### Thermal Oxidizer or Supersonic Combustor

Referring now to FIG. 1C, a thermal oxidizer or supersonic combustor 160 is shown in accordance with one embodiment of the present invention, which can be used as a gas cracker, hydrogen combustor for industrial heating applications, thermal oxidizer, and supersonic combustor for use as a scramjet engine. The susceptor 106 has a partial hollow bore 116 and a porous tip or nose section 162. The susceptor 106 is placed in the cylindrical hole 104 of the wave energy source 102 such that the porous tip 162 is within and/or close to the RF field. It will be understood that the porous tip 162 can be cut off to increase gas or combustion airflow. Atmospheric air or any oxidant flows into the gap 108 either axially as shown by arrow 164 or in a vortex, whirl or swirl flow as shown by curved arrow 166. Axial flow of air, oxidants or gases, such as landfill gas, natural gas, propane, butane, ethane, hydrogen and even liquids, can be flowed in either direction based upon the orientation and construction of the entire assembly 160 for a given application.

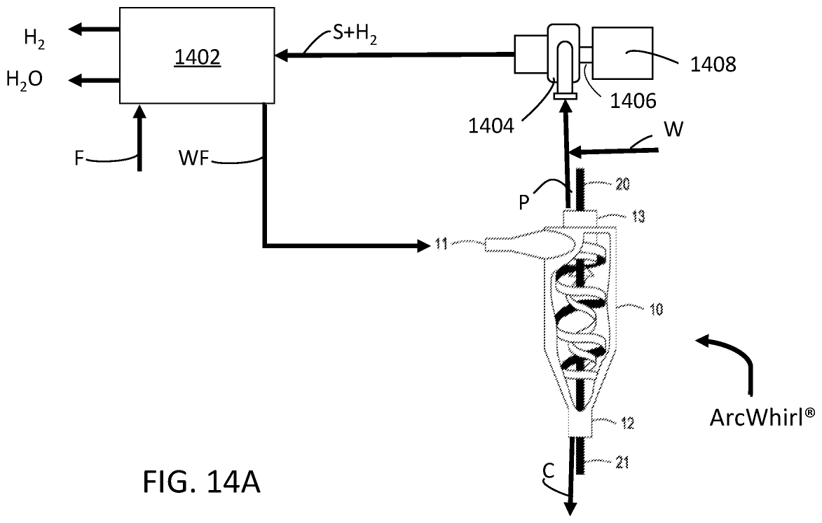

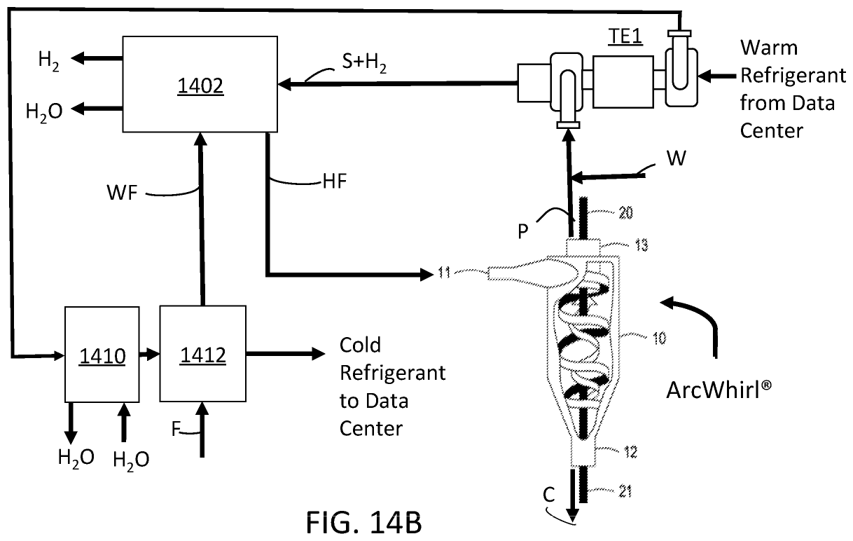

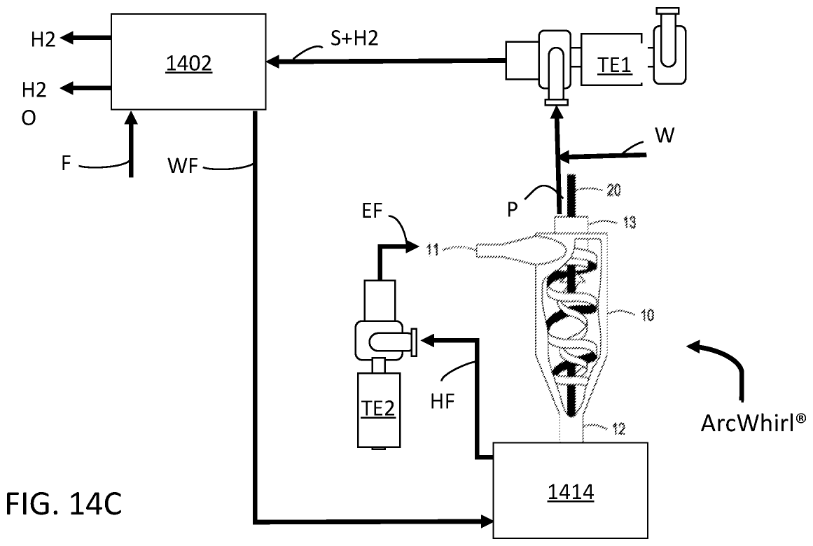

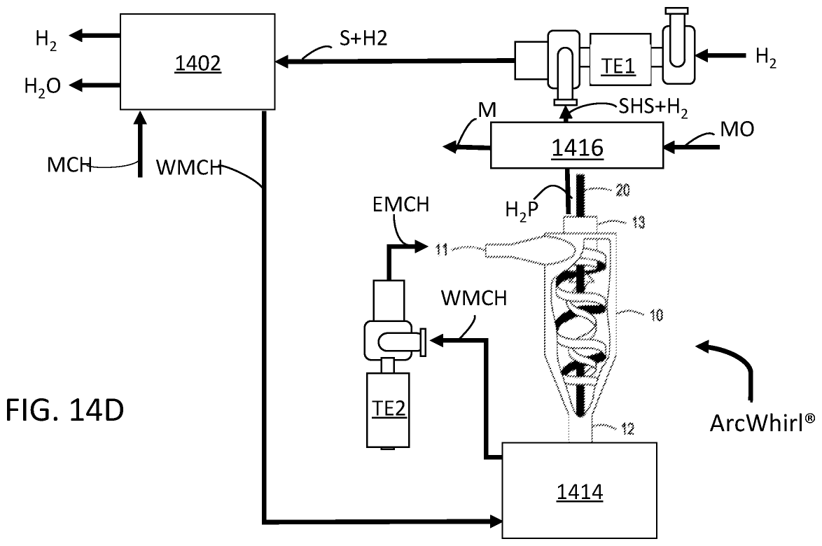

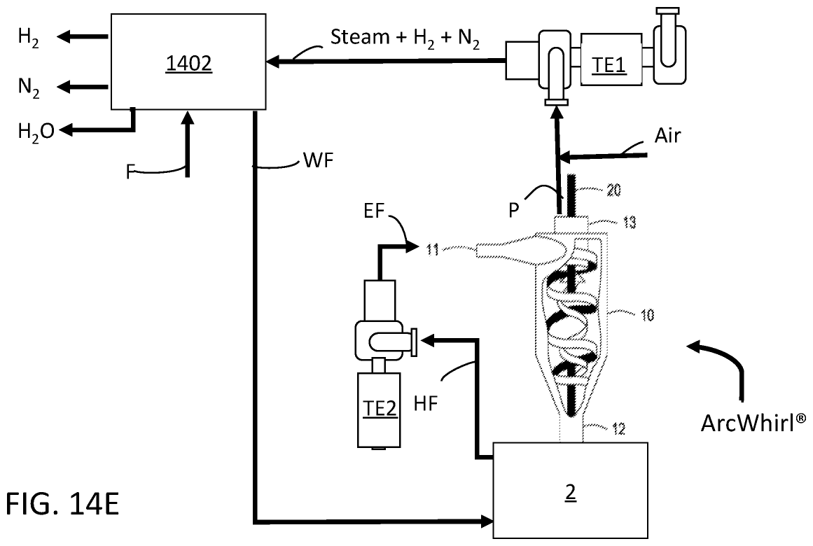

During operation, fuel 168 flows into the partial hollow bore 116 and exits through the pores in the porous tip 162. The RF energy from the wave energy source 102 heats the susceptor 106 to ensure that the fuel 168 forms an extremely hot gas shield around the porous tip 162. When device 160 is operated as a supersonic combustor, the fuel 168 ignites with air flowing at supersonic conditions. In order to operate below supersonic ramjet conditions, a blower, turbine or eductor is used to induce air or oxidant flow into the supersonic combustor 160. It will be understood that the supersonic combustor 160 could replace the ArcWhirl® combustor shown in FIG. 14D of U.S. Pat. No. 8,074,439, which is hereby incorporated by reference in its entirety.

When device 160 is operated as operated as a thermal oxidizer for low Btu gases, the low Btu gas flows into the gap 108 formed between the susceptor 106 and the wave energy source 102. Combustion air is introduced downstream of the hot low Btu gas. It will be understood that if the porous tip 162 is cutoff, then solids such as hazardous waste can be flowed into the partial hollow bore 116. Combustion air would flow in either direction as shown by arrow 164.

In addition, water can be added into the partial hollow bore 116 via the first end 120 and flashed to steam as it goes through the porous tip 162. The steam would then flow into the gap 108 and back towards the first end 120 thus superheating the steam. Likewise, hydrocarbons and hazardous gases can be treated and cracked in the same method. The gases can be mixed with the superheated steam and reformed into syngas or flowed directly into the first end 120, down the partial hollow bore 116, through the porous tip 162, and then into the gap 108. Consequently, this gives rise to a thermal oxidizer, cracker and supersonic combustor for numerous applications such as thermal oxidation for low Btu gas, thermal oxidation or degassing solid material such as soil contaminated with PFAS, regenerating activated carbon, cracking hydrocarbons and a 100% hydrogen supersonic combustor for hypersonic applications.

### Aerospike Supersonic Combustor

Now referring to FIGS. 1D and 1E, an aerospike supersonic combustor 170 is shown in accordance with one embodiment of the present invention. The wave energy source 102 is be lengthened to heat the susceptor 106. Moreover, the susceptor 106 can be adjusted to fit within the entire wave energy source 102. However, a very simple method for converting the supersonic combustor 160 of FIG. 1C into an aerospike supersonic combustor 170 is to screw or attach two susceptors 106a and 106b together via the first ends 110 as shown in FIG. 1D. Thus, the dual susceptors 106a and 106b forms a converging section 172, a throat 174 and a diverging section 176. Alternatively, this can be accomplished by attaching a similar shaped high temperature material as a nose cone 178 to the first end 110 of a single susceptor 106 as shown in FIG. 1E.

Likewise, to form an aerospike engine, the susceptor 106 is moved or fitted to extend beyond an expansion nozzle 180. This configuration operates similar to a garden hose nozzle allowing for various spray or exhaust patterns, to maintain its aerodynamic efficiency across a wide range of altitudes. In particular, the moveable aerospike susceptor in accordance with various embodiments of the present invention provides a blunt body for exhaust gases to thrust against, which is the purpose of an aerospike, and gives rise to a single stage to orbit (SSTO) engine as well as a hypersonic engine.

### Rotary Full-Bore Susceptor

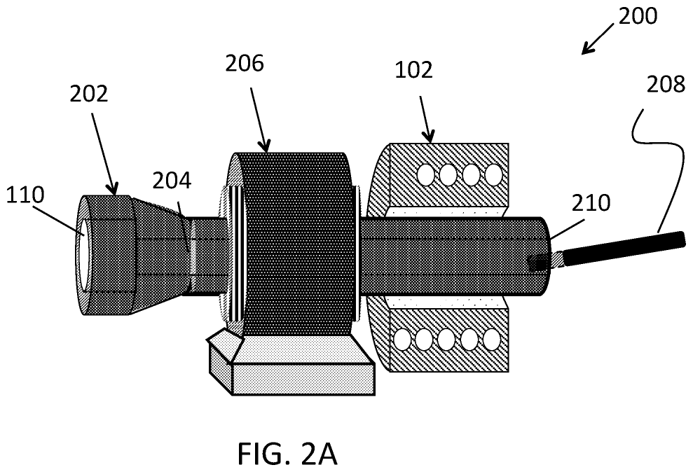

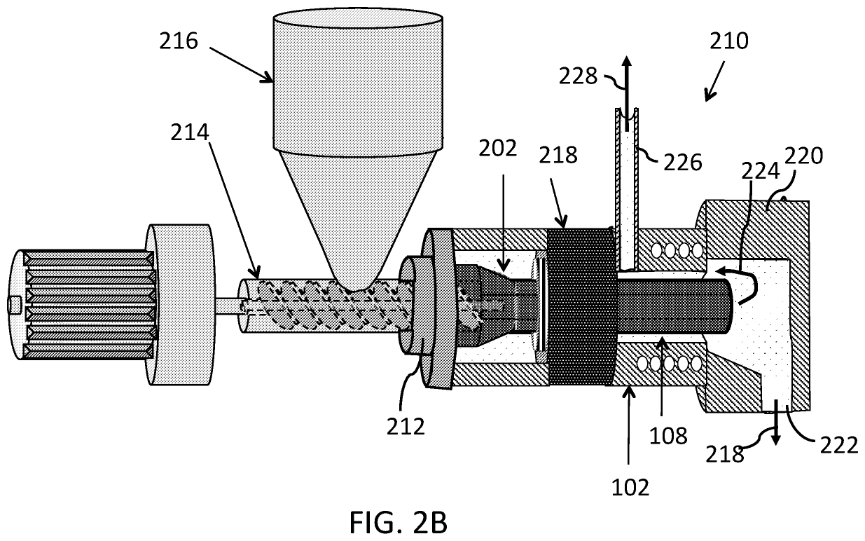

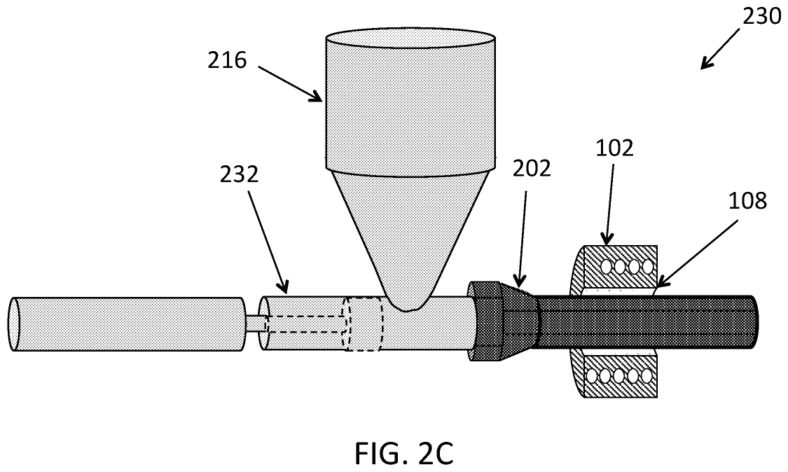

Referring now to FIG. 2A, a rotary full-bore susceptor 200 is shown in accordance with one embodiment of the present invention. The second end 122 of the susceptor 106 in FIG. 1A was cut off to provide the full-bore susceptor 202 shown in FIG. 2A. This allows solids to be processed within the through bore 204 of the susceptor 202. The full-bore susceptor 202 was coupled to a rotary drive 206, such as being inserted into a thru bore rotary pipe holder. As previously described, the coated exterior full-bore susceptor 202 is electrically insulating, but works as a susceptor within wave energy source 102. The interior of the full-bore susceptor 202 was tested for resistivity, but the multi-meter leads had to be moved around to show electrical conductivity. However, the inventor was able to strike an arc on the inside of the full-bore susceptor 202 by touching a graphite electrode 208 to the interior of the full-bore susceptor 202 when the first end 110 was grounded to the positive (+) of a DC plasma cutter power supply and the graphite electrode 208 was used as a cathode (−) and the lead was attached to the negative terminal of a DC plasma cutter power supply. The full-bore susceptor 202 was rotated and operated as an induction rotary furnace and a hybrid induction rotary arc furnace kiln when attached to the DC plasma cutter power supply. This allows any type of solid and/or semi-solid materials, such as cement raw kiln feed, sand, silica, metal shavings, pelletized material, woodchips, biomass, biosolids, sludge briquettes, granular matter, etc., to be processed by passing them into the first end 100 of the full-bore susceptor 202 and out of the open second end 210 of full-bore susceptor 202.

### Portland Cement Plant Raw Kiln Feed

Raw kiln feed mill for cement production is typically a mixture of limestone and clay or shale and is often referred to as a fine “rawmix.” During the production of Portland cement, volatile organic compounds (“VOCs”) are released when rawmix is fed into the cement kiln. In addition, many cement kilns use refuse derived fuel (“RDF”), which presents its own challenges. A technology that could rapidly preheat raw feed mill while destroying or thermally oxidizing VOCs would greatly help cement plants maintain current production capacities and be more ecologically friendly. Likewise, a technology that could flash rawmix and produce a nano-clinker cement would dramatically change the cement industry. Furthermore, if the same technology can precalcine the rawmix, then the off-gas stream with a high concentration of CO₂ could be captured and sold for enhanced oil recovery (EOR) or used for dry reforming. Likewise a technology that can treat a carbonate material while converting natural gas to hydrogen and carbon allows for a zero carbon emission plant. The following examples will clearly demonstrate the unexpected results of treating organics within cement raw kiln feed using embodiments of the present invention.

Now referring to FIG. 2B, a screw feeder inductively coupled rotary heater 210 is shown in accordance with one embodiment of the present invention. A full-bore susceptor 202 is attached with a rotary union 212 directly to a screw feeder 214. Material is fed into the screw feeder 214 using the feed hopper 216. The welding positioner 218 rotates the susceptor 202 while the screw feeder 214 feeds material directly into the susceptor 202. Note that any suitable device for rotating the full-bore susceptor 202 can be used in place of the welding positioner 218.

Rawmix was obtained from a cement manufacturer. The rawmix was placed in the feed hopper 216 and flowed into the rotating susceptor 202 using the screw feeder 214. In this non-limiting example, the revolutions per minute (RPM) of the welding positioner 218 was set for a residence time of one minute. Other resonance times can be used depending on the specifications and requirements of the system. The susceptor 202 was heated to a temperature below the melting point of the rawmix. The rawmix produced clinker 218 that exited from the rotating susceptor 202, flowed into end piece 220 and out the outlet 222.

The clinker was analyzed and showed that it was still high in lime. The feed pipe interior diameter was 35.1 mm of the feed pipe of the screw feeder 214 and the interior diameter of the inlet to the full-bore susceptor was 76.2 mm. Subsequent testing proved that the problem was solved by replacing the rotary union 212 with high temperature refractory wool to fill the gap between the feed pipe and the full-bore susceptor 202. As a result, the off-gases as shown by arrow 224 were then forced to transit into the gap 108 formed between full-bore susceptor 202 and the wave energy source 102. The off-gases 224 were cracked and partially thermally oxidized in the gap 108 using the extreme wave energy emitted from the full-bore susceptor 202. The rawmix contained trapped air, which allowed for partially thermally oxidizing the off-gases 224. The cracked gases 224 then exited via outlet 226 as shown by line 228. Consequently, this configuration provides a system, method and apparatus for precalcining or preclinkering rawmix while also treating volatile organic compounds (VOCs) and other pollutants. The concentrated CO₂ stream produced from the rawmix via the precalcination reaction can be captured and stored.

### Ring Formation in Rotary Kilns

One of the major problems with rotary kilns is the formation of a glass ring within the kiln. The kiln must be shut down and cooled for removal of the ring, which is both time consuming and costly. If a ring formation is likely to occur due to the melting of glassy type material, such as silica or metal oxides, or full melting is desired, the welding positioner 218 of FIG. 1B can be eliminated.

Turning now to FIG. 2C, a push rod or ram feeder inductively coupled heater 230 in accordance with one embodiment of the present invention is shown. A full-bore susceptor 202 is attached to a push rod or ram feeder 232. Material is fed into the push rod or ram feeder 232 using the feed hopper 216. The push rod or ram feeder 232 pushes material directly into the full-bore susceptor 202 for processing. Note that the screw feeder 214 in FIG. 2B can be used in heater 230 of FIG. 2C instead of the push rod or ram feeder 232. Likewise, the push rod or ram feeder 232 in FIG. 2C can be used in the heater 210 of FIG. 2B instead of the screw feeder 214.

Vertical Induction Cracker for Clean Hydrogen Production from Hydrocarbons (Shale Gas)

The oil and gas industry is in dire need of a decarbonization solution. The US EPA has defined clean hydrogen as less than 2 kgs of CO₂ produced per kg of H₂. The major issue with decarbonizing natural gas to hydrogen and carbon is the production of sticky coke (carbon) and not being able to recover the heat from the hot coke. The present invention's countercurrent flow system, method and apparatus solves both problems simultaneously.

Referring now to FIGS. 3A, 3B and 3C, vertical induction crackers (iCracker™) 300a, 300b, 300c are shown in accordance with various embodiments of the present invention. Each vertical induction cracker 300a, 300b, 300c includes an insulated heat resistant column 302 with a top cover 304 and a bottom 306. Although the vertical induction crackers 300a, 300b, 300c are shown in a vertical orientation, any orientation that provides counter-current flow will suffice to practice the present invention. The column 302 has a top 304, an upper side outlet 328, an upper side inlet 316 and a bottom outlet 318. A riser feeder 308 is disposed within the insulated heat resistant column and affixed to the top cover 304. A gap 310 is formed between the interior wall of the insulated heat resistant column 302 and the feeder riser 308. A susceptor 106 having a porous tip 162 is attached to the bottom of the riser feeder 308. For high flow rates, the porous tip 162 may be removed as shown in FIG. 2A to make a full-bore susceptor 202. A wave energy source 102 is disposed within, integrated into, or attached to the insulated heat resistant column 302. The location of the wave energy source 102 can vary depending on the circumstances as illustrated in the FIGS. 3A and 3B. At least a portion of the susceptor 106 is placed within the wave energy source 102 so that the susceptor 106 reaches a desired temperature range when absorbing wave energy from the wave energy source 102. As shown in FIG. 3A, the feeder riser 308 can slide in and out of the insulated heat resistant column 302 as shown by arrow 312 in order to adjust the position of the susceptor 106 within the wave energy source 102. A packing gland or other means known in the art to not allow gases to flow between the feeder riser 308 and the top cover 304.

A solid, liquid or gas material 314 flows into the insulated heat resistant column 302 via inlet 316. Inlet 316 may be located at the top, middle or bottom of the insulated heat resistant column 302. If operated as a thermal oxidizer, the inlet 316 would preferably be located somewhere in the middle of the insulated heat resistant column 302 so that adding dilution air and the solid material flowing into inlet 316 may be a thermal oxidation catalyst. The catalyst can be continually flowed by adjusting the location of the susceptor 106 and feeder riser 308 or a valve located on the bottom outlet 318 for removing spent catalyst. This allows for constantly flowing fresh catalyst. Note that the susceptor 106 can be used as a stopper by lowering it until it touches the nozzle block hole 320 in the bottom 306 of the insulated heat resistant column 302. As the feeder riser 308 is pulled up, solid material will flow out of the insulated heat resistant column 302 through exit 318 as shown by Arrow 322.

A hydrocarbon or any hydrogen containing fluid, landfill gas, low Btu gas or solid material is flowed into the riser inlet as shown by arrow 324. The feeder riser 308 is a preheater. The fluid within the feeder riser 308 is further heated and cracked via radiation as it enters the radiation zone formed between the wave energy source 102 and the susceptor 106, and is further heated within the porous tip 162 via conduction. Likewise, as the hot fluid rises through the gap 310, it transfers heat to the feeder riser 308 and any material 314 that flows into the inlet 316.

The hydrogen will rise and contact the material 314 heating it to aid in cracking the gases at the bottom of the insulated heat resistant column 302. Likewise, the hydrogen will be cooled by the material 314 entering into the insulated heat resistant column 302. Hydrogen exits the column through outlet 326 as shown by Arrow 328. The susceptor's porous tip 162 provides a secondary benefit. It forms a fluidized bed so that the any solid material 314 does not lump together, thus preventing plugging and fouling within the insulated heat resistant column 302.

Now referring for FIG. 3B, a slightly different fluidized induction column is shown in accordance with one embodiment of the present invention. In this non-limiting example, compressed natural gas (CNG), liquified natural gas (LNG), liquid propone gas (LPG), butane, ethane, pentane, olefins, biogas, syngas or other suitable hydrocarbon gas or fluids can be used as both a fluidizing gas and a refrigerant. The vertical induction cracker 300b cracks gas or fluid hydrocarbons into hydrogen and carbon while recovering heat produced by the process. The vertical induction cracker 300b uses a counter-current flow path for the solids or media in comparison to the gas or fluid in order to capture carbon while recovering the heat from the extremely hot solid carbon. The vertical induction cracker 300b has three zones: zone 1 is the solid or media heating and hydrogen cooling (HCZ) zone; zone 2 is the extreme heating zone or extreme transmitted power density (XTPDZ) zone; and zone 3 is the solids or media cooling (SCZ) zone.

The ambient temperature solids or media are feed from the inlet 316 into the column 302 where the solids or media contact the warm hydrogen in zone 1 (HCZ) where heat is transferred from the hydrogen to the solids or media. The somewhat cool hydrogen or cracked gases 328 exit the column 302 via outlet 326. As the solids or media traverse down the column 302, the solids or media contact hot hydrogen stream produced from the cracking process in the gap 310 and near the wave energy source 102 and susceptor 106. Next, the solids or media enter zone 2 (XTPDZ). If the solids or media contain an electrically conductive material, such as metals and/or carbon, then they will be heated via RF energy. However, the susceptor 106 will emit radiation sufficient to heat the solids or media within the gap 310. Likewise, the gas or fluid rising from the bottom of column 302 via the gas sparger or fluidizer 334 will thoroughly crack the hydrocarbons into hydrogen and carbon within zone 2 (XTPDZ). The carbon is captured onto the surface of the solids or media. Extremely hot solids or media will exit the gap 310 and flow downward in the column 302. As shown by arrow 330, gas or fluid hydrocarbons, such as those listed above flow into inlet 332 located at the bottom of the column 302 and into fluidizer 334. The gas or fluid immediately cools the hot solids or media, and the hot solids or media heat the gas or fluid within zone 3 (SCZ). The solids or media then exit column via outlet 318 as shown by arrow 322. The depth of the solids or media within the column 302 can be controlled via a rotary lock valve attached to the column's outlet 318. A screw feeder or ram feeder can also be used. A very good solid organic for use in the present invention is any spherical carbon containing matter, such as tungsten carbide beads or any organic matter that can be pressed into pellets and/or beads. Refractory beads, commonly referred to as ceramic proppants, can be used as the media to capture heat and carbon.

If the production of syngas is desired or the production of green syngas from biosolids or biomass is desired, then water or steam can be flowed into the riser 308 as shown by arrow 324. Thus, a porous tip 162 on the susceptor 106 produces superheated steam from the water for steam. The biosolids or biomass is flowed into column 302 via inlet 316 as shown by arrow 314. Also, green hydrogen from biomass can be produced with any of the vertical induction crackers 300a, 300b, 300c shown in FIG. 3A, 3B or 3C.

Referring now to FIG. 3C a funnel shaped fluidizer 336 is installed within the bottom 306 of the column 302. Once again the fluidizing fluid enters the bottom inlet 338 as shown by arrow 340 and into the funnel fluidizer 336. This configuration forms a gas slide for solid particles to exit the column 302 via outlet 318 as shown by arrow 322. Although a funnel shaped fluidizer 336 is shown, the column 302 may in itself contain a porous tube as shown in FIG. 3 of U.S. Pat. No. 8,329,044, which is hereby incorporated by reference in its entirety.

Zero CO₂ Silicon Production from Silica Example

Any one of the vertical induction crackers 300a, 300b, 300c can be selected to produce hydrogen, which would then be used as both a fluidizing gas and a reducing agent in the silica to silicon induction furnace shown in FIG. 3D in accordance the embodiment of the present invention. Alternatively, another source of hydrogen can be used. Silica (SiO₂), such as northern white frac sand, is a suitable material for conversion to silicon (Si). Northern white frac sand is a monocrystalline quartz with very few impurities. Northern white frac sand or any relatively pure quartz feedstock can be used the starting solid material for flowing into the inlet 314 of the column 302 in FIGS. 3A, 3B, 3C.

As shown in FIG. 3D, the silica is reduced to silicon by reacting hydrogen (H₂) with the oxygen bound in the silica to form steam and silicon. More specifically, hydrogen is fed into the susceptor 106 having a porous tip 162, which is inductively heated by the wave energy source 102. The hydrogen exits the porous tip 162 and reacts with the silica introduced into the gap 108 between the exterior of the susceptor 106 and the interior of the wave energy source 102. The resulting silicon exits through the end piece 338 coupled to the wave energy source and out the outlet 340. The steam can then be used to drive a turboexpander 342 supplementing the power, such as zero CO₂ power, for the wave energy source 102. The steam can be used for other purposes as well.

### Induction Vapor Compression Distillation Column

Vertical induction crackers 300b, 300c in FIGS. 3B and 3C can be used to process saltwater by flowing the saltwater into inlet 332, 338, respectively. The solid salt or brine exits the column 302 via the bottom exit 318. The brine could be further distilled into a solid salt using the system shown in FIG. 3D.

Likewise, seawater or high saline waters can be distilled using cracker 330a from FIG. 3A in the system shown in FIG. 3E in accordance with one embodiment of the present invention. In this embodiment, a heat exchanger 344 and a vapor compressor 346 are connected to vertical induction cracker 300a.

Saltwater (SW) enters the heat exchanger 344 where it is heated by high pressure and high temperature vapor 348 from the vapor compressor 346. The heated saltwater enters inlet 316 of the column 302 where it is again heated by high pressure and high temperature vapor 348 from the vapor compressor 346 via riser 308. The heated seawater is turned into steam by the heat generated by the susceptor 106 and wave energy source 102. Brine exits outlet 318 in the bottom of column 302. The resulting steam exits the column 302 via outlet 326. The vapor compressor 260 pulls a suction on the column outlet 326. Vapors flow into a suction side 350 of the vapor compressor 346 and are discharged as a high pressure and high temperature vapor via a discharge line 348. The compressed and superheated vapor flows into either the line back to the riser 308 or to steam users or the heat exchanger 344. It will be understood that valves can be used to direct the compressed vapors into the riser 308 or the heat exchanger 344 or for steam users or any combination thereof. Distilled water (distillate) flows out of the heat exchanger 344. It will be understood that three induction flash evaporators 300a can be installed in delta or wye configurations and used as virtual inertia wave energy dynamic braking systems for grid stabilization. Likewise, this system can be used for industrial steam production, food and beverage facilities that use steam, or buildings within a city that utilize district heating. For those applications, the discharge 348 from the vapor compressor 346 would be directed to steam users shown by Arrow SU. Note that the system described herein does not require any water treatment or pretreatment of seawater.

### Other Embodiments

In another embodiment of the present invention, an apparatus includes a wave energy source having a cylindrical hole, and a cylindrical susceptor at least partially disposed within the cylindrical hole of the wave energy source such that a gap is formed between an outside wall of the cylindrical susceptor and an inside wall of the cylindrical hole. An exterior of the cylindrical susceptor is coated or impregnated with a non-oxidizing material. The wave energy source generates a wave energy, and the cylindrical susceptor absorbs the wave energy and converts the wave energy to heat.

In one aspect, a partial hollow bore extends along a longitudinal axis of the cylindrical susceptor such that the cylindrical susceptor is open at a first end and closed at a second end. In another aspect, the first end of the cylindrical susceptor is enlarged. In another aspect, the gap comprises a first gap, and further comprising a pipe, conduit or tube partially inserted into the partial hollow bore of the cylindrical susceptor such that a second gap is formed between an inside of the partial hollow bore and the pipe, conduit or tube, and the pipe, conduit or tube does not extend to a bottom of the partial hollow bore. In another aspect, a fluid is heated by flowing the fluid into and through the pipe, conduit or tube such that the fluid exits the pipe, conduit or pipe near a bottom of the partial hollow bore, and flows through the second gap. In another aspect, the fluid is further heated by flowing the fluid through the first gap. In another aspect, the second end of the cylindrical susceptor comprises a porous tip. In another aspect, the porous tip is within or close to wave energy source; and a fuel is fed into the partial hollow bore, and a combustion air or oxidant is fed axially or in a vortex, whirl or swirl flow through the gap. In another aspect, the combustion air or oxidant is supersonic. In another aspect, a nozzle is attached to the wave energy source. In another aspect, the cylindrical susceptor comprises a first cylindrical susceptor having an enlarged first end, and further comprising a second cylindrical susceptor having an enlarged first end attached to the enlarged end of the first cylindrical susceptor. In another aspect, a nose cone is attached to the first end of the cylindrical susceptor. In another aspect, a full hollow bore extends along a longitudinal axis of the cylindrical susceptor such that the cylindrical susceptor is open at a first end and open at a second end. In another aspect, a rotary drive is coupled to the cylindrical susceptor. In another aspect, a screw feeder or ram feeder is coupled to the first end the cylindrical susceptor. In another aspect, an end piece is attached to the wave energy source such that the second end of the cylindrical susceptor extends into the end piece, wherein the end piece has a bottom outlet, and a gas outlet is connected to the gap. In another aspect, a solid material is fed into the first end of the cylindrical susceptor. In another aspect, the solid material comprises rawmix, sand, silica, metal shavings, pelletized material, wood chips, biomass, biosolids, sludge briquettes, or granular material. In another aspect, the apparatus further includes a column having a top, an upper side outlet, an upper side inlet and a bottom outlet; the wave energy source disposed within, integrated into, or attached to a portion of the column; a riser feeder partially disposed within the column and extending through the top of the column, the riser feeder having a top inlet and a bottom outlet; and the first end of the cylindrical susceptor attached to the bottom outlet of the riser feeder. In another aspect, the wave energy source and the cylindrical susceptor are position within a middle portion of the column or a lower portion of the column. In another aspect, the riser feeder is moveable within the column. In another aspect, the column further comprises a lower side inlet. In another aspect, a heat exchanger is coupled to the upper inlet of the column; and a vapor compressor having an inlet is coupled to the upper outlet of the column and an output coupled to the top inlet of the feeder riser and the heat exchanger. In another aspect, saltwater is fed into the heat exchanger, distilled water exits the heat exchanger, brine exits the lower outlet of the column, and steam exits the upper side outlet of the column. In another aspect, hydrogen is fed into the first end of the cylindrical susceptor, heated by the cylindrical susceptor and exits the porous tip of the cylindrical susceptor; and silica is fed into the gap and reacts with the heated hydrogen to produce steam and silicon.

### Wave Energy Method for Heating Matter

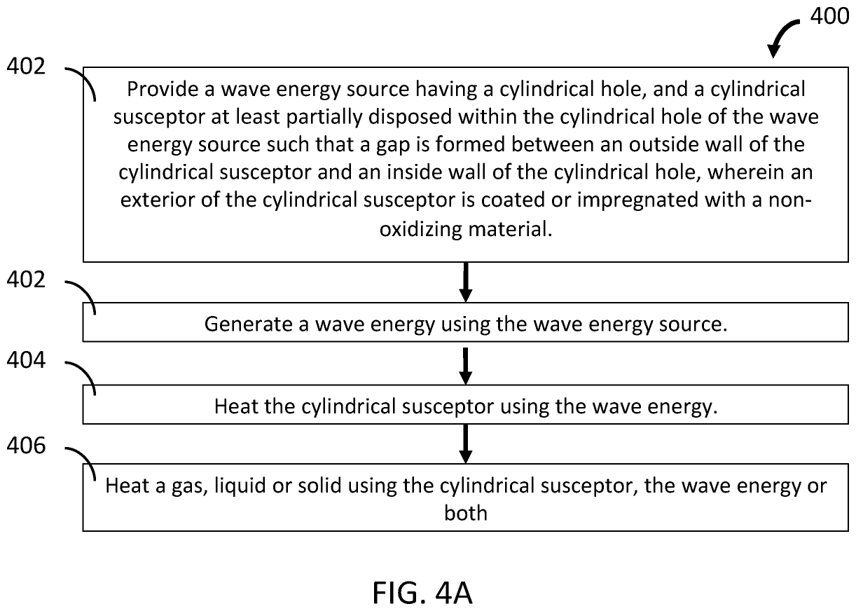

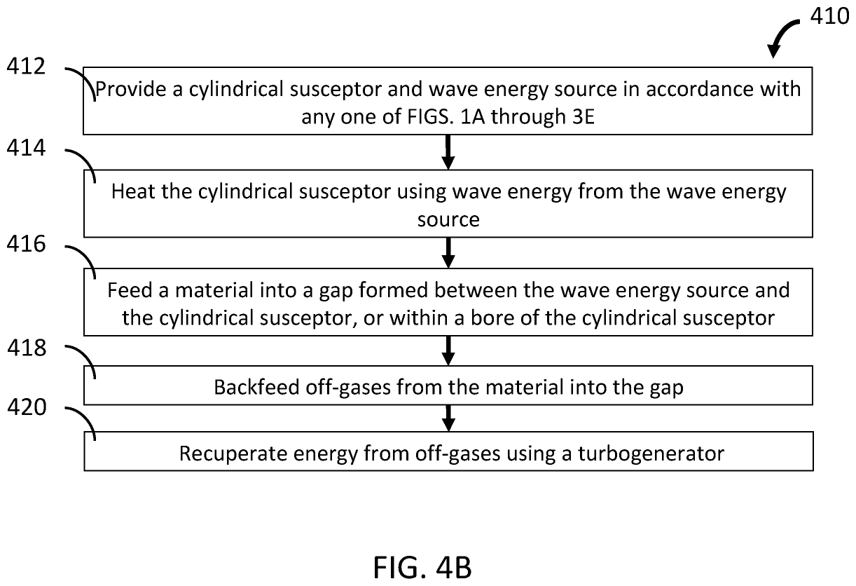

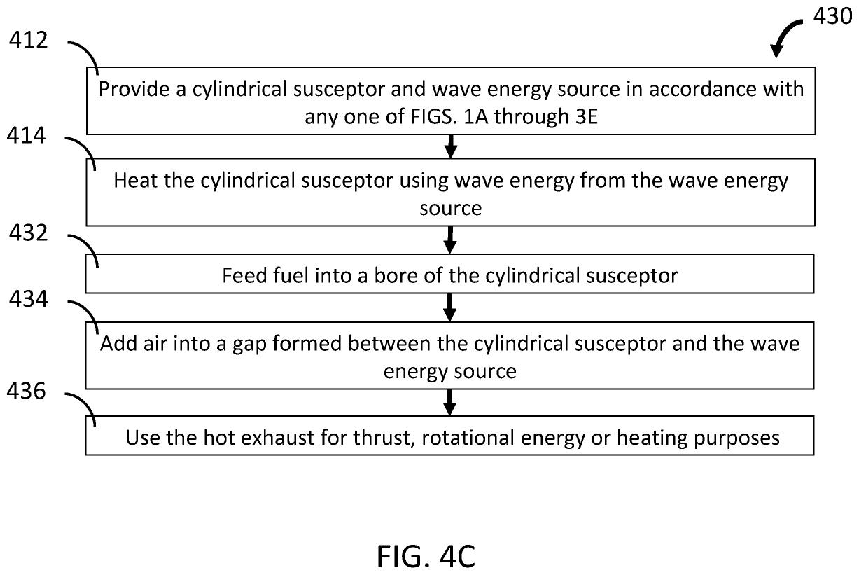

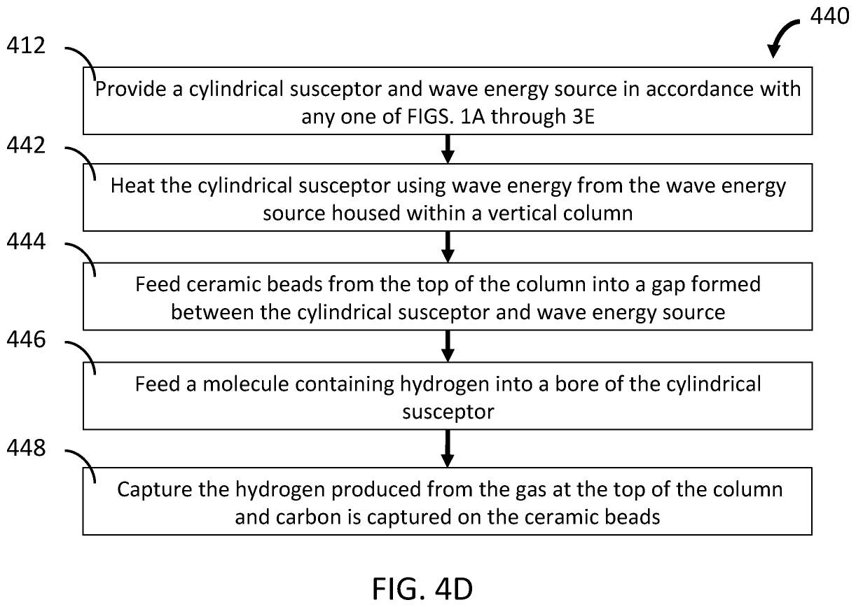

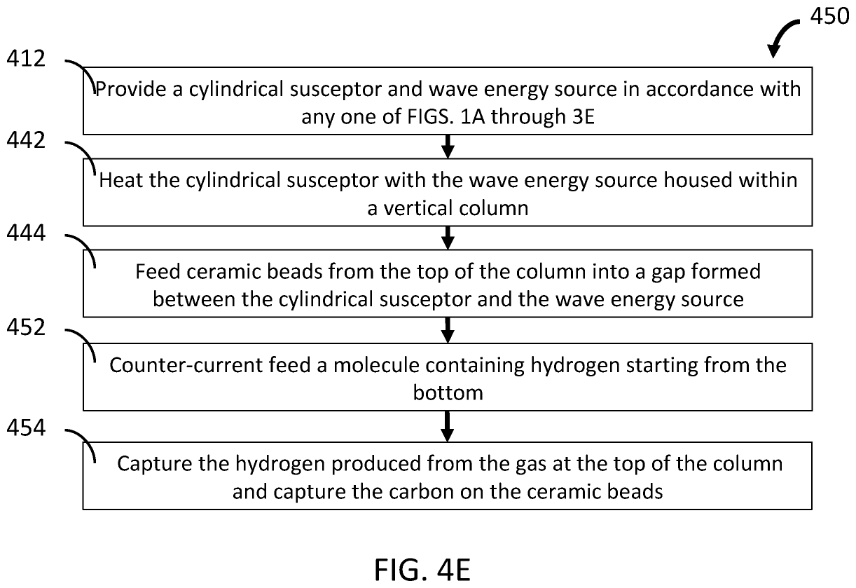

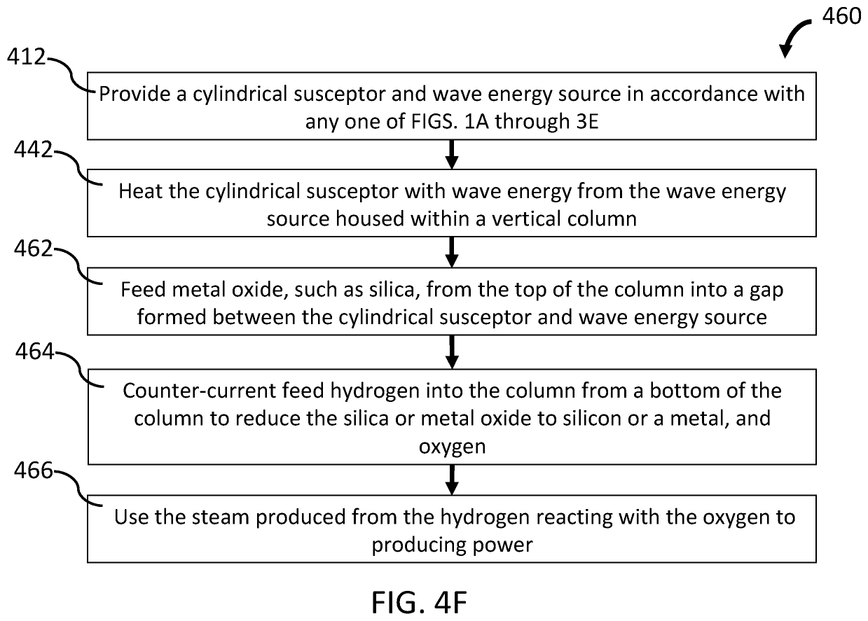

Now referring to FIG. 4A, a method for heating matter 400 in accordance with one embodiment of the present invention is shown. A wave energy source having a cylindrical hole, and a cylindrical susceptor at least partially disposed within the cylindrical hole of the wave energy source are provided in block 402. A gap is formed between an outside wall of the cylindrical susceptor and an inside wall of the cylindrical hole, wherein an exterior of the cylindrical susceptor is coated or impregnated with a non-oxidizing material. A wave energy is generated using the wave energy source in block 402. The cylindrical susceptor is heated using the wave energy in block 404. A gas, liquid or solid is heated using the cylindrical susceptor, the wave energy or both in block 406.

Referring now to FIG. 4B, a method for heating matter 410 in accordance with one embodiment of the present invention is shown. A cylindrical susceptor and a wave energy source in accordance with any one of FIGS. 1A through 3E are provided in block 412. The cylindrical susceptor is heated using wave energy from the wave energy source in block 414. A material (e.g., a gas, liquid, solid or combination thereof) is feed into a gap formed between the wave energy source and the cylindrical susceptor, or within a bore of the cylindrical susceptor in block 416. Off gasses from the material are backfed into the gap in block 418. Energy from the off gases are recuperated using a turbogenerator in block 420. In another embodiment of the present invention, a method includes providing a wave energy source having a cylindrical hole, and a cylindrical susceptor at least partially disposed within the cylindrical hole of the wave energy source such that a gap is formed between an outside wall of the cylindrical susceptor and an inside wall of the cylindrical hole, wherein an exterior of the cylindrical susceptor is coated or impregnated with a non-oxidizing material; generating a wave energy using the wave energy source; heating the cylindrical susceptor using the wave energy; and heating a gas, liquid or solid using the cylindrical susceptor, the wave energy or both.

In one aspect, the cylindrical susceptor further comprises a partial hollow bore along a longitudinal axis of the cylindrical susceptor such that the cylindrical susceptor is open at a first end and closed at a second end. In another aspect, the first end of the cylindrical susceptor is enlarged. In another aspect, the gap comprises a first gap, and further comprising a pipe, conduit or tube partially inserted into the partial hollow bore of the cylindrical susceptor such that a second gap is formed between an inside of the partial hollow bore and the pipe, conduit or tube, and the pipe, conduit or tube does not extend to a bottom of the partial hollow bore. In another aspect, the fluid is heated by flowing the fluid into and through the pipe, conduit or tube such that the fluid exits the pipe, conduit or pipe near a bottom of the partial hollow bore, and flows through the second gap. In another aspect, the fluid is further heated by flowing the fluid through the first gap. In another aspect, the second end of the cylindrical susceptor comprises a porous tip. In another aspect, the porous tip is within or close to wave energy source; and a fuel is fed into the partial hollow bore, and a combustion air or oxidant is fed axially or in a vortex, whirl or swirl flow through the gap. In another aspect, the combustion air or oxidant is supersonic. In another aspect, a nozzle is attached to the wave energy source. In another aspect, the cylindrical susceptor comprises a first cylindrical susceptor having an enlarged first end, and further comprising a second cylindrical susceptor having an enlarged first end attached to the enlarged end of the first cylindrical susceptor. In another aspect, a nose cone is attached to the first end of the cylindrical susceptor. In another aspect, the cylindrical susceptor further comprises a full hollow bore along a longitudinal axis of the cylindrical susceptor such that the cylindrical susceptor is open at a first end and open at a second end. In another aspect, the method further includes rotating the cylindrical susceptor using a rotary drive coupled to the cylindrical susceptor. In another aspect, the method further includes feeding the solid or a semi-solid into the first end of the cylindrical susceptor using a screw feeder or ram feeder coupled to the first end the cylindrical susceptor. In another aspect, an end piece is attached to the wave energy source such that the second end of the cylindrical susceptor extends into the end piece, wherein the end piece has a bottom outlet; and a gas outlet is connected to the gap. In another aspect, the method further includes feeding a solid material into the first end of the cylindrical susceptor. In another aspect, the solid material comprises rawmix, sand, silica, metal shavings, pelletized material, wood chips, biomass, biosolids, sludge briquettes, or granular material. In another aspect, a column having a top, an upper side outlet, an upper side inlet and a bottom outlet; the wave energy source disposed within, integrated into, or attached to a portion of the column; a riser feeder partially disposed within the column and extending through the top of the column, the riser feeder having a top inlet and a bottom outlet; and the first end of the cylindrical susceptor attached to the bottom outlet of the riser feeder. In another aspect, the wave energy source and the cylindrical susceptor are position within a middle portion of the column or a lower portion of the column. In another aspect, the method further includes moving the riser feeder within the column. In another aspect, the column further comprises a lower side inlet. In another aspect, a heat exchanger is coupled to the upper inlet of the column; and a vapor compressor having an inlet coupled to the upper outlet of the column and an output coupled to the top inlet of the feeder riser and the heat exchanger. In another aspect, saltwater is fed into the heat exchanger, distilled water exits the heat exchanger, brine exits the lower outlet of the column, and steam exits the upper side outlet of the column. In another aspect, the method further includes feeding hydrogen into the first end of the cylindrical susceptor such that the hydrogen is heated by the cylindrical susceptor and exits the porous tip of the cylindrical susceptor; and feeding silica into the gap such that the silica reacts with the heated hydrogen to produce steam and silicon.

### Wave Energy Method for Supersonic Combustion

Now referring to FIG. 4C, a method for supersonic combustion 430 in accordance with one embodiment of the present invention is shown. A cylindrical susceptor and a wave energy source in accordance with any one of FIGS. 1A through 3E are provided in block 412. The cylindrical susceptor is heated using wave energy from the wave energy source in block 414. A fuel is feed into a bore of the cylindrical susceptor in block 432. Air is added into a gap formed between the cylindrical susceptor and the wave energy source in block 434. The hot exhaust is used for thrust, rotational energy or heating purposes in block 436.

### Wave Energy Method for Making Hydrogen

Referring now to FIG. 4D, a method for making hydrogen 440 in accordance with one embodiment of the present invention is shown. A cylindrical susceptor and a wave energy source in accordance with any one of FIGS. 1A through 3E are provided in block 412. The cylindrical susceptor is heated using wave energy from the wave energy source housed in a vertical column in block 442. Ceramic beads are fed from the top of the column into that gap formed between the cylindrical susceptor and the wave energy source in block 444. A molecule containing hydrogen is fed into a bore of the cylindrical susceptor in block 446. The hydrogen produced from the gas at the top of the column is captured and the carbon is captured on the ceramic beads in block 448.

### Wave Energy Countercurrent Method for Making Hydrogen

Now referring to FIG. 4E, a method for making hydrogen 450 in accordance with one embodiment of the present invention is shown. A cylindrical susceptor and a wave energy source in accordance with any one of FIGS. 1A through 3E are provided in block 412. The cylindrical susceptor is heated using wave energy from the wave energy source housed in a vertical column in block 442. Ceramic beads are fed from the top of the column into that gap formed between the cylindrical susceptor and the wave energy source in block 444. A molecule containing hydrogen is counter-current fed into the column from a bottom of the column in block 452. The hydrogen produced from the gas at the top of the column is captured and the carbon is captured on the ceramic beads in block 454.

### Wave Energy Method for Making Silicon or Metals From Silica or Metal Oxides

Referring now to FIG. 4F, a method for making silicon or metals from silica or metal oxides 460 in accordance with one embodiment of the present invention is shown.

For example, the method 460 can be used to make silicon from silica, aluminum from alumina, UO₂ from U₂O₈, etc. A cylindrical susceptor and a wave energy source in accordance with any one of FIGS. 1A through 3E are provided in block 412. The cylindrical susceptor is heated using wave energy from the wave energy source housed in a vertical column in block 442. Silica or metal oxides are fed from the top of the column into that gap formed between the cylindrical susceptor and the wave energy source in block 462. Hydrogen is counter-current fed into the column from a bottom of the column to reduce the silica or metal oxide to silicon or a metal, and oxygen in block 464. The steam produced by the hydrogen reacting with the oxygen is used to produce power in block 466.

### Virtual Inertia Wave Energy Regenerative Braking

A concise example for leveling base load power and renewable energy tie-in while producing hydrogen from natural gas and/or water will be disclosed below.

### Three Phase Base Load Ng Plasma Dynamic Braking

The apparatus as shown in FIG. 32 of U.S. Pat. No. 9,445,488 is a PlasmaWhirl® reactor that includes three ArcWhirls®, each used as a separate leg L1, L2 and L3 from a power source, for example Wind, Solar, Batteries, Geopower, Hydropower, Internal Combustion Engine (Gas Turbine, Diesel or Gasoline), Nuclear, Turboexpander, Magneto Hydrodynamic Drive (MHD) Generator or Fusion. Although the 488′ patent discloses three AC plasma torches wired in delta or wye configurations it does not disclose a means for using the PlasmaWhirl® Reactor for dynamic braking in order to provide virtual inertia to operate a power plant in a flexible load configuration.

A virtual inertia wave energy regenerative braking system, method and apparatus are disclosed in FIGS. 5A, 5B, 5C, 5D, 8 and 10. Referring now to FIG. 5A, a virtual inertia wave energy dynamic braking apparatus 500 is shown. The apparatus 500 includes an induction coil 502 cast or potted in a high temperature refractory housing 504, with an interior wall 506, an inlet power lead 508, an outlet power lead 510 and a susceptor 512. In this configuration the coil 502 would be at a very low power level since the susceptor 512 is not within the lines of flux of the induction coil 502. As shown by arrow A the susceptor 512 can be moved in and out of the hollow interior of the housing 504. A material can be injected into the housing 504 as shown by arrow B and exit the housing 504 as shown by arrow C.

Now referring to FIG. 5B, the susceptor 512 is inserted into the housing and heats up due to induction heating. A gap 514 is formed between the susceptor 512 and the interior wall 506 of the housing 504. Material injected into the annulus 514 is treated with wave energy emitted from the susceptor 512 and/or from the magnetic flux lines provided the material is electrically conductive.

Although the susceptor 512 can be moved in and out of the induction housing 504, induction power supplies can energize the induction coil 502 within microseconds. Thus, this would also be a means for applying virtual inertia to control a grid in lieu of moving the susceptor 512 in and out of the RF field created by the coil 502.

Referring now to FIG. 5C, three induction systems are used for a three phase virtual inertial wave energy dynamic braking system. Each system is labeled in accordance with its respective legs L1, L2 and L2 shown as 500L1, 500L2 and 500L3. Very little power is used when susceptors 512L1, 512L2 and 5126L3 are not inserted into the field of its respective induction housing. On the other hand, as shown in FIG. 5D when control rod susceptors 512L1, 512L2 and 512L3 are inserted into its respective housing the power will increase due to the susceptors coupling to the magnetic field.

### Balancing and Synchronizing Loads for Frequency Control

Not being bound by theory it will be understood that each leg can be balanced separately for frequency control by inserting its control rod susceptor to a given depth into the housing. This is shown in FIG. 5D.

### Virtual Inertia Wave Energy Flex Mode for Rotating Inertia

Various embodiments of the present invention provide for a system, method and apparatus for flexible operational modes at power plants with rotating inertia. As previously disclosed in FIG. 5C, control rods 512L1, 5126L2 and 5126L3 would be fully inserted to maximize power consumption from the power plant. Natural gas would be flowed into the gap and would be cracked into hydrogen and carbon. This configuration allows for the production of hydrogen via water splitting (electrolysis) or from a hydrocarbon via cracking and/or photolysis.

Returning to FIGS. 3A, 3B, 3C and 3D a virtual inertia wave energy plant can be built onsite at a power plant for production of hydrogen, carbon and silicon. This truly gives rise to flexible modes of operation, specifically for generating revenue from the sale of zero CO₂ hydrogen, graphite and silicon.

It will be understood that any non-CO₂ emitting power source for example, hydro, solar, wind and even turboexpanders that recuperate energy can be used for production of zero CO₂ hydrogen, graphite, silicon or distilled water with the present invention.

Three phase renewable tie-ins, such as wind turbines, hydroturbines, biomass power plants with dynamic braking would be operated similar to the above description but in a spinning reserve mode. This allows large base load plants to continuously produce rated power while making hydrogen, but allows the renewables to operate at maximum power for example with prevailing high wind velocities for wind turbines. The present invention is an ideal use for braking wind turbines while manufacturing hydrogen and carbon from natural gas using plasma dynamic braking.

Offshore Wind Energy with Viper™ Riser for Green H₂

Offshore wind has the greatest potential for renewable hydrogen production. However, therein lies the problem-footprint. It is well known and well understood that footprint on marine vessels is limited due to deck space. Consequently, any hydrogen production system installed on a vessel must be compact and have a high transmitted power density. Plasma electrolysis has upwards of ten times the power density of resistive heating such as Faraday electrolysis. Furthermore, if a water splitting system or apparatus can be installed subsea, then that eliminates any issues with deck space.

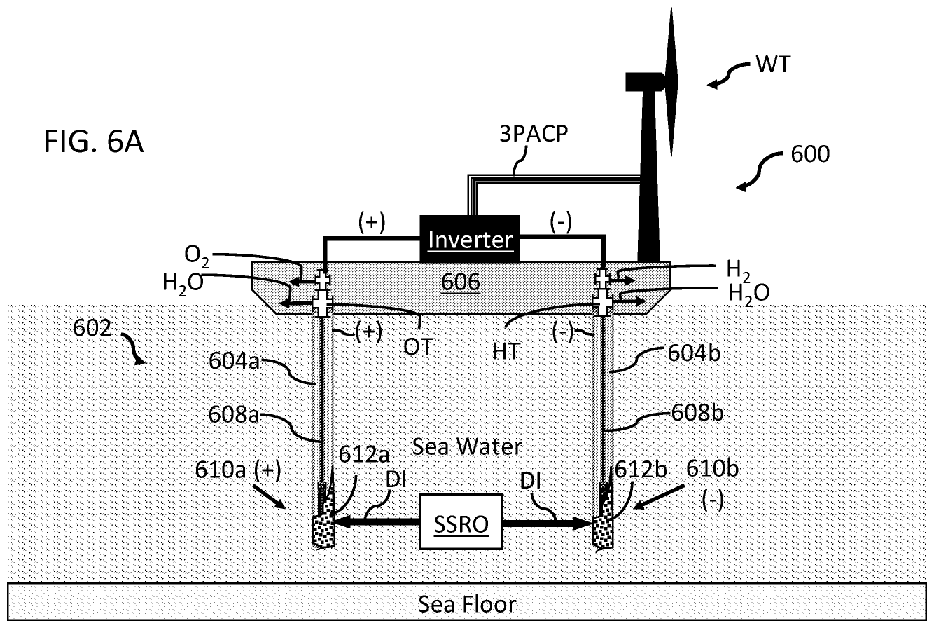

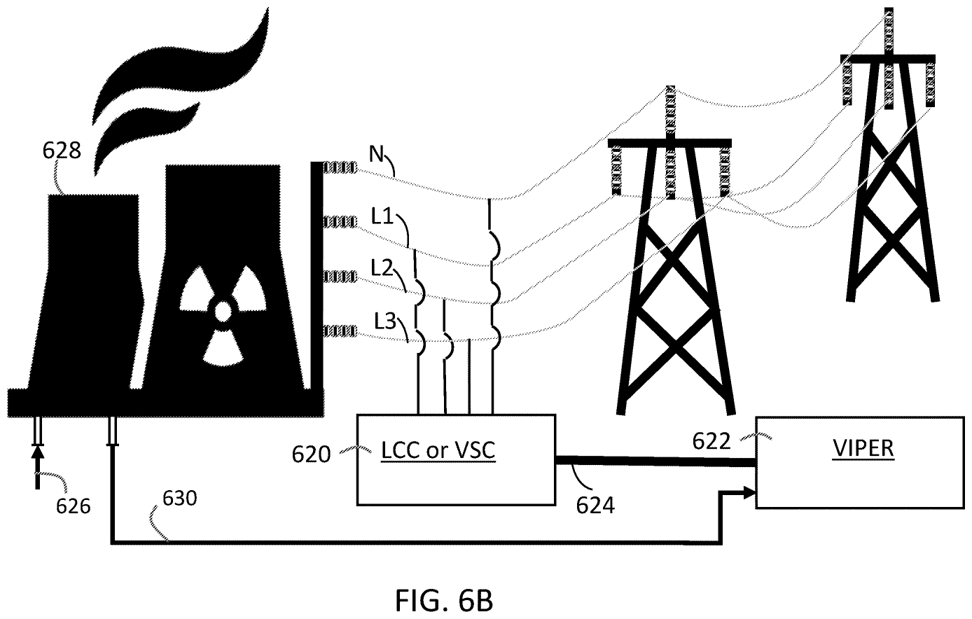

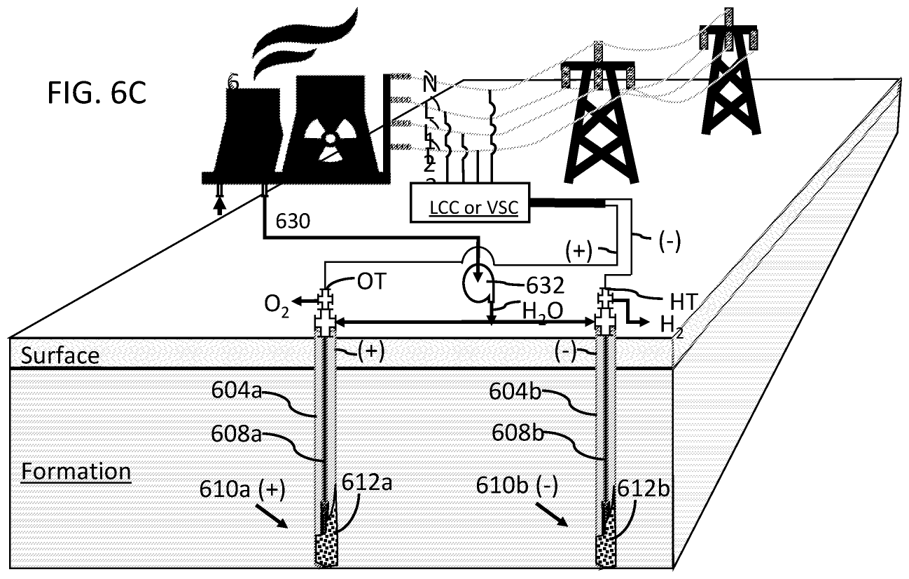

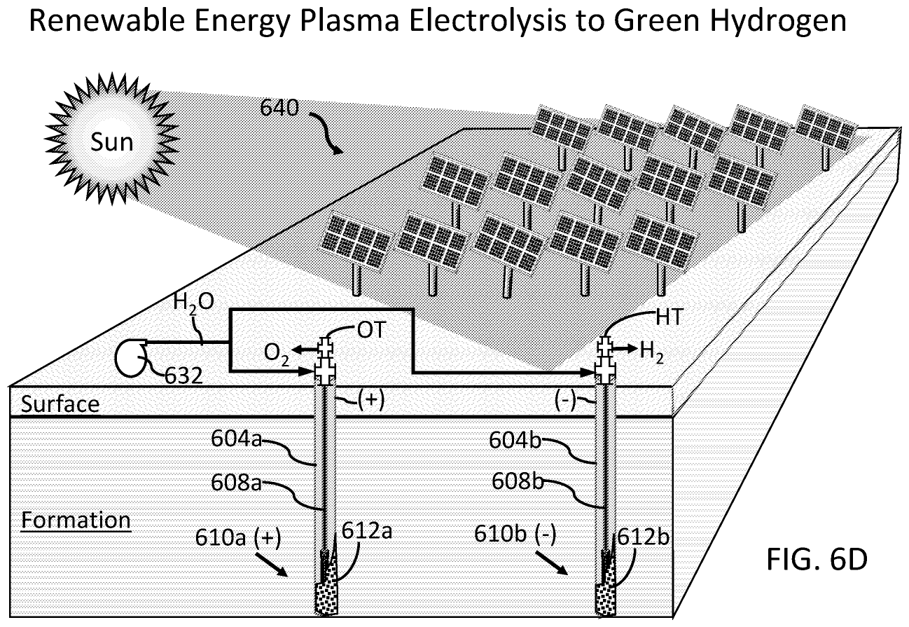

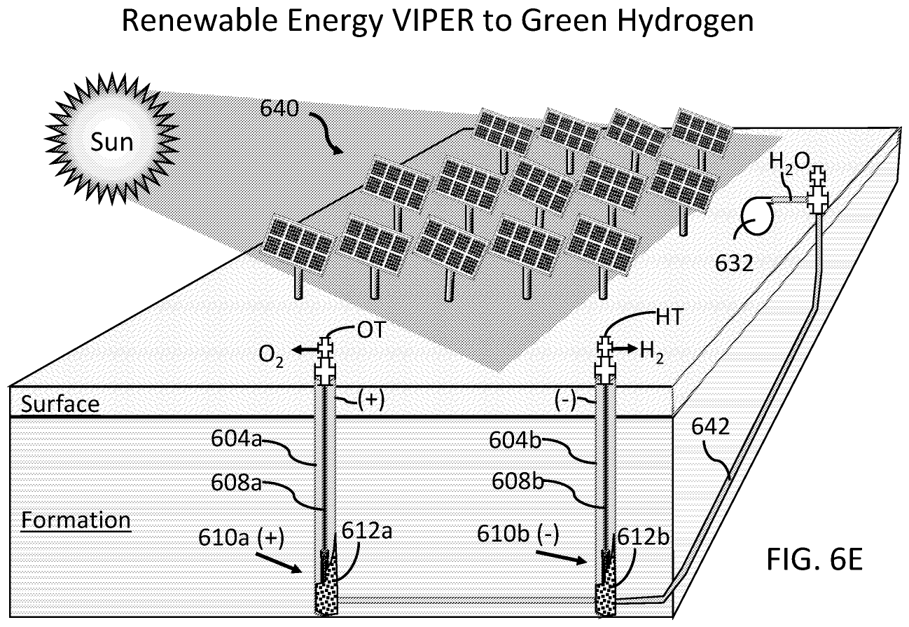

Referring now to FIG. 6A an offshore wind energy virtual inertia plasma electrolysis riser system (VIPER™) 600 includes an offshore wind turbine (WT) producing three phase AC electrical power (3PACP) connected to an AC to DC inverter, for example a silicon controlled rectifier (SCR), an IGBT or a magnetohydrodynamic drive. The DC power is directly connected to a plasma electrolysis system 602 that includes an anode column 604a and a cathode column 604b. The columns 604a and 604b are hung from the bottom or thru the moon pool of a vessel 606 in which the renewable power source, e.g., a wind turbine (WT), etc., is located topside. Each column 604a and 604b contains a riser 608a and 608b. Electrodes or susceptors 610a and 610b are attached to risers 608a and 608b. Column 604a and riser 608a are attached to an oxidant tree (OT), and column 604b and riser 608b are attached to a hydrogen tree (HT). If hydrogen and oxygen are to be split from seawater, then a reverse osmosis system can be installed onboard the vessel 606, or a subsea reverse osmosis system (SSRO) that produces distilled water (DI) may be installed on the seafloor. The distilled water (DI) is then used to generate the hydrogen and oxygen. Both columns 604 and 604b are filled or at least partially filled with a media 612a and 612b, such as proppants, to increase efficiency of the process. The OT produces oxygen and water. The HT produces hydrogen and water. Note that a vertical induction cracker, such as FIG. 3A, can be used in the plasma electrolysis system 602.

Current oil and gas barges, deepwater drilling ships and semisubmersible vessel equipment can be used for carrying out the present invention. For example, if a subsea reverse osmosis (SSRO) system is used, then the deepwater drilling ship would lower the subsea reverse osmosis (SSRO) and the columns 604a and 604b. The columns 604a and 604b then could be connected to a separate vessel 606, which incorporates the renewable power source. The columns 604a and 604b would be interconnected via piping from the subsea reverse osmosis (SSRO) in order to flow pressurized deionized water to each riser 608a and 608b. The following operating steps will demonstrate the industrial application of this embodiment of the present invention.

A plasma electrolysis startup mode is as follows:
1. Riser valves and column valves integrated into the oxidant tree (OT) and hydrogen tree (HT) are opened.
2 Distilled water (DI) is flowed from the subsea reverse osmosis (SSRO) into the columns 604a and 604b until distilled water (DI) flows out of the oxidant tree (OT) and hydrogen tree (HT) riser valves and production string valves.
3. Subsea reverse osmosis (SSRO) distilled water (DI) is diverted away from columns 604a and 604b.
4. Column valves are shut.
5. High pressure nitrogen is pumped into both risers 608a and 608b to form a bubble on top of the water within the risers 608a and 608b.
6. DC power is energized to both electrodes or wave energy source/susceptors 610a and 610b.
7. As pressure increases in both the columns 604a and 604b and risers 608a and 608b, risers valves are throttled to flow the nitrogen and then the oxidant and hydrogen into the oxidant tree (OT) and hydrogen tree (HT).

A plasma electrolysis operating mode is as follows:
1. Distilled water (DI) flow is resumed to columns 604a and 604b.
2. Oxidant pressure and hydrogen pressure are monitored and maintained by throttling riser valves and diverting distilled water (DI) from the subsea reverse osmosis (SSRO) system.

Note that hydrostatic pressure provides the means for pressurizing the hydrogen. Thus, a separator hydrogen compressor is not needed for carrying out the present invention. Likewise, the hydrogen can be injected into natural gas pipelines for distribution of hydrogen enriched natural gas (HENG).

### VIPER™ Tunnel

FIGS. 6B, 6C, 6D and 6E disclose zero carbon emitting power for water splitting with a virtual inertia plasma electrolysis reactor (VIPER™) tunnel system. The term “tunnel” herein refers to any inground or subsurface well, depression, pool, cavern, pipeline or hole whether horizontal, vertical or any orientation thereof.

Now referring to FIG. 6B, a power plant in which AC power is rectified into high voltage direct current (HVDC) utilizing a line-commutate current converter (LCC) or voltage sourced converter (VSC) 620 for powering a virtual inertia plasma enabled reactor (VIPER™) tunnel system 622 in accordance with one embodiment of the present invention is shown. Electricity 624 is provided to the VIPER™ tunnel system 622. In addition, cooling water 626 flows into the cooling tower 628 and the return water 630 is provided to the VIPER™ tunnel system 622. FIG. 6B is shown in FIG. 6C, which discloses the power plant's LCC or VSC connected to an anode well or column 604a and a cathode well or column 604b. Wells or columns 604a and 604b and/or drill strings or risers 608a and 608b are filled or partially filled with media 612a and 612b, such as proppants. A high pressure pump 632 provides pressurized water H₂O to wells or columns 604a and 604b via surface injection through the oxidant tree (OT) and the hydrogen tree (HT). When direct current DC power flows to the electrodes or wave energy source/susceptors 610a and 610b, water is split via plasma electrolysis into hydrogen and oxygen, which flow to the surface and exit via the oxidant tree (OT) and hydrogen tree (HT).

Referring now to FIG. 6C, a solar farm 640 directly connected to an anode well or column 604a and a cathode well 604b in accordance with one embodiment of the present invention is shown. Wells or columns 604a and 604b and/or drill strings or risers 608a and 608b are filled or partially filed with media 612a and 612b, such as proppants. A high pressure pump 632 provides pressurized water H₂O to wells or columns 604a and 604b via surface injection through the oxidant tree (OT) and the hydrogen tree (OT). When direct current power flows to the electrodes or wave energy source/susceptors 610a and 610b, water is split via plasma electrolysis into hydrogen and oxygen, which flow to the surface and exit via the oxidant tree (OT) and hydrogen tree (HT).

Now referring to FIG. 6D, a solar farm 640 directly connected to an anode well or column 604a and a cathode well 604b that are interconnected with a lateral well 642 in accordance with one embodiment of the present invention is shown. Wells or columns 604a and 604b and/or drill strings or risers 608a and 608b are filled or partially filed with media 612a and 612b, such as proppants. A high pressure pump 632 provides pressurized water H₂O to wells or columns 604a and 604b via surface injection through the oxidant tree (OT) and the hydrogen tree (OT). When direct current power flows to the electrodes or wave energy source/susceptors 610a and 610b, water is split via plasma electrolysis into hydrogen and oxygen, which flow to the surface and exit via the oxidant tree (OT) and hydrogen tree (HT).

In another embodiment of the present invention, a power flex mode system for providing virtual inertia while producing hydrogen includes: a first well partially filled with media covering an anode electrode; a second well partially filled with media covering a cathode electrode; a water conduit connecting the first well anode electrode to the second well cathode electrode; an AC power to DC power inverter; one or more solar panels connected to the anode electrode and the cathode electrode; and wherein energizing the DC circuit produces a hydrogen on the cathode electrode and produces an oxidant is on the anode electrode.

In another embodiment of the present invention, a solar power system for providing virtual inertia while producing hydrogen includes: a first well partially filled with media covering an anode electrode; a second well partially filled with media covering a cathode electrode; a water conduit connecting the first well anode electrode to the second well cathode electrode; one or more solar panels connected to the first well anode electrode and the second well cathode electrode; and wherein energizing the DC circuit produces a hydrogen on the cathode electrode and produces an oxidant on the anode electrode.

Methane Vacuum UV Photolysis with AC/DC Virtual Inertia Wave Energy Brake

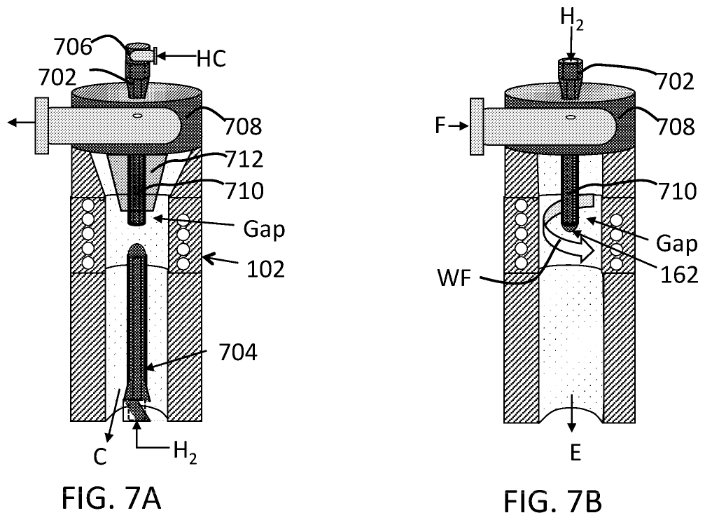

Natural Gas can be split into hydrogen and carbon via photolysis with vacuum ultraviolet light (VUV) produced from the present invention. This can be accomplished by generating a hydrogen plasma which emits in the VUV spectrum. Referring to FIGS. 7A and 7B but not being bound by theory, the graphite electrodes can be heated to a temperature to emit Vacuum UV via induction or electrical arc or a combination of both, thus the natural gas will be split into hydrogen and carbon via photolytic fission (photolysis). As the less dense hydrogen is whirled near the electrodes/scepters, it will form a hydrogen plasma thus emitting within the Lyman Band. This will further enhance photolysis of natural gas. For operation with an AC circuit only, the RF coil would be energized and the DC circuit would not be energized for three phase plasma dynamic braking applications. Likewise, for operating with solar or any DC circuit, the plasma arc would be the virtual inertia for controlling a DC grid. This AC/DC virtual inertia wave energy brake is shown with susceptor 702 and 704 in FIG. 7A. A cyclone volute 706 would be fitted unto susceptor 702, which of course the tip would be cut off to allow for a hydrocarbon (HC) or any other fluid that can be treated with wave energy to enter into the volute 708. Susceptor 704 would retain its porous tip. As the fluid whirls down the bore 710 it heats up. Next the fluid, for example methane, exits the bore and enters into the plasma and is cracked into hydrogen and carbon. When the methane cracks into hydrogen and carbon, the gas stream will increase in volume four times which uses the conservation of angular momentum to separate the hydrogen from the carbon.

Since the whirl will increase in velocity and carbon is more dense then hydrogen it will spin out to the walls of the housing. However, to aid in separating the hydrogen from carbon a vortex finder 712 is installed within the large volute 708. The less dense hydrogen will report to the vortex finder 712 and exit the large volute 708 as shown by Arrow H₂. Once again the system of FIG. 7B can replace the inductively coupled plasma ArcWhirl® as an AC/DC virtual inertial wave energy brake.

Returning now to FIG. 1C, a hydrogen plasma can be formed for photolysis of natural gas by introducing hydrogen into the bore as shown by arrow 168. As the H₂ exits the porous tip 162, it will form a hydrogen plasma. Natural gas would be introduced into the assembly 160 tangentially to form whirl flow as shown by arrow 166 and the resulting products from photolytic fission of natural gas—hydrogen and carbon—would be separated with a cyclone separator. This configuration is shown as FIG. 7B. Once again, a hydrogen plasma is formed as H₂ exits the porous tip 162. A fluid (F) (e.g., natural gas) would flow into the volute 708 and form a whirling flow. The whirling natural gas would split due to photolytic fission into hydrogen and carbon. The hydrogen and carbon would exit as shown by arrow E, to separation means known in the art such as a cyclone separator. On the other hand, FIG. 7B can be operated as a whirl combustor for zero carbon emissions by simply using air or oxygen as fluid (F).

### DC Plasma Electrolysis Virtual Inertia Braking

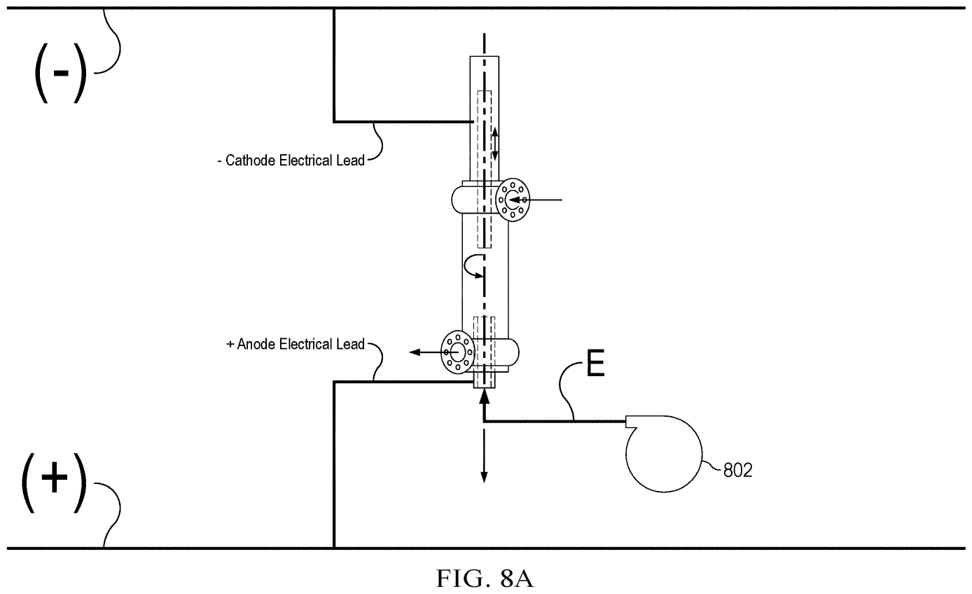

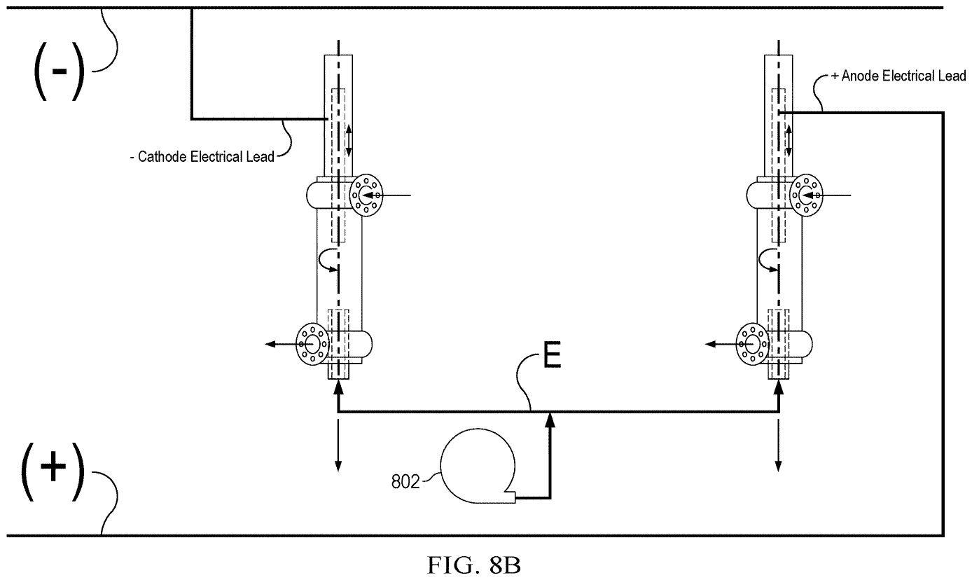

The ability to stabilize the frequency or power output from a DC microgrid or solar photovoltaic panels (solar farm) while manufacturing steam, hydrogen, oxygen, chlorine or bleach is unheard of. The ArcWhirl® as shown in FIG. 8 can be operated in electrolysis or plasma electrolysis (glow discharge plasma) modes for splitting water from pump 802 while providing virtual inertia for a DC Grid.

### Unexpected Results

The multiple mode ArcWhirl® was setup to operate in multiple modes but without moving the electrode. The ArcWhirl® was oriented in a vertical position with V1 of at the top and V3 at the bottom. A DC silicon controlled rectifier (SCR) (ESAB ESP-150) with an open circuit voltage of 380 VDC was used for the test. Since there was no electrical connection within the circuit when the SCR was energized there was very little power output from the DC power supply. An electrolyte consisting of water and baking soda was flowed up and into inlet/outlet V3. The electrolyte completed the circuit by shooting through (+) anode nozzle and coupling to the (−) cathode rod. Upon closing the circuit with the electrolyte the DC power supply was operating at maximum continuous duty cycle at 380 VDC and 90 amps. The ESAB ESP-150 power supply is rated at a continuous duty of 35 kw. The ArcWhirl® produced an orange glow discharge since sodium emits within the orange spectrum. What is completely unexpected is that the multiple mode ArcWhirl® can be used in a DC circuit in a parallel configuration to control a DC grid while also making hydrogen and oxygen. The system can be immediately turned on/off via flowing water up and into the ArcWhirl®. The ArcWhirl® in effect is its own DC circuit breaker using only an electrolyte to make or break the circuit. It will be understood that the ArcWhirl® can be placed in series with either a DC or AC circuit and used as a liquid circuit breaker.

Referring to FIG. 8B, but not being bound by theory, two ArcWhirls® may be piped together, and electrically wired such that one is the cathode and the other is the anode. This separates the production of hydrogen from oxygen. This would allow for extremely high pressure operation, if for example a common water pressure sprayer or an oil and gas frac pump 802 is used to provide the water pressure.

Plasma Electrolysis has a much higher transmitted power density then Faraday Electrolysis. Thus, for the same power input a smaller reactor can be used, thus saving in manufacturing costs. Not being bound by theory, reactions in plasma electrolysis are much more intense and occur at speeds much faster than Faraday Electrolysis.

### Stopper Rod Plasma Electrolysis Electrode

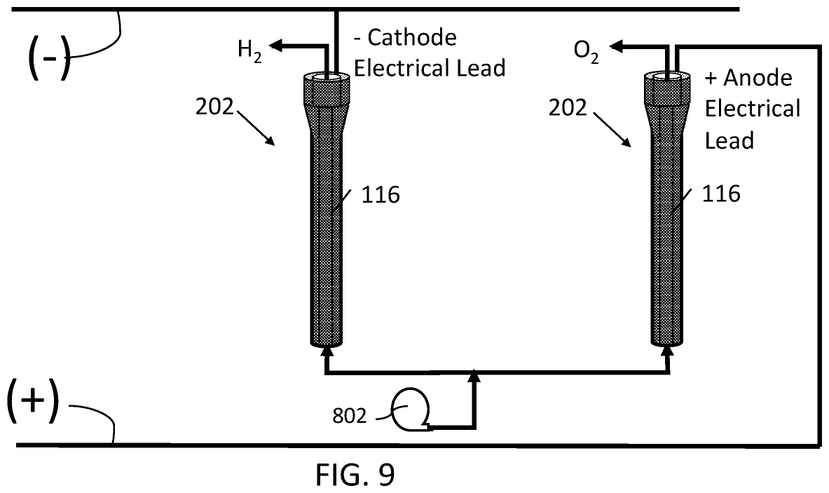

Once again by cutting off the tip 122 of the susceptor 106 shown in FIG. 1A it can be used as an electrode within a plasma electrolysis cell as shown in FIG. 9. However, since the exterior of the susceptor 106, 202 has a glaze that electrically insulates the susceptor 106, 202, then both susceptors 202 as shown in FIG. 9 can be immersed within the same tank since electrolysis and/or plasma electrolysis will occur primarily within the bore 116 of the susceptors 202. Of course the exits for each susceptor 202 would be piped separately for collecting hydrogen and oxygen. This configuration allows for a very simple system, method and apparatus for producing green hydrogen while also providing virtual inertia to a DC grid.

### Twin Whirl Plasma Electrolyzer

The inventor's U.S. Pat. No. 10,030,195 and European Patent No. 2931849 disclose the TWIN WHIRL™ or TWIRL™ hydrocyclone systems, which are hereby incorporated by reference in their entirety.

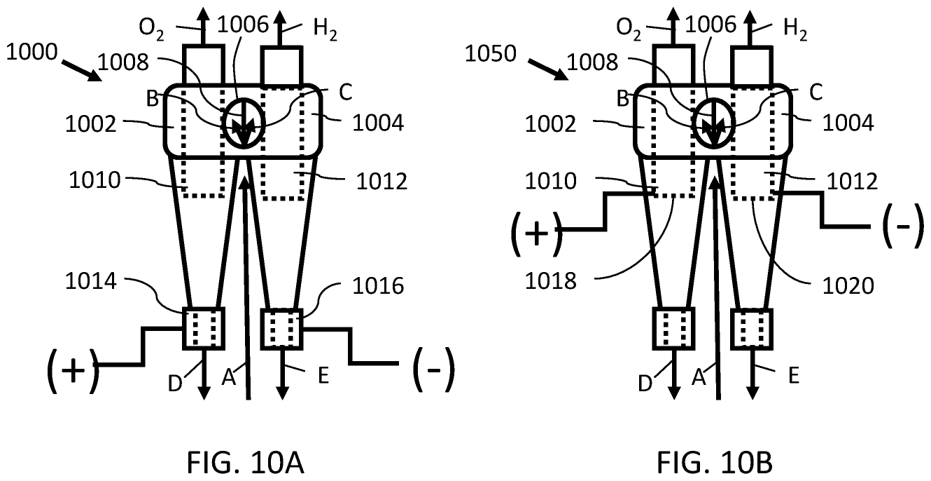

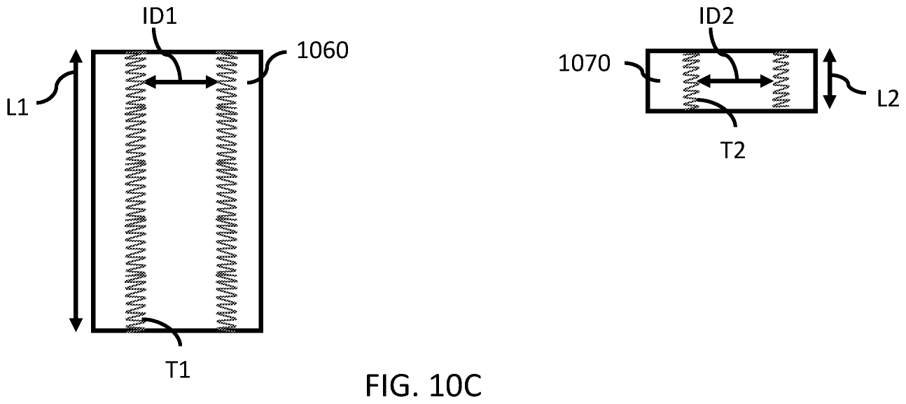

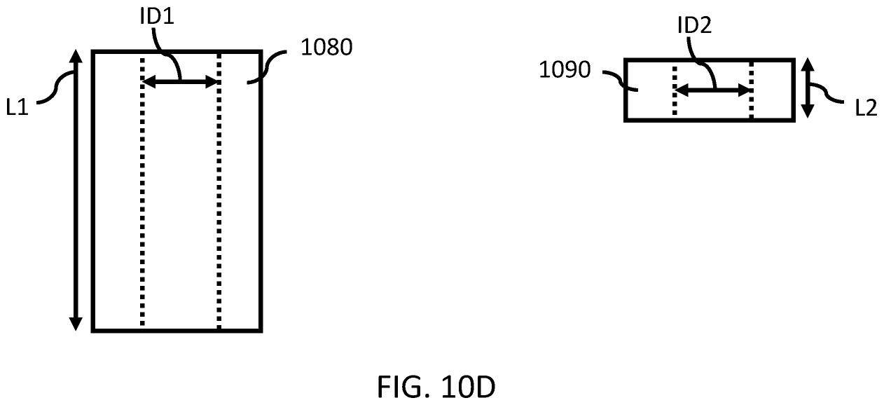

Now referring to FIG. 10A, a twin whirl hydrocyclone 1000 comprising mirror image hydrocyclones 1002 and 1004 physically conjoined with a single inlet 1006 with a divider 1008 that splits flow as shown by arrow A into separate streams as shown by arrows B and C into the left hydrocyclone 1002 and the right hydrocyclone 1004. As used herein, conjoin refers to at least two hydrocyclones joined with one common inlet, such that a fluid with electrical conductivity (EC) entering the hydrocyclones will provide an electrical path to at least one electrode in a first hydrocyclone and at least one electrode in a second hydrocyclone. It will be understood that the twin whirl hydrocyclone 1000 would be manufactured using electrically insulating material or all interior components with the exception of the electrodes are coated with a non-conductive material.

As the fluid is split into streams B and C the fluid whirls around the outside of vortex finders 1010 and 1012.” The fluid continues in a whirl flow down the hydrocyclones 1002 and 1004 and enters into electrode apex valves 1014 and 1016. Most hydrocyclones have a plastic or rubber insert nozzle held in place with a retaining nut. When the retaining nut is screwed into the exterior threads of the hydrocyclone is squeezes the insert nozzle. As the insert is squeezed the hole diameter thru the insert nozzle becomes smaller, hence the name apex valve. The fluids are separated due to densities. Less dense fluids will report to the vortex finder while more dense fluids will go out through the apex valve. Although conductive silicone rubber is available, for sake of simplicity electrically conductive solid nozzle electrode nuts 1014 and 1016 will be described to practice the present invention. It will be understood that an electrode insert nozzle (apex valve) can be used in lieu of electrode nuts 1014 and 1016. The most important attribute is that the interior of the electrode nuts 1014 and 1016 must be electrically conductive so that the whirling fluid contacts an electrically conductive surface that is wired to a DC circuit.

For illustration purposes only, the left-hand side hydrocyclone 1002 electrode nut 1014 is wired to the (+) positive side of a DC circuit. The right-hand side hydrocyclone 1004 electrode nut 1016 is wired to the (−) negative side of a DC circuit. It will be understood that the polarities can be switched for the left-hand side and right-hand side hydrocyclones. When power is applied to the DC circuit and a conductive fluid is flowed into the Twin Whirl Hydrocyclone 1000, the circuit will effectively be closed due to the conductivity of the fluid. Oxygen will be generated on the anode (+) nut threads 1014 and hydrogen will be generated on the threads of the cathode (−) nut 1016.

Since both oxygen and hydrogen are gases, the oxygen will go to the eye of hydrocyclone 1002 and into vortex collector 1010 and exit as shown by arrow O₂ and hydrogen will go to the eye of hydrocyclone 1004 and into vortex collector 1012 and exit as shown by arrow H₂. The conductive fluid will exit from the electrode nut 1016 Arrow E and electrode nut 1014 arrow D. The fluid flowing from both electrode nuts can be back mixed into a tank or flowed into separate containers.

### Vortex Finders or Sleeve Inserts

FIG. 10B discloses a twin whirl hydrocyclone 1050 that is very similar to the twin whirl hydrocyclone 1000 of FIG. 10A except that the vortex finders 1010 and 1012 or an insertable sleeve are the electrodes and connected to opposite polarities of a DC power source. For illustration purposes only, the left-hand side hydrocyclone 1002 vortex finder 1010 is wired to the (+) positive side of a DC circuit. The right-hand side hydrocyclone 1004 vortex finder 1012 is wired to the (−) negative side of a DC circuit. It will be understood that the polarities can be switched for the left-hand side and right-hand side hydrocyclones. When power is applied to the DC circuit and a conductive fluid is flowed into the twin whirl hydrocyclone 1050, the circuit will effectively be closed due to the conductivity of the fluid. Oxygen will be generated on the anode (+) vortex finder 1010 and hydrogen will be generated on the cathode (−) vortex finder 1012.

### Electrode Nut

Referring now to FIG. 10C, the electrode nut can screw into an electrically non-conductive exterior threaded tube. What is unique about the electrode nut is that the threads increase the surface area. In addition, the opposing hydrocyclones of FIGS. 10A and 10B should use electrode nuts that are threaded in the same whirl direction as the fluid to maintain whirl flow. In other words, one nut would have reverse threads. It will be understood that the exterior of the nut or the nut itself can be coated or cast within an electrically non-conductive exterior material.

Furthermore, by using acme type threads on the exterior of the tube and acme threads on the interior of a very long nut, the nut can be adjusted for exposing various amounts of surface area between the anode nut and the cathode nut. This is important for being able to adjust the system so that it will operate in plasma electrolysis mode. It will be understood that a lug or mechanical linkage must be attached or affixed on the nut in order to connect the DC power source lead to the nut or nozzle insert.

A first electrode 1060 and a second electrode 1070 are shown in FIG. 10C. The first threaded electrode 1060 has a length L1 and an inside diameter ID1 with threads T1. On the other hand, the second electrode 1070 has a length of L2 and an inside diameter ID2 and threads T2. Through experimentation, the inventor determined that a surface area ratio of 2:1 or greater is necessary to ignite, confine and sustain a plasma sheath on the electrode with less surface area. However, as previously disclosed the threaded electrodes can be screwed in and out to ensure that the surface areas are significantly different to ensure the apparatus will operate in plasma electrolysis mode. But this introduces a mechanical or electro-mechanical means for moving the electrode in or out. Or an operator must do it by hand. However, an electrode vortex finder or sleeve insert as shown in FIG. 10D solves this problem.

It will be understood that in lieu of the entire vortex finder being made of an electrically conductive material, it may be made of the same electrically non-conductive material as the conjoined hydrocyclones. Consequently, as shown in FIG. 10D, electrically conductive sleeve 1080 having a length L1 and an inside diameter ID1 is inserted into vortex finder 1010, and an electrically conductive sleeve 1090 having a length L2 and an inside diameter ID2 is inserted into vortex finder 1012 such that the fluid is whirled and forced against the interior walls of the sleeves within the vortex finders. Thus, the electrically conductive fluid completes the electrical circuit between the two electrodes. It will be understood that one of the sleeves or vortex finders may be smaller than the other in surface area exposed to the fluid to ensure that a plasma forms on one electrode. This can be accomplished by using a smaller electrode, or coating, spraying, painting or gluing an electrically non-conductive material unto the one of the electrodes.

One advantage of the hydrocyclone electrolyzer is that hydrocyclones used in upstream oil and gas applications, such as desanders and cyclone separators found in refineries and chemical plants, are manufactured for pressures exceeding 700 BAR (10,100 psig). Thus, to pressurize the hydrogen and oxygen only requires a high-pressure pump, which consequently eliminates expensive hydrogen compressors.

Likewise, since oxygen and hydrogen are gases, both will immediately report to the eye. Not being bound by theory, since the cathode can operate in plasma electrolysis mode, it will produce more hydrogen per unit of electricity input than faraday electrolysis.

In another embodiment of the present invention, a plasma electrolysis apparatus includes a pair of non-conductive conjoined hydrocyclones having a single inlet, an oxidant outlet and a hydrogen outlet, a first side cone side having a first electrically conductive part and a second cone side having a second electrically conductive part.

In one aspect, the first and second electrically conductive parts are wired to opposite polarities of a DC power source. In another aspect, one of the first or second electrically conductive parts is smaller than the other electrically conductive part; or one of the first or second electrically conductive parts is partially coated with an electrically non-conductive material to decrease its electrically conductive surface area as opposed to the other electrically conductive part. In another aspect, the first and second electrically conductive parts comprise a first and second electrically conductive apex valve nuts. In another aspect, the first and second electrically conductive apex valve nuts have electrically conductive threads. In another aspect, the first and second electrically conductive parts comprise a first and second electrically conductive apex valve nozzle inserts. In another aspect, the first and second electrically conductive parts comprise a first and second electrically conductive vortex finder. In another aspect, only interior surfaces of the first and second electrically conductive vortex finders are electrically conductive. In another aspect, the first and second electrically conductive parts comprise a first and second electrically conductive sleeve inserted into the first and second vortex finders. In another aspect, only interior surfaces of the first and second electrically conductive sleeves are electrically conductive.

In another embodiment of the present invention, a method for making hydrogen with plasma electrolysis includes: providing a pair of non-conductive conjoined hydrocyclones having an oxidant outlet and a hydrogen outlet, a first side cone side having a first electrically conductive part and a second cone side having a second electrically conductive part; connecting the first and second electrically conductive parts to opposite polarities of a DC power source; flowing a fluid into the single inlet; and producing hydrogen and oxidants from the fluid using the plasma electrolysis from one of the electrically conductive parts as a cathode (−) and the other of the electrically conductive parts as an anode (+).

In one aspect, the first and second electrically conductive parts are wired to opposite polarities of a DC power source. In another aspect, one of the first or second electrically conductive parts is smaller than the other electrically conductive part; or one of the first or second electrically conductive parts is partially coated with an electrically non-conductive material to decrease its electrically conductive surface area as opposed to the other electrically conductive part. In another aspect, the first and second electrically conductive parts comprise a first and second electrically conductive apex valve nuts. In another aspect, the first and second electrically conductive apex valve nuts have electrically conductive threads. In another aspect, the first and second electrically conductive parts comprise a first and second electrically conductive apex valve nozzle inserts. In another aspect, the first and second electrically conductive parts comprise a first and second electrically conductive vortex finder. In another aspect, only interior surfaces of the first and second electrically conductive vortex finders are electrically conductive. In another aspect, the first and second electrically conductive parts comprise a first and second electrically conductive sleeve inserted into the first and second vortex finders. In another aspect, only interior surfaces of the first and second electrically conductive sleeves are electrically conductive.

In another embodiment of the present invention, an offshore wind turbine power system for providing virtual inertia while producing hydrogen includes: a first riser partially filled with media covering an anode electrode; a second riser partially filled with media covering a cathode electrode; a water conduit connecting the first riser anode electrode to the second riser cathode electrode; an AC power to DC power inverter; one or more solar panels connected to the anode electrode and the cathode electrode; wherein energizing the DC circuit produces a hydrogen on the cathode electrode and produces an oxidant on the anode electrode; and virtual inertia is applied to a wind turbine of the wind power system.

Virtual Inertia with DC Plasma Electrolysis

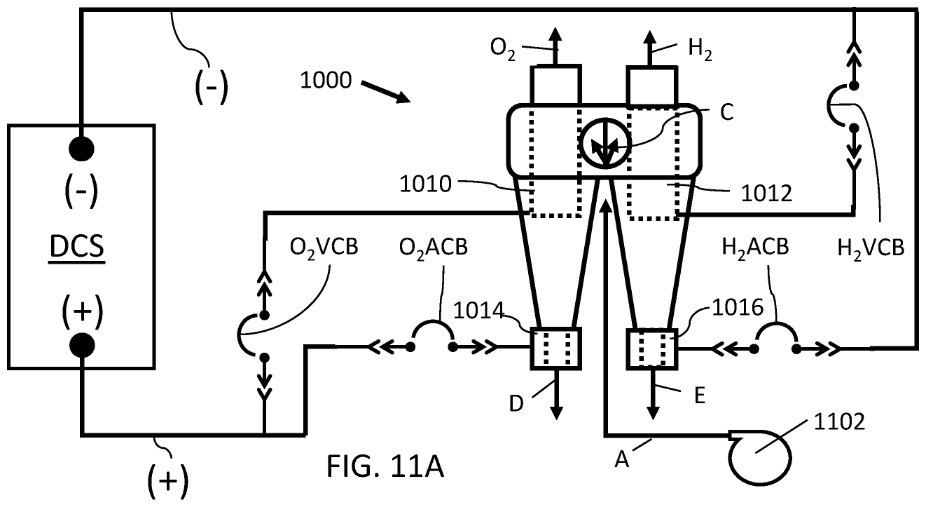

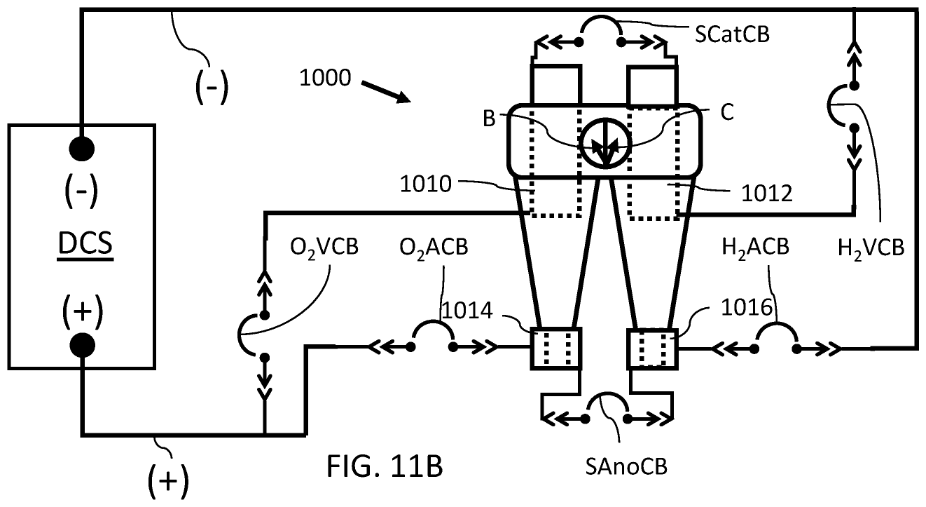

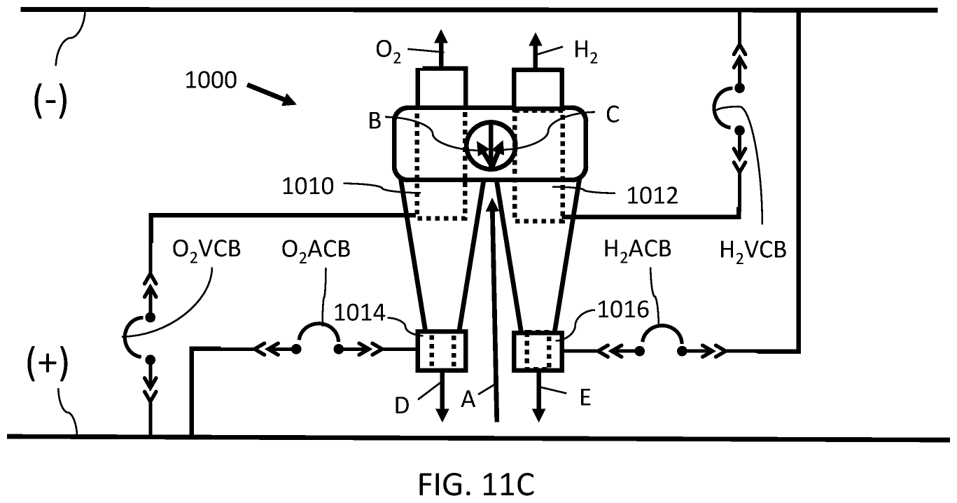

Now referring to FIGS. 11A, 11B and 11D, only a single twin whirl hydrocyclone 1000 of FIG. 10A is required to provide virtual inertia to an AC or DC grid. Note that twin whirl hydrocyclone 1050 of FIG. 10B may also be used. FIG. 11A discloses a twin whirl plasma electrolysis hydrocyclone 1000 connected to a DC Source (DCS). The negative cathode lead (−) contains two circuit breakers, one in line with the hydrogen vortex collector (H₂VCB) and another in line with the hydrogen apex valve (H₂ACB). Likewise, the positive anode lead (+) contains two circuit breakers, one in line with the oxygen vortex collector (O₂VCB) and the other in line with the oxygen apex valve (O₂ACB). Although circuit breakers are not necessary to practice the invention, the circuit breakers perform several functions. First, additional loads can be placed on the microgrid formed with the DC source. Second, the circuit breakers allow for energizing the vortex collector electrodes are the apex valve electrodes are any combination thereof for the right-hand side and left-hand side hydrocyclones. Third, the TWIRL™ plasma electrolyzer can provide virtual inertia to the DC microgrid by simply turning ON a pump 1102. On the other hand, the pump 1102 can remain on while all circuit breakers are open. Next, by closing one oxygen circuit breaker and one hydrogen circuit breaker the TWIRL™ plasma electrolyzer will begin to provide virtual inertia to the DC microgrid while making green hydrogen and oxygen.

Referring now to FIG. 11B additional circuit breakers (SCatSB) and (SAnCB) are added for production of steam or hydrogen and oxygen. Consequently, this unique and unobvious configuration will be described in TABLE 3 for production of hydrogen and oxygen or steam:

TABLE 3
CIRCUIT BREAKER POSITION

| Breaker | H₂ and O₂ | | |
|---|---|---|---|
| Name | Production | Steam Production 1 | Steam Production 2 |
| SCatCB | Open | Closed | Closed |
| SAnCB | Open | Closed | Closed |
| O₂VCB | Closed | Open | Closed |
| O₂ACB | Closed | Closed | Open |
| H₂VCB | Closed | Closed | Open |
| H₂ACB | Closed | Open | Closed |

The difference between operating in plasma electrolysis or faraday electrolysis is simply opening or closing the hydrogen vortex finder circuit breaker (H₂VCB). Opening H₂VCB reduces the cathode electrode surface area such that the ratio of anode surface area to cathode surface area is at least 2:1.

However, for steam plasma electrolysis mode as shown in FIG. 11B, additional circuit breakers SCatCB and SAnoCB would be added to electrically connect the two vortex finders and electrically connect the two apex valve electrodes. As shown in TABLE 3 there are two steam modes. Steam Production 1 and Steam Production 2 modes are enabled by electrically switching the vortex finder electrodes and apex valve electrode to be either the anodes or cathodes.

FIG. 11C discloses the twin whirl electrolyzer 1000 electrically connected to a DC Microgrid, although the steam production circuit breakers SCatSB and SAnCB are not shown but in practice would be included for production of steam or hydrogen and oxygen while providing virtual inertia to the DC microgrid. This would be ideal for any city that requires district heating during the winter yet during the warmer months would produce hydrogen in lieu of steam.

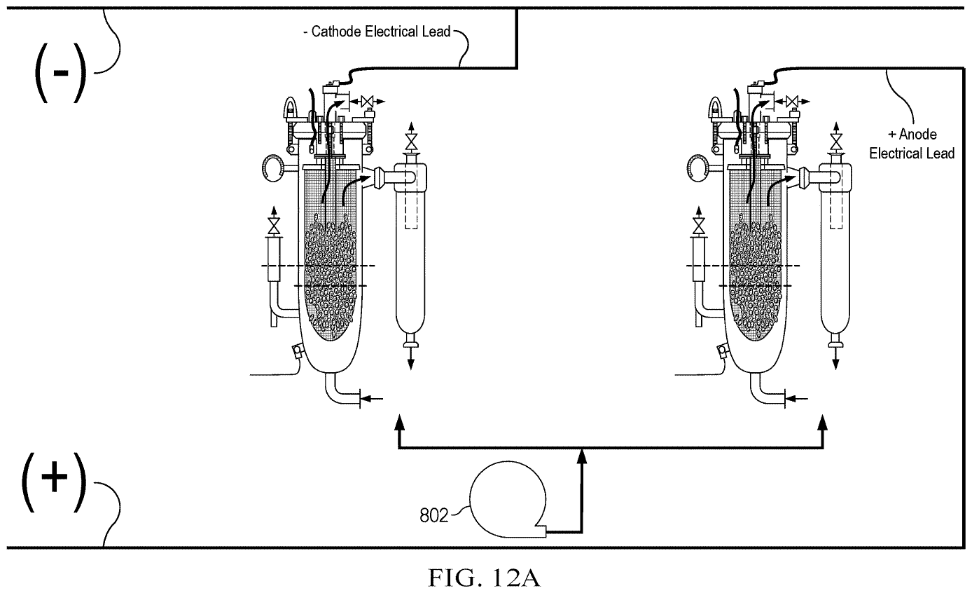

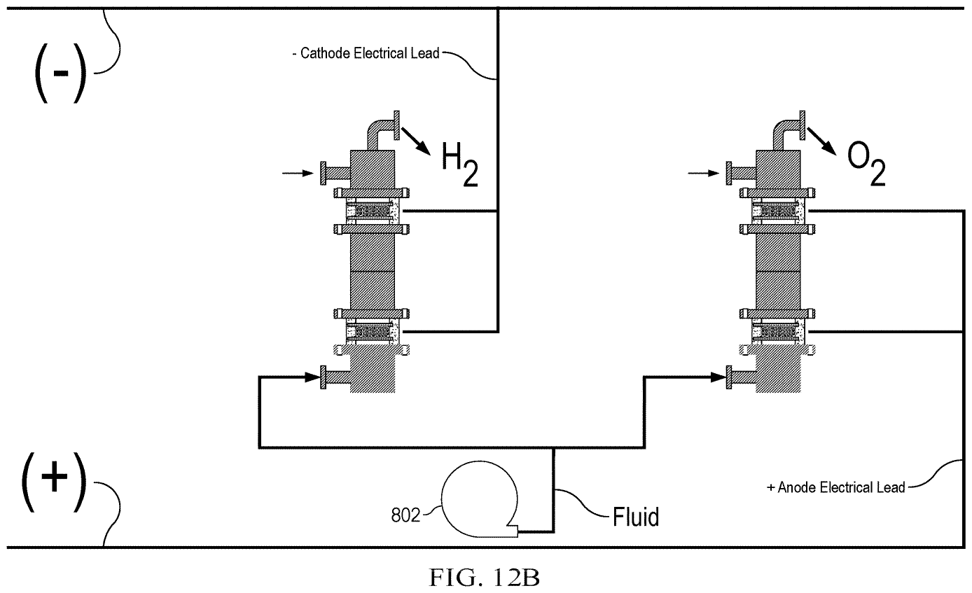

Now referring to FIG. 12A, the present inventor's plasma electrolysis cells, referred to as the HiTemper™, are electrically connected to a DC microgrid for production of hydrogen and oxygen while providing virtual inertia. Similarly FIG. 12B shows the present inventor's plasma electrolysis cells electrically connected to a DC microgrid to provide virtual inertia while producing production of hydrogen and oxygen.

### Wayside Dynamic Plasma Braking for 3^{rd} Rail or Catenary Electric Trains

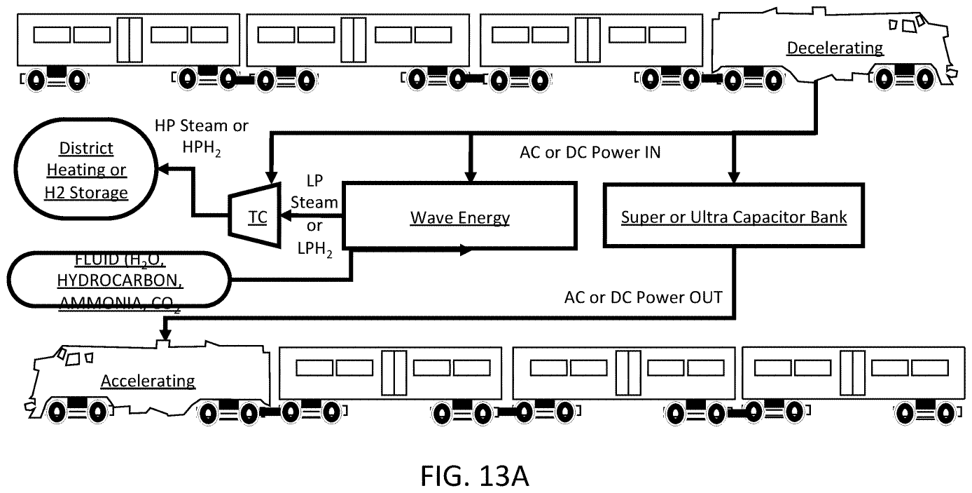

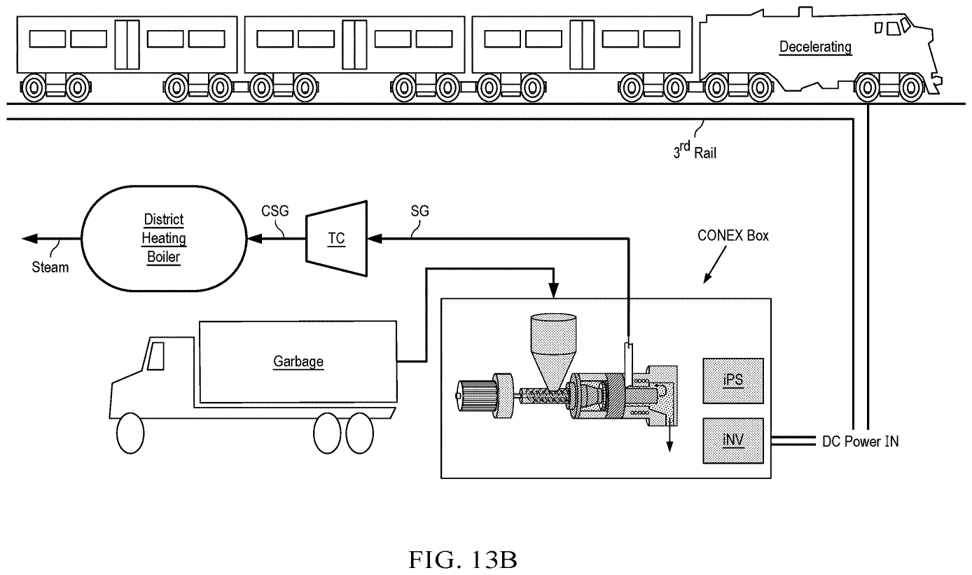

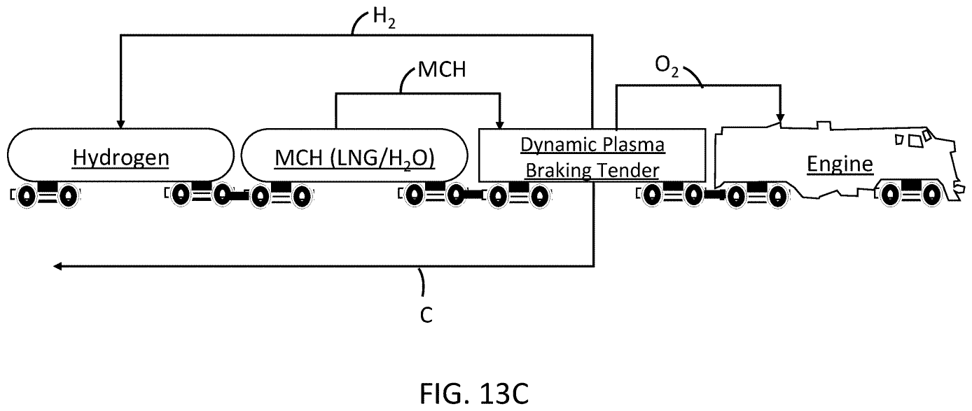

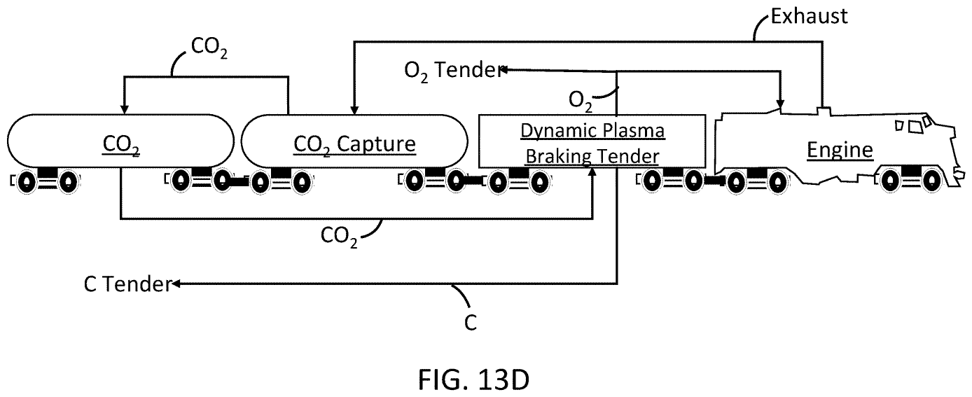

Referring now to FIG. 13A, any DC wave energy systems, methods and apparatuses can be used for providing virtual inertia for subways and trains. The decelerating train would provide power to the DC Wave Energy System which of course provides virtual inertia in lieu of transferring power to an accelerating train. A fluid, for example water with a sufficient conductivity would be used to produce steam or hydrogen and oxygen based upon the time of year. For example, during winter months, the Wave Energy Virtual Inertia system would make steam for district heating. However, during summer months, the Wave Energy Virtual Inertia System would make hydrogen and oxygen.

### Wayside Dynamic Plasma Reactor for Garbage to Syngas to Reduce Rat Problems

New York City and many large cities have a rat problem. The problem stems from garbage being placed streetside. However, NYC can solve this problem using a Wave Energy more specifically Induction and/or Plasma Reactors along all subway routes. The DC power produced during deceleration would be used to power the Wave Energy Systems. Likewise, the DC Plasma Reactors will provide virtual inertia for stabilizing the DC grid used for powering subway trains.

FIG. 13B discloses a stationary Dynamic Plasma Braking Virtual Inertia System, Method and Apparatus for producing SYNGAS from garbage and subway wastewater. The two feedstocks, garbage and wastewater are fed to the Wave Energy System. An ideal DC wave energy system are susceptor systems disclosed in FIGS. 1A to 3E. Specifically, FIGS. 2B and 2C are well suited for operating on a DC grid specifically 3^{rd} rail. For example, referring to FIGS. 13B and 2B, the screw feeder induction heater is installed in a CONEX Box. It is located near DC power. DC power is fed into the CONEX Box and into an inverter iNV, such as Nova Inverters which are available in various sizes that are currently utilized by Amtrack and the MBTA for powering equipment on third rail 450-750 VDC work train applications. Next, the DC is inverted to AC for powering an induction power supply iPS. Consequently, this makes induction an ideal fit for installing CONEX Boxed Garbage Induction Gasifiers along any Subway Line throughout a city or along the rail for highspeed trains. This eliminates landfilling and the syngas SG can be compressed with a turbocompressor TC and piped to a boiler for making steam for district heating. PlasmaWhirl® CONEX Boxes can be installed throughout a city in close proximity to DC power to provide virtual inertia to the DC grid.

FIG. 13C discloses an onboard/mobile dynamic plasma breaking tender for cracking/splitting MCH. Upon breaking, MCH (LNG/H₂O) is fed into the dynamic plasma braking eCracker. The MCH is be cracked into hydrogen (H₂), carbon (C) and oxygen (O₂). The oxygen is fed into the engine while the hydrogen is stored onboard in a hydrogen tender, and the carbon is stored onboard in a carbon tender.

Likewise, FIG. 13D discloses and onboard dynamic plasma braking cracker. But in this system, the CO₂ emitted from the train's engine would be captured and stored using methods known in the art such as zeolites. The CO₂ capture tanker releases its CO₂ and store it in the CO₂ storage tanker. Upon braking, the CO₂ is fed into the dynamic plasma braking eCracker. The CO₂ is cracked into carbon (C) and oxygen (O₂). The oxygen is fed into the engine while the carbon is stored onboard in a carbon tender.

eCRACKER with eTURBOEXPANDER

Referring now to FIG. 14A, the present inventor's plasma ArcWhirl® is an ideal photoreactor for carrying out the present invention. Natural gas feedstock (F) flows into a recuperator 1402 and is heated into warm feedstock (WF). Next, the warm feedstock (WF) flows into the plasma ArcWhirl® where VUV light splits the methane into hydrogen and carbon.

The VUV photons are produced due to forming a hydrogen plasma between the electrodes. When methane splits the hydrogen gas will increase the total gas volume within the ArcWhirl® by four times. Consequently, since the ArcWhirl® is a cyclone then a volume expansion of 4 times takes into effect the Conservation of Angular Momentum. Hence, the velocity of the gas stream must increase, thus spinning out the carbon to the walls of the ArcWhirl® while the hydrogen goes to the Eye and exits through the Vortex Collector. Some hydrogen will stay within the arc and produce a hydrogen plasma emitting in the VUV spectrum. The carbon will exit via the apex valve.

Once again since the gas stream expanded in volume by four times, then this helps in recovering energy by using an eTurbo or turbo expander comprising a turbine 1404 connected via a shaft 1406 to a motor generator 1408. eTurbos are common and thus this system, method and apparatus gives rise to an onboard vehicle system for converting LNG or CNG to hydrogen and carbon.

However, the hydrogen plasma exiting the ArcWhirl® needs to be cooled prior to entering the turbine 1404. The simplest cooling method is to inject water, thus forming steam which increases the mass flow into the turbine which increases power production. The Steam and Hydrogen (S+H₂) exits the turbine 1404 and flows into the recuperator 1402 which further cools the steam and H₂ by transferring its heat to the incoming hydrocarbon feedstock (F).

### Data Center

FIG. 14B is very similar to FIG. 14A, with the exception of an additional recuperator and a cooling water heat exchanger. The recuperator in the present invention is an HVAC system's condenser 1412. The condenser 1412 is a gas-to-gas heat exchanger in which LNG, CNG or LPG can be used as the coolant for condensing the AC refrigerant. Upstream of the condenser 1412 is a cooling water heat exchanger 1410 to precool the refrigerant prior to entering the condenser 1412.

Likewise, FIG. 14C is similar to FIG. 14B, but includes a heat exchanger 1414 for capturing the heat from the carbon by transferring it to the warm feedstock WF thus producing a hot feedstock (HF), which is used to drive a 2^{nd} turboexpander (TE2) in which the hot fluid exits the turboexpander TE2 as an expanded fluid (EF).

### Metal Oxides to Metals and Metalloids

FIG. 14D, which is similar to FIG. 14C, discloses a system for the production of metals and metalloids (M) from metal oxides (MO). As the hydrogen plasma (H₂P) exits the ArcWhirl®, a metal oxide (MO) (e.g., silica, etc.) is fed directly into the hydrogen plasma within a reactor 1416. The hydrogen reduces the silica to silicon, and the oxygen and hydrogen react to form superheated steam and excess H₂ as shown by arrow (SHS+H₂). The steam and hydrogen (SHS+H₂) drives the turbine of the turbine expander (TE1) for power production. Steam and any excess Hydrogen (S+H₂) flow into the recuperator 1402. If there is excess hydrogen it can be compressed with the compressor attached to the TurboExpander TE1.

H₂+N₂ for Ammonia Production

FIG. 14E discloses a system for producing hydrogen and nitrogen as a feedstock for an ammonia plant. As the hydrogen plasma H₂P exits the ArcWhirl®, air is underfed so that all of the oxygen in the air will be combusted to form steam and then the resulting steam, hydrogen and nitrogen flow into the turboexpander (TE1). The steam, hydrogen and nitrogen (Steam+H₂+N₂) exhaust from the turboexpander (TE1) and flows into the Recuperator 1402 in order to preheat the hydrocarbonfFeedstock (F) and condenses the steam. The nitrogen (N₂), hydrogen (H₂), and steam are used as the feedstock in an ammonia plant.

### Zero CO₂ 100% Hydrogen Fired Gas Turbine Engine

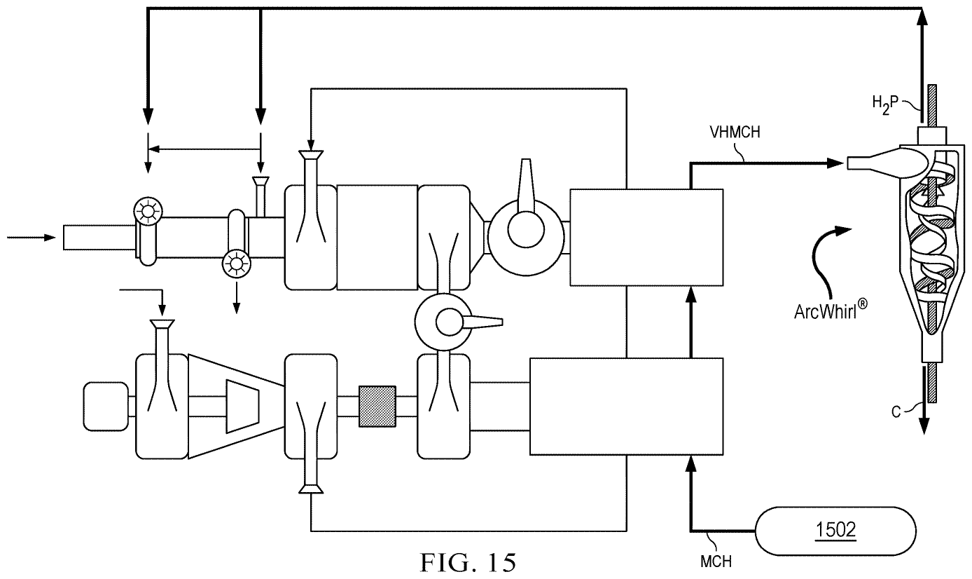

A wave energy hydrogen gas turbine system is disclosed in FIG. 15. A storage tank 1502 flows a molecule containing hydrogen (MCH) (e.g., LNG, CNG or LPG) into a 1^{st} Recuperator 228 and a 2^{nd} Recuperator of present inventor's lean combustion gas turbine engine (U.S. Pat. No. 9,869,277). The very hot molecule containing hydrogen (VHMCH) stream enters into the present inventor's plasma ArcWhirl® (U.S. Pat. No. 7,422,695 B2). Once again, VUV provides the wave energy for photolysis of the hydrocarbon molecule. The Hydrogen Plasma (H₂P) exits the ArcWhirl® and flows to the ArcWhirl® igniter 100 attached directly to the whirl combustor 204. As a result the hydrogen is lean combusted and flows into the turbine 214 thus providing rotational power and heat.

### High Temperature Plasma Electrolysis for Hydrogen Production

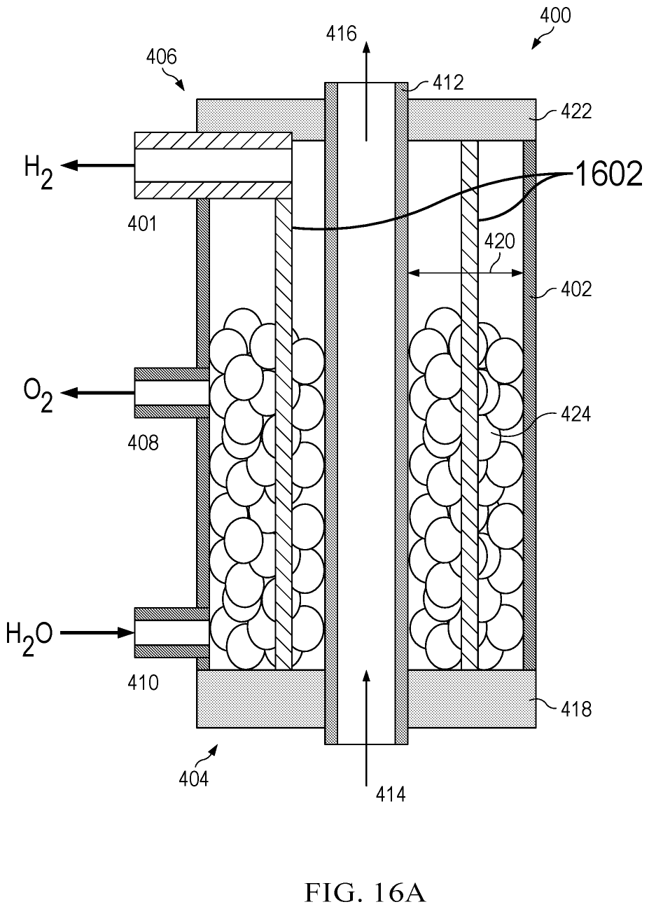

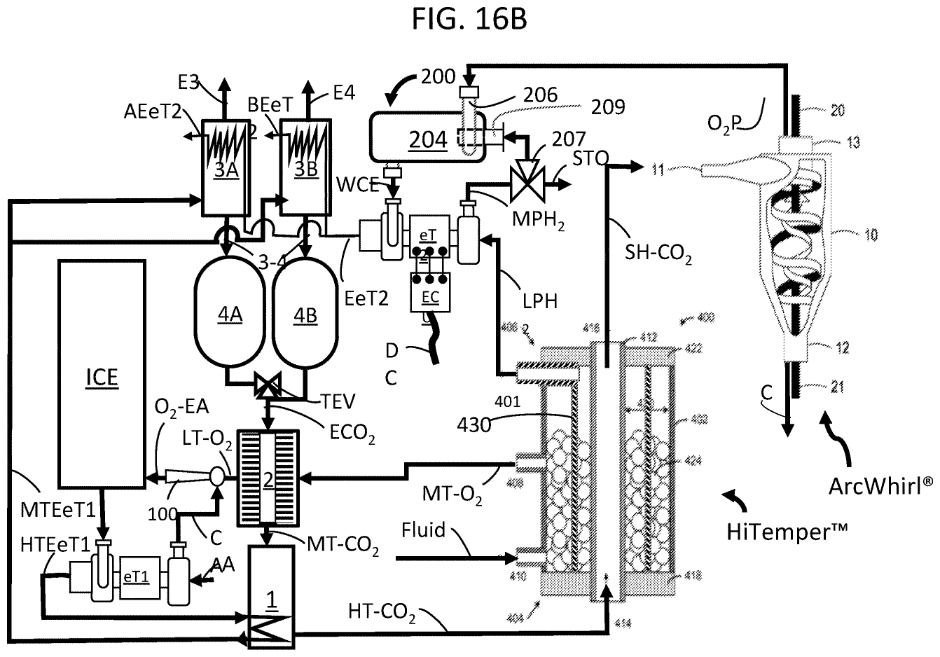

Referring to FIG. 16A, a tubular membrane 1602 is inserted into the plasma electrolysis cell 400 to separate the anode shell 402 from the cathode tube 412. Water (H₂O) is flowed into inlet 410. Oxygen (O₂) exits the anode compartment via outlet 408 and Hydrogen (H₂) exits the cathode compartment via outlet 401.

Carbon Capture and eCracking with Green Hydrogen Production

FIG. 16B discloses a carbon capture, eCracking and green hydrogen system. This system would be ideal for use as in the dynamic plasma braking tender of FIG. 13C. An internal combustion engine (ICE) flows its exhaust to an eTurbo (eT1). The hot turbo exhaust (HTEeT1) discharged from the eTurbo (eT1) flows into a 1^{st} recuperator 1 then out of the recuperator 1 and into CO₂ thermal regenerated fixed bed adsorbers 3A and 3B. The fixed bed adsorbers are filled with a solid adsorption media, for example ZSM-5 zeolite, zeolite 13×, Porocel's activated alumina Dynocel 628, activated carbon or porous activated ceramic beads, commonly referred to as proppants.

The CO₂ in the exhaust is adsorbed unto the media and the remaining exhaust gases such as steam, nitrogen and oxygen flow out of adsorbers 3A and 3B as shown by Arrows E3 and E4. Upon thermal regeneration, the CO₂ is desorbed and flows into CO₂ storage tanks 4A and 4B. It will be understood that 3A and 4A make up one process train while 3B and 4B make up another process train. Thus, one train is online and adsorbing CO₂ while the other train is thermally regenerating and desorbing CO₂. CO₂ from either tank 4A or 4B flows through thermal expansion valve (TEV) and then expanded CO₂ (ECO₂) flows into a 2^{nd} Recuperator 2 and medium temperature CO₂ (MT-CO₂) flows through the 1^{st} Recuperator 1 and high temperature CO₂ (HT-CO₂) flows into the HiTemper's tubular cathode 412 as shown by Arrow 414. The Super-Heated CO₂ (SH—CO₂) enters into the ArcWhirl® and is cracked into oxygen and carbon. The Oxygen Plasma (O₂P) exits the ArcWhirl® via vortex finder 13, while the carbon @ flows out of the ArcWhirl® through the apex valve 12.

It will be understood that the vortex finder 13 would be directly connected to the tangential entry of the whirl combustor 204 to form a whirling plasma. Hydrogen is injected into the eye of the whirl combustor 204 via an injector 207. Whirl combustor exhaust (WCE) flows into the turbine of a 2^{nd} eTurboCharger (eT2). The eTurboCharger Exhaust (EeT2) is used to thermally regenerate adsorbers 3A and 3B and exits as exhaust as shown by arrows AEeT2 and BEeT2.

Hydrogen is produced in the HiTemper™ plasma electrolyzer as shown in FIGS. 16A and 16B. The hydrogen exits the HiTemper™ plasma electrolyzer via outlet 401 as low pressure hydrogen (LPH₂), and inters into the suction side of the eTurboCharger's (eT2) compressor. The medium pressure H₂ (MPH₂) flows thru a three-way valve 207 to storage (STO) or is injected into the eye of the whirl combustor 204 via an injection quill 209.

Oxygen is produced in the HiTemper™ plasma electrolyzer as shown in FIGS. 16A and 16B. The oxygen exits the HiTemper™ plasma electrolyzer via outlet 408 as medium temperature O₂ (MT-O₂) which flows into a 2^{nd} Recuperator 2. The expanded carbon dioxide (E-CO₂) entering the 2^{nd} Recuperator 2 quickly cools the oxygen entering the 2^{nd} Recuperator 2. The low temperature oxygen (LT-O₂) exits the Recuperator 2 and enters into the suction side of a venturi 100. The motive fluid for the venturi 100 is the compressed air (CA) discharged from the 1^{st} eTurbocharger (eT1). The oxygen enriched air (O₂EA) discharged from the venturi 100 enters the internal combustion engine (ICE).

A wave energy system has been disclosed for low or zero carbon dioxide emissions from an internal combustion engine. Although not shown, the internal combustion engine may be used for producing rotational energy to drive a generator, pump, compressor, truck, vehicle, train or even an aircraft. For stationary applications, the HiTemper™ and ArcWhirl® can provide virtual inertia for DC microgrids. Although not shown the apparatus of FIG. 7A may replace the ArcWhirl® of FIG. 16B, thus allowing for virtual inertia on DC and/or AC Grids.

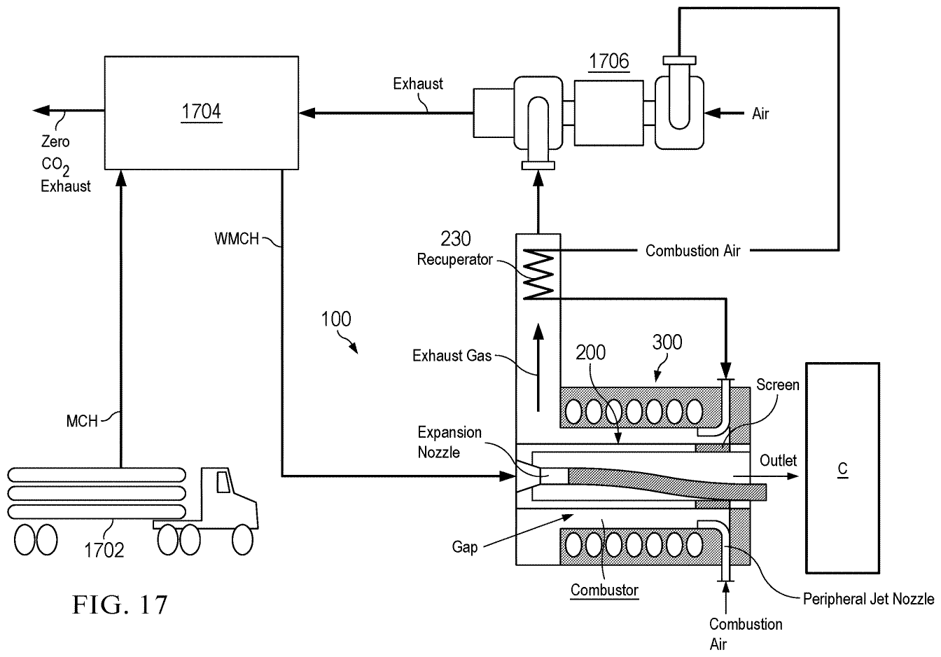

FIG. 17 discloses a system for zero carbon emissions power from hydrocarbons or any molecule containing hydrogen (MCH). A tube trailer truck 1702 delivers a compressed hydrocarbon (e.g., CNG, etc.) to a site requiring zero carbon emissions power. The molecule containing hydrogen (MCH) flows into a recuperator 1704 and exits as a warm molecule containing hydrogen (WMCH). Next it flows into the present inventor's patented induction kiln and the MCH is cracked into hydrogen and carbon. The hot combustion air entering the annulus via jet nozzles forms a venturi and pulls a suction on the hollow susceptor thus drawing the hydrogen thru the screen. The susceptor is induction heated and the exterior will be very hot thus it provides the energy to ignite the air and hydrogen mixture. This provides additional energy to heat the susceptor tube. The hot exhaust gases preheat the combustion air, which then flows into the turbine of an eTurboCharger 1706 producing power and excess heat. The excess heat in the exhaust from the eTurbocharger 1706 is used to preheat the molecule containing hydrogen (MCH) in the recuperator 1704.

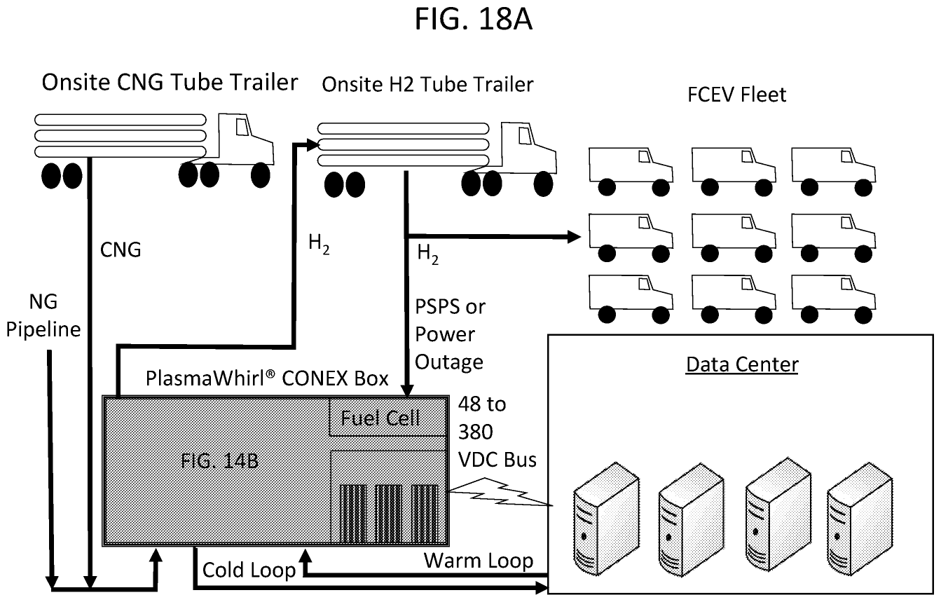

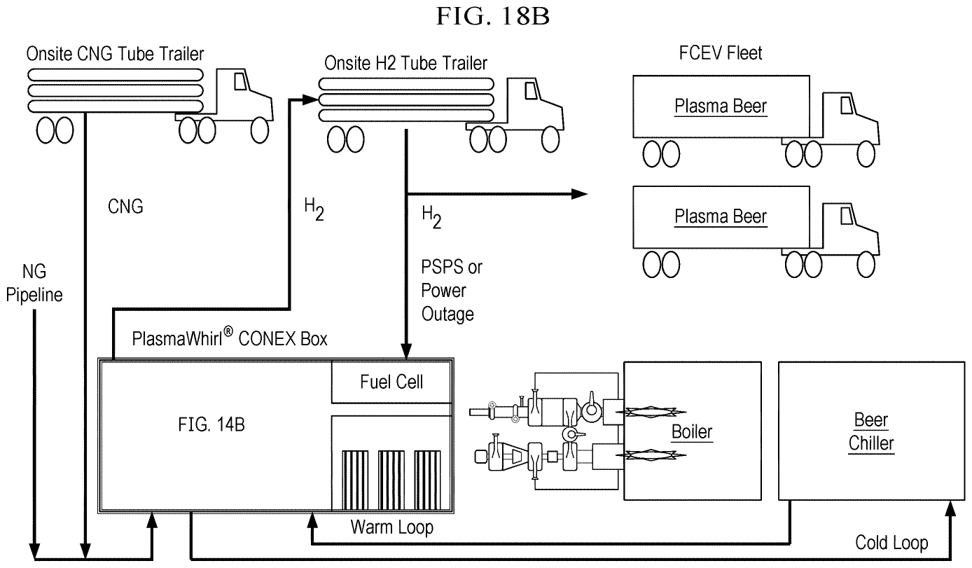

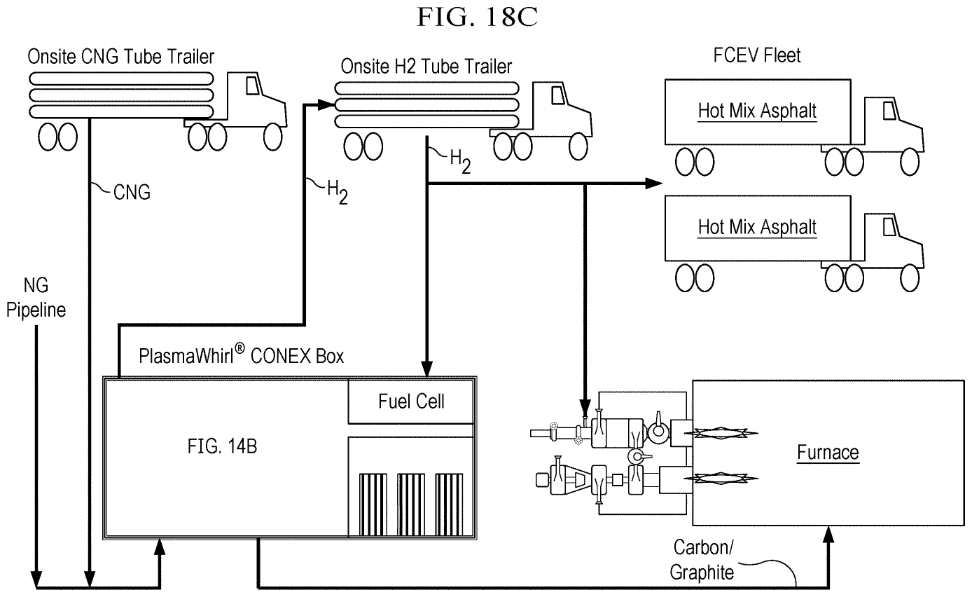

FIG. 18A discloses a system for providing resiliency for data centers in combination with zero emission hydrogen and a valuable carbon stream that can be used a shielding for an electromagnetic pulse (EMP) event. The invention of FIG. 14B and a fuel cell system would be installed in a PlasmaWhirl® CONEX box. The PlasmaWhirl® CONEX box will produce hydrogen, power, cooling and carbon from an alkane such as CNG, LNG, LPG or Butane utilizing the ArcWhirl® wave energy photolysis system coupled to an eTurboCharger. In addition, the PlasmaWhirl® CONEX Box can provide DC power via the fuel cells to the Data Center in the event of a public safety power shutoff (PSPS) event. Furthermore, a constant flow of CNG or even LNG allows for cooling the Data Center on extremely hot days with the benefit of producing hydrogen with zero CO₂ emissions. The constant flow produces hydrogen at a steady flow for filling tube trailers which subsequently can refill a fleet of Fuel Cell Electric Vehicles (FCEVs) or any vehicle that can combust hydrogen in an Internal Combustion Engine (ICE).

FIG. 18B discloses a system providing resiliency for food and beverage plants in combination with zero emission hydrogen and a valuable carbon stream that can be used water treatment. The invention of FIG. 14B and a fuel cell system is installed in a PlasmaWhirl® CONEX box. The PlasmaWhirl® CONEX box produces hydrogen, power, cooling and carbon from an alkane such as CNG, LNG, LPG or Butane utilizing the ArcWhirl® wave energy photolysis system coupled to an eTurboCharger. In addition, the PlasmaWhirl® CONEX box can provide DC power via the Fuel Cells to the Food and Beverage Plant in the event of a public safety power shutoff (PSPS) event. Furthermore, what is unique and unobvious is that utilizing a constant flow of CNG or even LNG allows for cooling the beverage chillers on extremely hot days with the benefit of producing hydrogen with zero CO₂ emissions. The constant flow produces hydrogen at a steady flow for filling tube trailers which subsequently can refill a fleet of fuel cell electric vehicles (FCEVs) or any vehicle that can combust hydrogen in an internal combustion engine (ICE).

FIG. 18C discloses a system for providing resiliency for asphalt plants in combination with zero emission hydrogen and a valuable carbon stream that can be mixed into asphalt. The invention of FIG. 14B and a fuel cell system is installed in a PlasmaWhirl® CONEX box. The PlasmaWhirl® CONEX box produces hydrogen, power and carbon from an alkane such as CNG, LNG, LPG or Butane utilizing the ArcWhirl® wave energy photolysis system coupled to an eTurboCharger. In addition, the PlasmaWhirl® CONEX box can provide DC power via the fuel cells to the asphalt plant in the event of a public safety power shutoff (PSPS) event. The present inventor's plasma turbocharger will combust 100% hydrogen. Consequently, asphalt furnaces can be retrofitted with plasma turbocharger combustors and fire 100% H₂, thus eliminating CO₂ emissions. Furthermore, what is unique and unobvious is that utilizing a constant flow of CNG or even LNG allows for constant production of hydrogen. The constant flow produces hydrogen at a steady flow for filling tube trailers which subsequently can refill a fleet of fuel cell electric hot mix asphalt trucks or any vehicle that can combust hydrogen in an internal combustion engine (ICE).

FIG. 18D discloses a system for providing resiliency for cement clinker plants in combination with zero emission hydrogen and a valuable carbon stream that can be activated for water treatment. The invention of FIG. 14B and a fuel cell system would be installed in a PlasmaWhirl® CONEX box. The PlasmaWhirl® CONEX box produces hydrogen, power, cooling and carbon from an alkane such as CNG, LNG, LPG or Butane utilizing the ArcWhirl® wave energy photolysis system coupled to an eTurboCharger. In addition, the PlasmaWhirl® CONEX box can provide DC power via the fuel cells to the Cement Plant in the event of a public safety power shutoff (PSPS) event. The present inventor's plasma turbocharger will combust 100% hydrogen. Consequently, the rotary kiln can be retrofitted with a plasma turbocharger for combusting 100% hydrogen, thus eliminating CO₂ emissions. As previously disclosed in FIG. 2B, an induction PlasmaWhirl CONEX box would process raw kiln feed into a precalcined clinker. Thus, the off-gas from the raw kiln feed would be a very concentrated CO₂ stream with some carbon and hydrogen due to cracking of any organics found within the raw kiln feed. The CO₂ would be sent to the present inventions CO₂ eCracker system as disclosed in FIG. 16B.

### Virtual Inertia Wave Energy Rectifier MHD Reactor and Turbo Expander

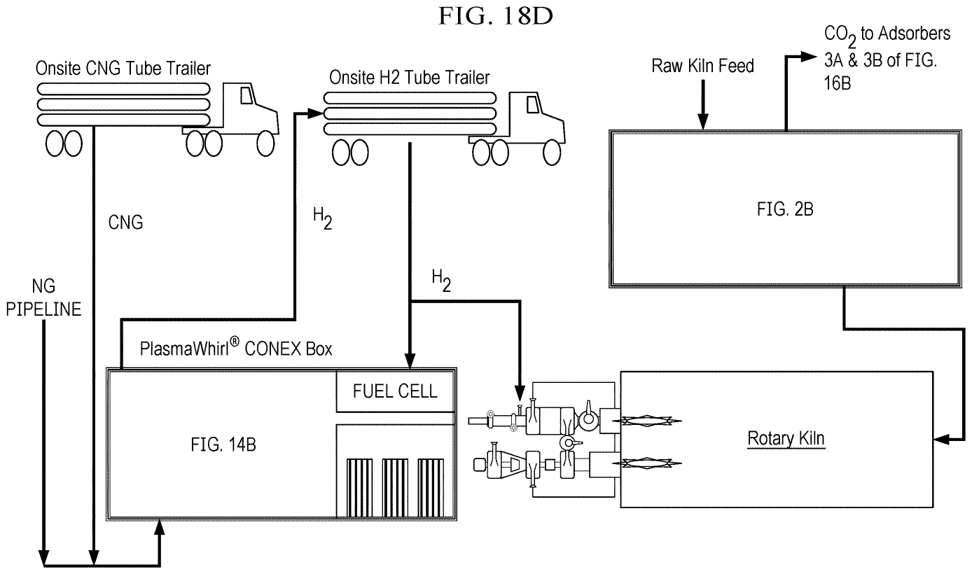

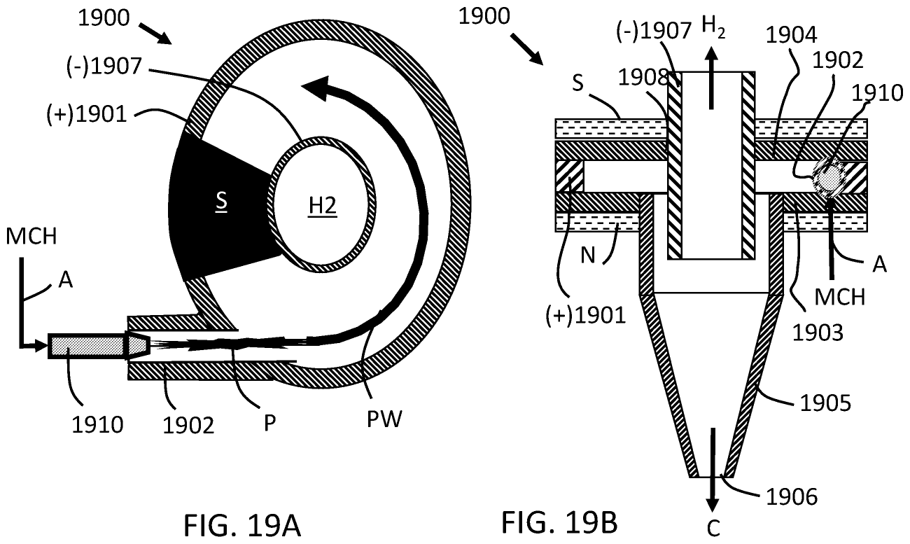

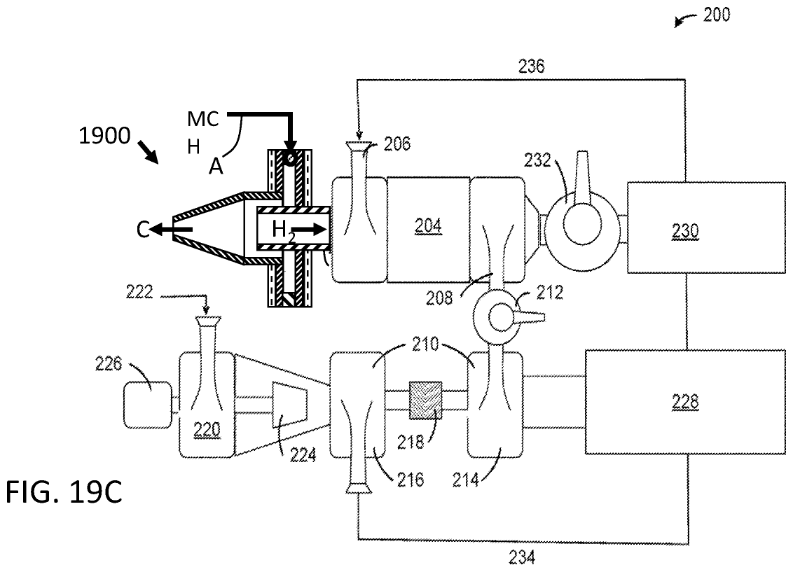

The present invention shown in FIGS. 19A and 19B includes a plasma rectifier in which three phase AC power is converted to DC power using a plasma magnetohydrodynamic reactor while also generating hydrogen and recuperating energy with a turboexpander. The equation for magnetic force is similar to Coulomb's Law. But the key point is that the force is inversely proportional to the distance squared (i.e. it obeys an inverse square law with distance).

$$F ∝ 1 / {r}^{2}$$

where r is the distance between the magnets. However, for electric dipoles, the field strength decreases more rapidly with distance; as R⁻³ or

$$F ∝ 1 / {r}^{3}$$

It is well known and well understood that hurricanes, tornadoes and whirlpools produce an eye. The eye is normally at a lower pressure than the circulating wall of fluid. Hydrocyclones and cyclone separators are commonly used as density separators for solids, liquids and gases. If a high pressure gas is used it will produce a near perfect vacuum within the eye. Hence, if a VUV emitter were placed within the eye, then photolysis of methane near the eye would take place at near the speed of light.

FIG. 49A depicts to top cross-sectional view and FIG. 49B depicts a side cross-sectional view of a cyclone magnetohydrodynamic generator (MHDG) 1900. The MHDG 1900 is constructed and assembled as follows:
1. A positive (+) terminal volute ring 1901 with a tangential inlet 1902 is sandwiched between a non-electrically conductive bottom plate 1903 and a non-electrically conductive top plate 1904.
2. Plates 1903 and 1904 are affixed to the positive (+) terminal volute ring 1901 by means known in the art, such as bolts, glue, clamps, etc.
3. A straight to funnel shaped cone 1905 with an apex 1906 is attached to the bottom plate 1903. Once again with means known in the art.
4. A negative (−) terminal vortex finder 1907 is inserted through a hole 1908 within the non-electrically conductive top plate 1904.
5. A magnet with a Southpole S is affixed to the top plate 1904 and a magnet with a Northpole N is affixed to the bottom plate 1903.
6. A plasma torch 1910 is attached the tangential entry 1902 of the volute ring 1901.

The following steps demonstrate how to operate the MHDG:
1. Power is turned on for the Plasma Torch 1910.
2. A Molecule Containing Hydrocarbon MCH, such as methane, is flowed into the torch as shown by Arrow A.
3 As the MCH flows into the plasma torch 1910 and through the arc the MCH is cracked to Hydrogen H₂ and Carbon C and forms a plasma P.
4. The plasma P exits the plasma torch 1910 into the tangential inlet 1902 then forms a plasma whirl PW, circulating around the (−) vortex finder 1907.
5. The plasma P is electrically conductive and is traveling at a very high velocity.
6. The plasma whirl PW cuts the lines of flux between the magnets S and N which induces an electrical flow between the (+) positive and (−) negative terminals.
7. The Carbon C exits the funnel's 1905 apex 1906.
8. The Hydrogen H₂ exits the vortex finder 1906.

### Plasmawhirl® Reactor

Although the invention in FIGS. 19A and 19B discloses only one plasma torch 1910, it will be understood that two or more torches can be attached to the cyclone magnetohydrodynamic generator to form a PlasmaWhirl® Reactor. However, to practice the current invention only one torch is necessary to form a whirling plasma.

### Three Phase AC or Single-Phase AC to DC for Virtual Inertial and Rapid Battery Charging

The system of FIGS. 19A and 19B allows for converting three phase AC to DC with the addition of hydrogen and carbon production. This opens the door for two major applications: adding virtual inertia to an electrical grid; and a combined rapid electric vehicle charger and hydrogen fueling station.

Commercial off-the-shelf (COTS) plasma torches are widely available. For example, an older but still widely used plasma cutting system is ESAB's PT-19 torch and ESP-150 Power Supply. The ESP-150 power supply is a three phase silicon controlled rectifier (SCR). It converts AC power to DC power. The PT-19 torch is a DC torch. Likewise, Thermal Dynamics

Plasma eTurbocharger

Turning now to FIG. 19C, the cyclone magnetohydrodynamic generator 1900 replaces the Plasma ArcWhirl® torch 100. The hot hydrogen exiting from the vortex finder 1907 enters into a cyclone combustor 204 with a tangential entry 206 and tangential exit 208. The cyclone combustor 204 is connected to a turbocharger 210 via valve 212. Hot gases enter into a turbine 214 of the turbocharger 210. The turbine 214 rotates a compressor 216 by means of a shaft with a pinion 218. A compressor inlet valve 220 is connected to the compressor 216. Compressor inlet valve 220 eliminates the need for stators to impart a whirl flow to match the compressor wheel rotation direction. In addition, by utilizing a tapered reducer for the housing the velocity of the air 222 must increase in order to conserve angular momentum. By utilizing a plunger style stopper valve assembly 224 coupled to a linear actuator 226, the mass flow can be pinched or reduced while maintaining velocity. The physical separation of the compressor/turbine or turbocharger 210 from the combustor 204 allows for a radically different design for gas turbines, power plants and airframes. The turbocharger 210 can be located and oriented to maximize airflow while minimizing foreign object damage (FOD). In addition, the turbocharger 210 may be coupled to rotating unions and tubing in order to rotate or direct the exhaust from the turbine 214 for thrust vectoring. In order to maximize efficiency a first stage recuperator 228 is placed on the discharge exhaust from the turbine 214 and a second stage recuperator 230 is place on the discharge exhaust from the combustor 204 via a valve 232. Compressed air 234 enters into the first stage recuperator 228 and then into the second stage recuperator 230. The hot compressed air 236 then enters into the combustor 204 via a volute with tangential entry 206.

More specifically, the compressor inlet valve 220 includes a volute with a tangential entry, a cone-shaped reducer connected to the volute, a linear actuator connected to the volute, and a cone-shaped stopper disposed within the cone-shaped reducer and operably connected to the linear actuator. A controller is connected to the linear actuator to adjust a gap between the cone-shaped stopper and the cone-shaped reducer to increase or decrease mass flow while maintaining whirl velocity to closely match compressor tip velocity.

Although there are several variations and modes of operations a few brief examples will be given in order to quickly demonstrate the uniqueness as well as functionality of the supersonic lean combustion plasma turbine 200. The hydrogen plasma from the MHDG vortex finder 1907 is discharged into the eye of the cyclone combustor 204. The hydrogen plasma entering into the cyclone combustor 204 is also the igniter. Since it is in the eye of the cyclone it will be extended along the longitudinal axis of the combustor 204 and into valve 232. By throttling valves 212 and 232 the turbine can be operated from a takeoff mode and transition to supersonic and hypersonic flight. The purpose for separating the combustor 204 from the compressor 216 and turbine 214 allows for a unique and completely unobvious mode of operation—holding a supersonic flame—with 100% hydrogen. Supersonic hydrogen combustion has a long flame and very high temperature. Consequently, gas turbine engines have the combustor sandwiched between the compressor and the turbine. Thus, flow must reduce to sub-sonic in order to hold a hydrogen flame. But the PlasmaWhirl® combustor 204 holds the hydrogen flame dead center within eye of a whirling fluid, for example combustion air.

### Radial Disc Plasma Arcwhirl® MHD Generator

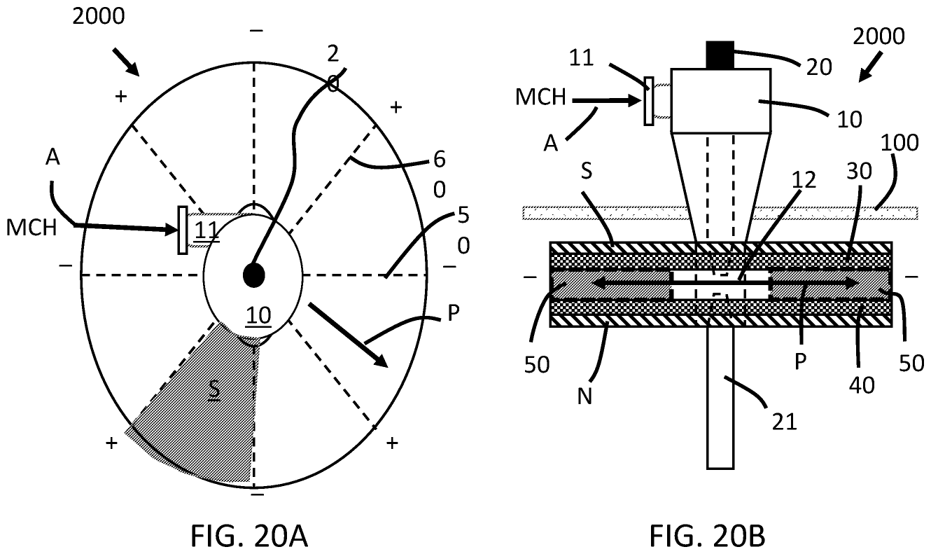

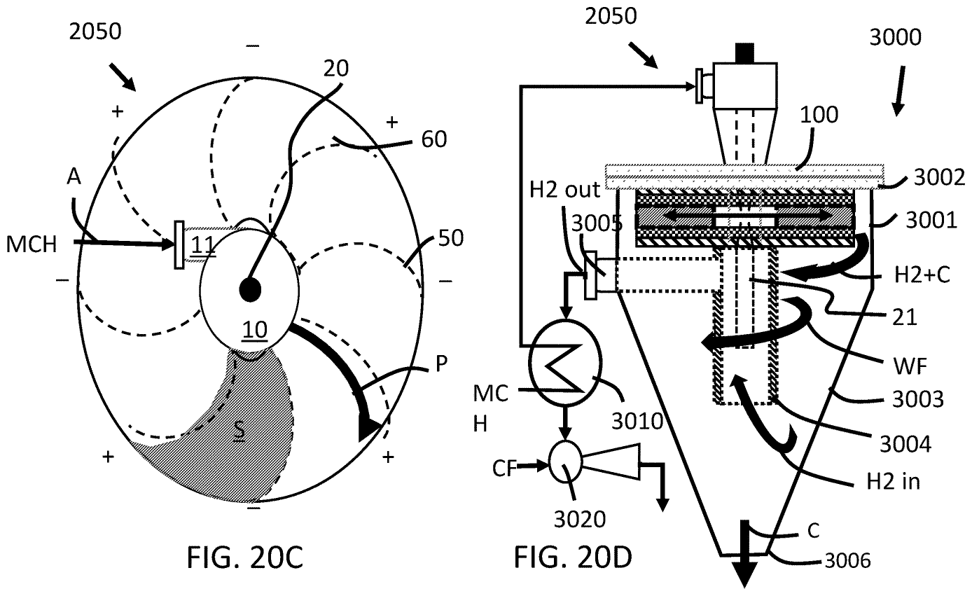

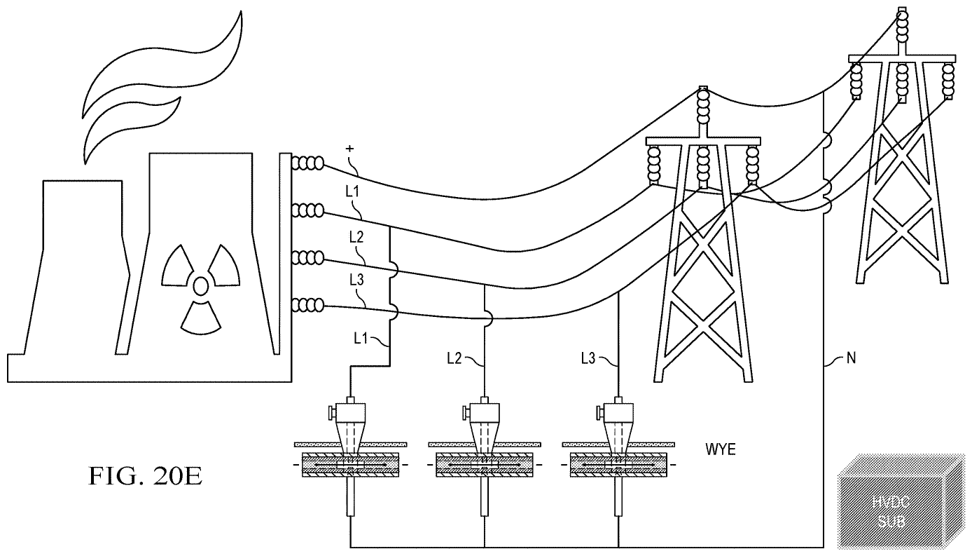

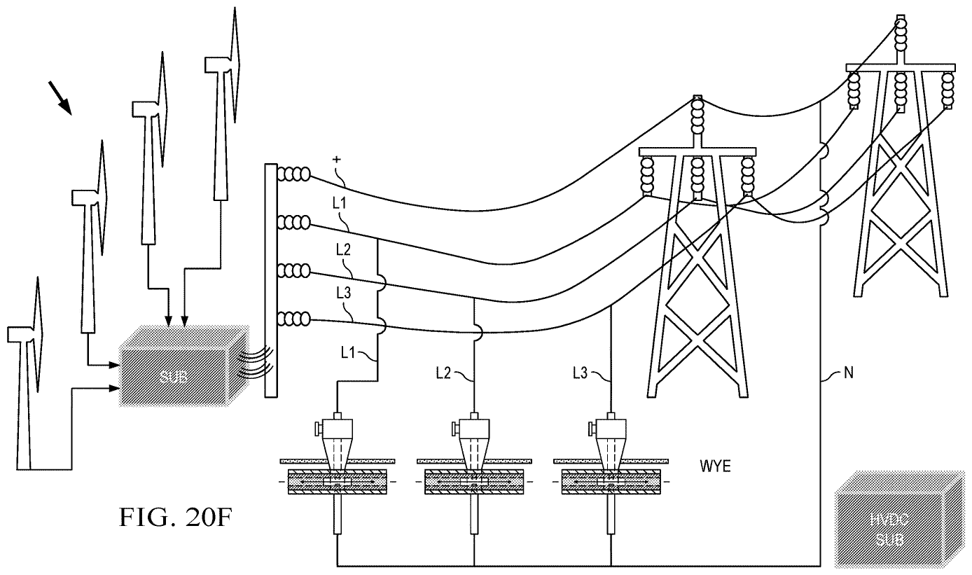

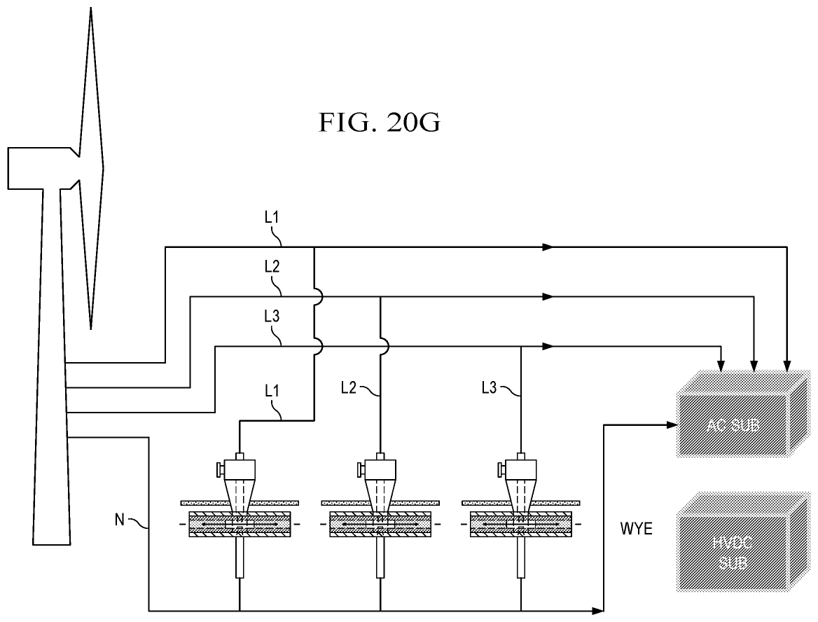

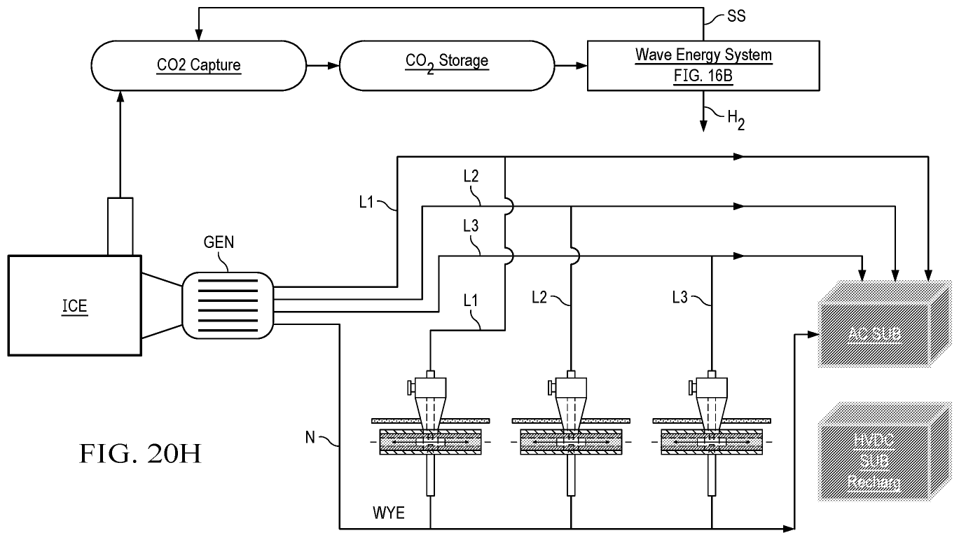

The most common MHD Generator is the radial disc type. An ArcWhirl® cyclone can be used to construct and assemble a radial disc plasma ArcWhirl® generator 2000 as shown in FIGS. 20A and 20B. The ArcWhirl® cyclone has a mounting flange 100 attached to it for insertion into a container (not shown). The ArcWhirl® Cyclone is attached via its apex valve 12 to radial disc MHD generator 2000 comprising a top plate Southpole(S) Magnet and bottom plate Northpole (N) Magnet as shown in FIG. 20B. The Southpole(S) Magnet is electrical isolated using a high temperature insulator 30 and the Northpole (N) Magnet is isolated using a high temperature insulator 40. Alumina makes an ideal high temperature electrical insulator. But there are many refractories that are electrical insulators that can be used in the present invention. The (−) negative radial terminal fins 50 and the (+) positive radial terminal fins 60 are electrically conductive plates sandwiched between insulators 30 and 40.

The following steps demonstrate how to operate the Radial Disc MHD 2000:
1. Power is turned on for the Power Supply (not shown).
2 Electrode 20 or 21 is pushed with a linear actuator to touch electrode the opposing electrode 20 or 21.
3. Electrode 20 or 21 is pulled back and arc forms between electrodes 20 and 21.
4. A Molecule Containing Hydrocarbon MCH, such as methane, is flowed into the ArcWhirl® Cyclone 10 inlet 11 as shown by Arrow A.
5 As the MCH flows down near the arc, wave energy, in particularly vacuum UV (VUV) photons split the methane which results in hydrogen and carbon.
6. Likewise a small amount of hydrogen remains within the arc forming a hydrogen plasma.
7. Since the photolysis of methane results in hydrogen with a volume increase of four times the initial volume of methane, the conservation of angular momentum must be conserved since the Apex 12 has a smaller diameter than the cyclone volute and cone.
8. As a result the whirling hydrogen and carbon plasma must increase in velocity.
9 The hydrogen and carbon plasma P then follow a radial path along the radial terminal fins 50 and 60.
10. The plasma cuts the lines of flux formed between the Northpole (N) and Southpole(S) magnets inducing electrical flow within the (+) terminal fins and the (−) terminal fins.
11. The plasma then exits the fins radially into a container (not shown) for separating the hydrogen from the carbon.
12. The hydrogen is stored for future use or can be flowed into a plasma ArcWhirl® turbocharger.

### Curved Radial Fins Disc Plasma Arcwhirl® MHD Generator

In lieu of straight radial electrode fins (−) and (+) as shown in FIGS. 20A and 20C disclose curved radial electrode fins (−) and (+). This curved fin system, method and apparatus maintains whirl flow and has several unobvious and novel benefits. First, the plasma (P) will be slung towards and hug opposing radial fins. Second, curved fins (−) and (+) provide greater surface area. Likewise, as previously stated, curved fins (−) and (+) retain whirl flow, thus allowing for separating the hydrogen from the carbon as shown in FIG. 20D.

FIG. 20D discloses a radial flow MHD disc generator 2050 with curved fins attached to and partially inserted into a large cyclone separator 3000. The cyclone separator 3000 includes a head 3001 with a flange 3002 for attaching the MHD Generator 2000 flange 100 as shown in FIG. 20B to the large cyclone separator 3000 flange 3002. The head 3001 is attached to a cone 3003 to conserve angular momentum and allow for separating hydrogen from carbon. A vortex finder 3004 with an outlet tube 3005 are affixed to the cone. The vortex finder 3004 can be affixed to the smaller vortex finder 12 or the Northpole (N) Magnet of FIG. 20B. It will be understood that the smaller vortex finder 12 would block the flow of H₂ into the larger vortex finder 3004 by means of an electrically insulating plate or tube. However, the plate and/or tube (not shown) would allow insertion of the DC electrode 21 into the vortex finder 12. In addition, the large vortex finder 3004 may be attached to the head 3001 via radial braces (not shown).

The cone has an apex valve 3006. Apex valves are widely known and installed on various types of cyclone separators. As previously stated, the cyclone separator 3000 includes a vortex finder 3004 and a hydrogen outlet 3005. Carbon exits via the apex valve 3006.

Operation of the system disclosed in FIGS. 20C and 20D is similar to steps one through ten for FIGS. 20A and 20B. However, whether curved fins are straight fins are used by attaching the MHD 2050 to a larger cyclone separator the hydrogen and carbon can be separated as shown in FIG. 20D. If the straight radial fin MHD system, method and apparatus of FIG. 20B is used, then it will be understood that curved blading could be installed on the insulator 40. On the other hand, referring to FIG. 20D a shelf with curved blading (not shown) similar to a squirrel cage fan blading could be installed within the large cyclone separator. Of course, the MHD 2050 could simply sit on top of the shelf. Referring to FIG. 20D with curved fins (−) and (+) the following separation steps will disclose this novel means for separating H₂ from Carbon:
1. Hydrogen and carbon as shown by Arrow H₂+C exit the MHD 2050 and continue in a Whirl Flow as shown by Arrow WF.
2 As the hydrogen and carbon flow down the cone 3003, the Whirl velocity increases due to conservation of angular momentum.
3 The less dense hydrogen reports to the vortex finder 3004 and enters into it as shown by Arrow H₂ in.
4. The hydrogen collected within the vortex finder enters into an outlet tube 3005 and as shown by Arrow H₂ out is piped to a gas-to-gas heat exchanger 3010 in which Molecule Containing Hydrogen MCH cools the hydrogen H₂ and the H₂ warms the MCH.
5. Next the H₂ flows into the suction side of a venturi 3020. The venturi 3020 pressurizes the hydrogen and further cools it.
6. Carbon continues flowing down the cone 3003 of the Cyclone Separator 3000 and exits the apex valve 3006 as shown by Arrow C.

What is completely unexpected about the hydrocyclone MHD is that once it is started the DC power produced by the MHD can power the arc or used for recharging electric vehicles (evs), powering a DC microgrid. Consequently, the system manufactures hydrogen and carbon from molecules containing hydrogen such alkanes and olefines with no additional energy input. Likewise, without being bound by theory is it believed that the system will crack CO₂ into carbon and oxygen with no additional energy input as long as the feed CO₂ is pressurized to maintain a high enough velocity to form a conductive plasma path that cuts the lines of flux from the magnets. This allows for a system for decarbonizing natural gas while rectifying AC power to DC power. This will be shown in the following example.

### Wye MHD Rectification for Nuclear Power Plant Flex Mode Operation

Referring to FIG. 20E the MHDs shown in FIGS. 20A, 20B, 20C and 20D are installed in a wye configuration. Thus a Nuclear Power Plant (NPP) or other power plant can operate in a flex mode using the following steps:
1. Power is turned ON for each MHD, which reduces the load placed on the AC Transmission lines.
2. An arc is struck within each MHD.
3. A hydrocarbon or CO₂ are flowed into each MHD.
4. The resulting H₂ and Carbon or Oxygen and Carbon are separated as shown in FIG. 51D.
5. DC Power is sent to a DC Substation or Microgrid.

### Wye MHD Rectification and H₂ Production for Renewable Power Flex Mode Operation

Referring to FIG. 20F the MHDs shown in FIGS. 20A, 20B, 20C and 20D are installed in a wye configuration. Thus a wind farm can operate in a Flex Mode using the following steps:
1. Power is turned ON for each MHD, which reduces the load placed on the AC Transmission lines from the Wind Farm.
2. An arc is struck within each MHD.
3. A hydrocarbon or CO₂ are flowed into each MHD.
4. The resulting H₂ and Carbon or Oxygen and Carbon are separated as shown in FIG. 51D.
5 DC Power is sent to a DC Substation or Microgrid.
6. This allows for a windfarm to rectify its AC output to DC for placing it on High Voltage DC Lines, recharging EVs or for dispatching DC to a DC microgrid at a moment's notice.

### Wye MHD Rectification and H₂ Production for Renewable Power Flex Mode Operation

Referring to FIG. 20G the MHDs shown in FIGS. 20A, 20B, 20C and 20D are installed in a wye configuration. Thus a single wind turbine can operate in a Flex Mode using the following steps:
1. Power is turned ON for each MHD, which reduces the load fed to an AC substation from a single wind turbine.
2. An arc is struck within each MHD.
3 A hydrocarbon or CO₂ are flowed into each MHD.
4 The resulting H₂ and Carbon or Oxygen and Carbon are separated as shown in FIG. 51D.
5. DC Power is sent to a DC Substation or Microgrid.
6. This allows for a wind turbine to rectify its AC output to DC for placing it on High Voltage DC Lines, recharging EVs or for dispatching DC to a DC microgrid at a moment's notice.

### Electrical Resiliency in a Box (E-RIB™)

It is estimated that there are over 12 million internal combustion engine (ICE) distributed or standby generators in the US alone. The ICE residential standby generators range in size from 5 kw to about 24 kw. Three phase residential and commercial ICE distributed or standby generators range in size from about 22 kw to 40 kw. Industrial gas or diesel ICE standby generators range in size from about 10 kw to 1,000 kw. Gas turbine standby generators or peaking plants range is size from about 300 kw upwards to GE's TM 2500 rated at 35 mw.

A major problem exists with all of the ICE standby generators that burn fossil fuels. With Climate Change Laws, for example the US's recently passed Inflation Reduction Act (IRA), many of the ICE gensets will go unused and will be a stranded asset. Consequently, a need exists for eliminating CO₂ emissions from Standby Gensets as well as converting AC Standby Gensets to DC rechargers.

Referring to FIG. 20H an electric resiliency in a box (eRIB™) system allows for capturing, storing and converting CO₂ emissions from an ICE standby generator. More importantly, the system, method and apparatus allows for direct tie-in for DC microgrids by incorporating a MHD CO₂ cracker. It will be understood that a single phase ICE genset would only require one MHD cracker while a three phase ICE genset would use 3 MHD's.

The system, method and apparatus of FIG. 16B is incorporated into the eRIB™ with one exception. The ArcWhirl® as shown in FIG. 16B is replaced with the MHDs 2000 as shown in FIG. 20H.

Turning now to FIG. 20i, the steps for operating the system, method and apparatus are:
1. The ICE is started and CO₂ is captured within a CO₂ capture container.
2. CO₂ is transferred to a Storage Container utilizing heat from either hot O₂ or the exhaust from the ICE.
3. An arc is struck within the MHD and CO₂ is flowed from the CO₂ storage container to the MHD.
4. AC power is rectified in the MHD to DC power for placing on a DC microgrid or used for recharging electric vehicles (EVs).
5. Oxygen is separated and stored or flowed into the ICE.
6. Carbon is separated and stored and later to be sold or converted to activated carbon and/or graphite.

### Tread™—Turbo Regen Electric Assist Drive

The present inventor's lean combustion U.S. Pat. Nos. 9,869,277, 9,163,584,
8833054 and 8074439 are hereby incorporated by reference in their entirety.

### Onboard Direct Coupled WEC Regen Braking

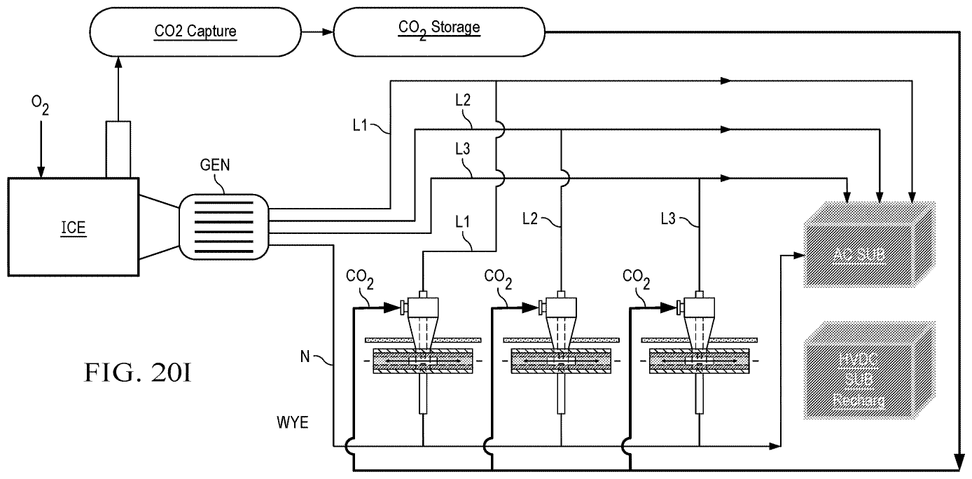

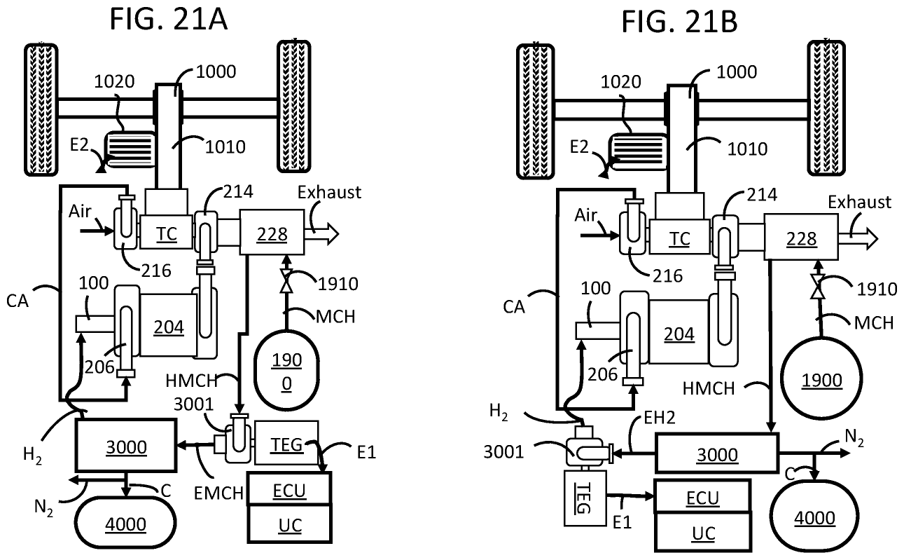

FIG. 21A discloses an onboard plasma regenerative braking system, method and apparatus. A transaxle 1000 comprising a transmission 1010 and a motor generator 1020 are attached to a turbocharger TC comprising a turbine 214 and a compressor 216 with a pinion, for example a turbocharger with a pinion 218 as shown in the present inventor's lean combustion patents. The turbocharger TC is physically attached via piping to a whirl combustor 204. Exhaust from the whirl combustor 204 enters the turbine 214 of the turbocharger to provide rotational energy to the turbine wheel. Once again since the shaft of the turbine is connected to the pinion 218 and the compressor 216 the exhaust drives the turbine 214, which rotates the shaft and pinion thus providing rotational energy to the transmission 1010, motor generator 1020 and transaxle 1000.

The following steps will describe an operating mode for the onboard direct coupled plasma regenerative braking system for cruising, braking and accelerating modes of operation.

A cruising mode is as follows:
1. A fuel tank 1999 flows a molecule containing hydrogen MCH, for example, gasoline, diesel, methane, ethane, propane, butane, ethanol, methanol thru a Fuel Valve FV and into a recuperator 228.
2. The hot exhaust flowing thru the recuperator is the exhaust from the turbine 214 of the turbocharger TC.
3. The hot molecule containing hydrogen HMCH exits the recuperator 228 and flows into a turbine 3001 of a turboexpander generator TEG, thus producing electrical power.
4. As shown by arrow E1 electrical power flows into an Electronic Control Unit ECU.
5. The ECU receives or distributes electrical power to the Ultracapacitors UC, motor generator 1020, a wave energy cracker 2000 and/or an igniter 100.
6. The Expanded Molecule Containing Hydrogen EMCH exits the turbine 3001 and enters into a Wave Energy Cracker 3000, which cracks the MCH into Hydrogen H₂ and Carbon C.
7. The Carbon C exits the Wave Energy Cracker 3000 and is stored in a tank 4000.
8. The Hydrogen H₂ exits the Wave Energy Cracker 3000 and flows into a fuel injector igniter 100. An ArcWhirl® 100 can be used as a combined fuel injector ignitor. However, any device which will inject and convert hydrogen into a H₂ plasma will suffice to practice the present invention.
9 Compressed air from the compressor 216 of the turbocharger TC is flowed into a tangential entry 206 of the whirl combustor 204.
10. An eye, not shown, is formed within the center of the whirling combustion air within the whirl combustor 204.
11. The H₂ plasma from the ArcWhirl® 100 enters the eye of the whirl combustor 204.
12. The H₂ is lean combusted and the hot exhaust gases exit the Whirl Combustor 204 and drive the turbine 214 of the turbocharger thus providing rotational energy to the pinion 218, the transmission 2020, the motor generator 2010 and the transaxle 2000 for cruising speeds that do not require high torque.

A braking mode is as followings:
1. When brakes are applied over-torque turns the motor/generator 1020 into a generator and the Fuel Valve (FV) and is throttled to a position controlled by an electrical signal sent from the ECU.
2 Electrical power E2 produced by the motor/generator 1020 flows into the ECU or directly into the UCs.
3. The ECU receives or distributes electrical power to the Ultracapacitors UC, motor generator 1020, the wave energy cracker 2000 and/or the ArcWhirl® 100.

An accelerating mode is as follows:
1. When the throttle (not shown) is depressed the ECU sends a signal to the UCs to release its electrical power to the motor/generator 1020 thus moving the vehicle.
2. The ECU also sends a signal to open the Fuel Valve (FV) based upon how far the throttle is depressed by the driver.
3. One Cruise Speed is obtained the system, method and apparatus resorts back to cruise mode.

A preferred molecule containing hydrogen is methane. As previously stated photolysis of methane occurs with Vacuum UV (VUV). Consequently, this reduces the electrical power needs for the wave energy system. However, there is another added benefit for using methane. When methane is cracked the hydrogen causes a volume expansion four times greater than methane. Hence, TREAD™ can be reconfigured as shown in FIG. 21B.

Referring to FIG. 21B, the hot molecule containing hydrogen HMCH enters into the wave energy cracker 3000. As stated before the methane is cracked into hydrogen and carbon with a resulting volume expansion of at least four times from that of the HMCH. An expanded hydrogen EH₂ enters into a turbo-expander generator TEG. An example of an ideal vehicle type TEG is manufactured by Borg-Warner and Garrett Motion and is more commonly known as an electric turbocompounder.

In order to not confuse the meaning, numbers and abbreviations herein, TC means TurboCharger, which may or may not contain a pinion for providing rotational energy to a bull gear, eTC means electric turbocharger, which includes a compressor, motor/generator and a turbine. TEG means an electric turbocompounder or any turbine expander which produces rotational energy. eComp means an electric compressor, electric supercharger or any device for compressing or pumping a fluid.

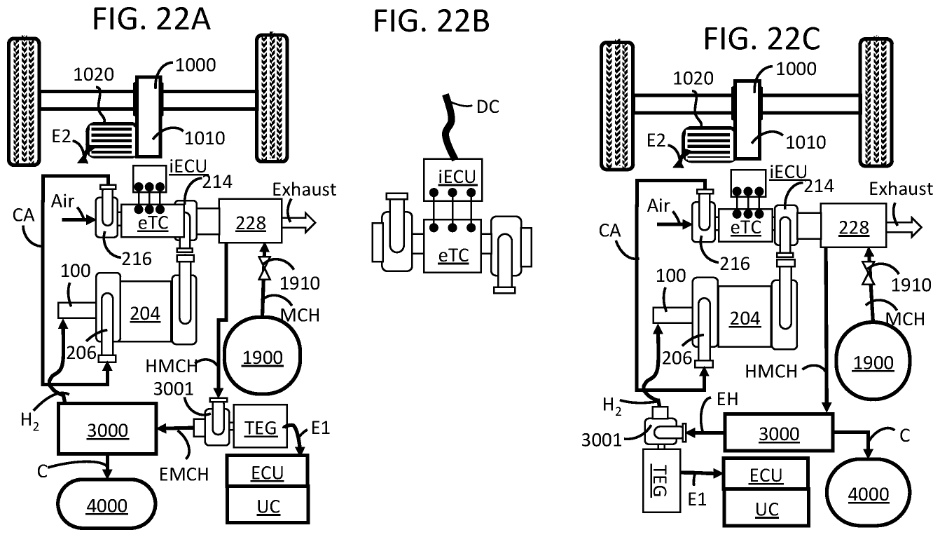

Turning back to FIGS. 21A and 21B, if ammonia is the molecule containing hydrogen MCH in tank 1900, then as it flows to through the recuperator 228 it will expand upwards of 850 times. Thus, this allows for recuperating the energy in compressing and liquifying ammonia in the TEG 3001 before the wave energy cracker 3000 as shown in FIG. 21A or after the wave energy cracker 3000 as shown in FIG. 22A. Although Carbon C is shown entering into Tank 4000, it will be understood that another turboexpander generator may be installed to capture the hot nitrogen N₂ exiting from the wave energy cracker 3000. The nitrogen N₂ would then exit via a tailpipe as shown by arrow N₂.

Another excellent MCH with a high liquid to gas expansion ratio is propane (LPG). Propane is widely available and allows for ease of installation of a retrofit kit on vehicles already designed to operate with propane. Likewise, LNG (Liquified Natural Gas) has an expansion ratio of 600. Consequently, many larger vehicles such as trucks that have been modified to operate with LNG are an ideal fit for an Onboard Indirect Coupled Wave Energy Cracker Regen Braking System as shown in FIGS. 22A and 22B.

### Onboard Indirect Coupled WEC Regen Braking

FIGS. 22A and 22C are systems for a zero CO₂ emission hybrid electric hydrogen turbine engine with an electric transaxle 1000 and an electric turbocharger eTC. FIG. 22B shows a typical commercially off the shelf (COTS) electric turbocharger eTC with an attached inverter electronic control unit iECU.

eTurbocharger

BorgWarner's eTurbo™ model numbers eB40, eB50, eB60 and eB80 are an ideal fit for the present invention. Likewise, Garret Motion manufactures electric turbochargers. Ideal electric transaxles 1000 for carrying out the present invention for semi-trucks are manufactured by Allison (eGen Power® 100S, 100D and 130D), Meritor, a division of Cummins and Cascadia Motion, a division of BorgWarner. Ideal electric transaxles 1000 for carrying out the present invention for vehicles are manufactured by Tesla, Volkswagon, Rivian, and Cascadia Motion. For smaller applications, ClubCar®, General Transmissions, Inc located at 302 Lorenaly Dr., Suite E, Brownsville, TX 78526 and Benevelli of Italy manufacturers both electric transaxles and wheel drives. The term electric transaxle herein includes wheel drives.

### AC to DC Power Convertor

A preferred wave energy cracker 3000 shown in FIGS. 21A, 21B, 22A and 22C would be the MHD shown in FIGS. 19A, 19B, 19C, 20A, 20B, 20C and 20D.

### Tread™ for Zero or Low CO₂ Emissions

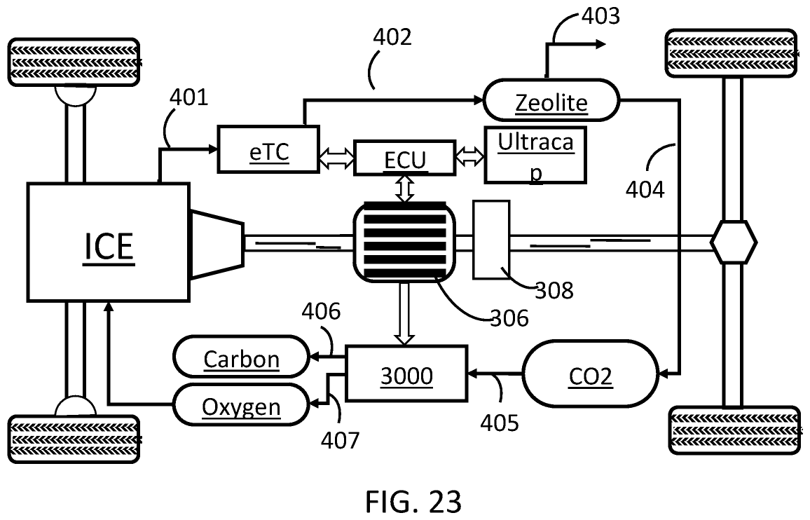

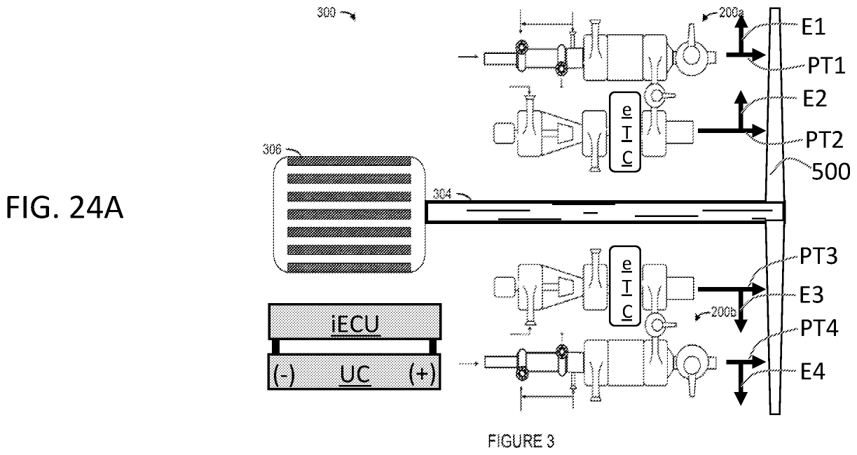

FIG. 23 discloses a system for low or zero CO₂ emissions from an internal combustion engine ICE. Exhaust from the ICE flows into an electric TurboCharger eTC as previously disclosed in FIG. 22B. The exhaust from the electric turbocharger eTC flows into a vessel filled with a media for example Zeolite for capturing CO₂. This system has been previously disclosed in FIG. 16B. However, FIG. 16B does not disclose the system in use on a vehicle, but FIG. 13D discloses the use of the CO₂ capture and plasma cracking system, method and apparatus for trains.

Returning to FIG. 23, when the vehicle operator applies the brakes, the motor/generator produces power. In lieu of storage of the power in batteries, the power is used to crack CO₂ with a wave energy cracker 3000. The carbon is stored onboard and oxygen is used in the engine.

### Tactical Recharger Enhanced Assured Distributed™ Generation

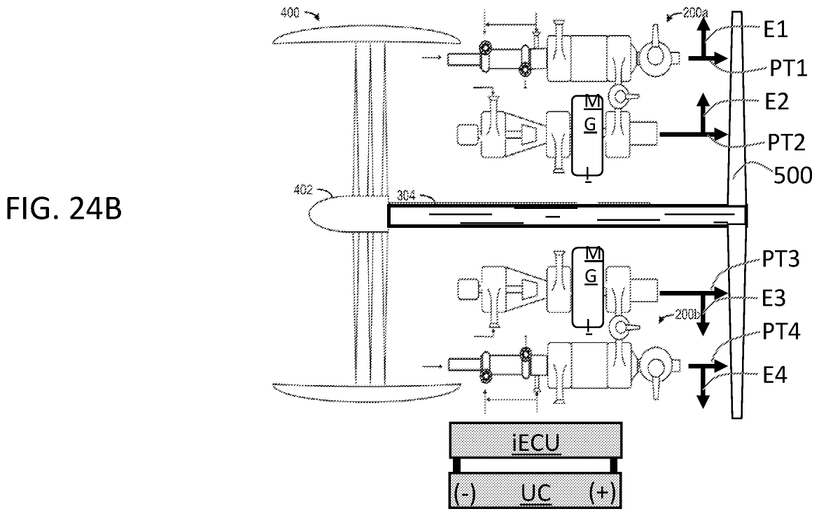

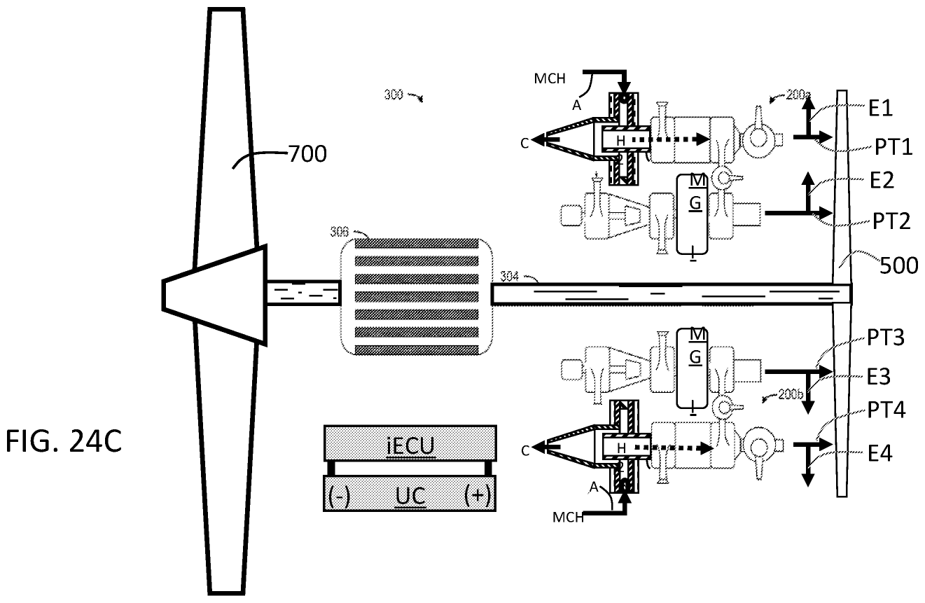

FIG. 24A discloses a system for remote EV recharging as well as providing distributed generation. The lean combustion plasma system can be easily retrofitted with a power turbine 500 as shown in FIG. 24A. This gives rise to a system for onsite rapid battery charging while also providing AC or DC power to a microgrid. The system will be described for both microgrid and rapid recharging modes.

A microgrid mode of operation is as follows:
1. As shown in FIG. 24A one or more plasma turbo systems 200a and 200b would be installed with an electric turbo charger eTC as shown in FIG. 22B.
2 The plasma turbo systems 200a and 200b would be turned on by providing power to the eTCs via the UltraCapacitors UC. Fuel flow would be increased to increase mass flow from the whirl combustor and the eTC.
3. Once plasma turbo systems 200a and 200b are up to speed DC power is provided to recharge the UCs and power a microgrid or for slow charging evs.
4. Flow from both the plasma whirl combustor 204 and electric turbocharger eTC would be directed away from the power turbine 500 as shown by Arrows E1, E2, E3 and E4.

A rapid recharge mode of operation is as follows:
1. As shown in FIG. 24A one or more Plasma Turbo Systems 200a and 200b would be installed with an electric turbo charger eTC as shown in FIG. 22B.
2. The plasma turbo systems 200a and 200b would be turned on by providing power to the eTCs via the UltraCapacitors UC. Fuel flow would be increased to increase mass flow from the Whirl Combustor and the eTC.
3. Once plasma turbo systems 200a and 200b are up to speed DC power is provided to recharge the UCs and power a microgrid or for slow charging evs.
4. Flow from both the plasma whirl combustor and turbocharger would be directed into the power turbine (PT) 500 as shown by Arrows PT1, PT2, PT3 and PT4.
5. The power turbine (PT) 500 would provide rotational energy to a large motor/generator 306
6. UltraCaps would be energized to assist in rotating the PT 500.
7. The motor/generator 306 would reach an ideal speed for producing AC Power which would be rectified to DC power for rapid charging. However, the motor/generator 306 may be produce DC power.

### Power Turbine Flywheel

It will be understood that the Power Turbine 500 may be combined with a Flywheel for maintaining PT 500 speed in order to quickly bring online the AC or DC motor/generator 306 for rapid charging EVs. Likewise, it will be understood that the motor/generator 306 may be used during brownout and blackouts as well as a blackstart system for bringing a power plant back online.

### High Bypass Fan Engine

Turning now to FIG. 24B the power turbine 500 would rotate a high bypass fan for aircraft. This completely eliminates gearboxes, thus eliminates maintenance and costs.

### Ductless Feathering Propeller Electric Turbine Engine

Turning now to FIG. 24C, the plasma turbos 200a and 200b may be retrofitted with MHDs as previously disclosed, but this is not necessary to carry out the present invention. With MHDs it allows for additional DC output while providing DC power with the electric turbochargers eTCs.

Aviation is quickly transitioning to electric motors. The system shown in FIG. 24C has the following transitional steps from takeoff, to cruise to landing.

A pushback, taxi, takeoff and climb out mode of operation is as follows:
1. As shown in FIG. 24C one or more plasma turbo systems 200a and 200b would be installed with an electric turbo charger eTC as shown in FIG. 22B.
2. The plasma turbo systems 200a and 200b would be turned on but set at ground idle only providing DC power to the aircraft.
3. The plane would use in wheel motors to pushback and taxi.
4. For takeoff fuel flow to plasma turbos 200a and 200b would be increased to wide open throttle to increase mass flow from the whirl combustor 204 and the eTC.
5. Mass Flow would be directed into the power turbine 500 as shown by Arrows PT1, PT2, PT3 and PT4.
6. UltraCapacitors UC would energize the motor/generator 306 to assist in turning a Propeller 700.

A cruise mode of operation is as follows:
1. As shown in FIG. 24C one or more plasma turbo systems 200a and 200b would be installed with an electric turbo charger eTC as shown in FIG. 22B.
2. The plasma turbo systems 200a and 200b would be set at cruise speed to provide DC power to the aircraft and provide mass flow.
3 Mass Flow would be directed into the power turbine 500 as shown by Arrows PT1, PT2, PT3 and PT4.

A landing mode of operation is as follows:
1 As shown in FIG. 24C one or more plasma turbo systems 200a and 200b would be installed with an electric turbo charger eTC as shown in FIG. 22B.
2. The plasma turbo systems 200a and 200b would be set at idle speed to provide DC power to the aircraft.
3. Mass Flow would be directed away from the power turbine 500 as shown by Arrows E1, E2, E3 and E4.
4. The Propeller would be feathered to provide torque to the motor/generator, thus recharging the UltraCapacitors UCs.
5. Upon wheels down, the propellers would be articulated and feathered to provide reverse thrust and the Ultracapacitors UCs would provide power to the motor/generator 306 bringing the aircraft to taxi speed or a complete stop.
6 The aircraft would taxi using in-wheel electric motors and the UltraCapacitors that were rapidly recharged while descending and landing.

### SUMMARY

The present invention utilizes a dynamic wave energy braking system, method and apparatus for climate change mitigation. The present invention provides a plasma dynamic braking system, method and apparatus for producing hydrogen from hydrogen containing molecules while also providing energy recovery for transportation such as rail, subways, trucks, planes, ships and vehicles. In addition, the present invention provides for hydrogen production via plasma dynamic braking for stationary energy applications such as load adjustment from interment renewable energy (solar, wind), frequency control for base load leveling of power plants, transition from a baseload to a flexible mode of operation (producing hydrogen) for Nuclear Power Plants (NPPs), renewable energy tie-in, grid forming and plasma magnetohydrodynamic generator/rectifier. In addition, the present invention provides a dynamic plasma braking system, method and apparatus for recovering the energy used for braking to synthesize molecules containing hydrogen (MCH) into hydrogen and other elements. The present invention utilizes a dynamic braking generator coupled to a wave energy source with a transmitted power density (TPD) greater than 10 w/cm² for treating a pure or relatively pure hydrogen and carbon or hydrogen and oxygen containing gas or liquid, specifically methane (CH₄) or water (H₂O) for conversion to hydrogen, oxygen, graphite, silicon or steam with low or zero carbon dioxide emissions. The present invention provides a system, method and apparatus for recovering the energy used to compress CNG or liquify LNG while converting the CNG or LNG to hydrogen and carbon. The present invention utilizes a turbo expander coupled to an electrical and wave energy source with a transmitted power density (TPD) greater than 10 w/cm² for treating a pure or relatively pure hydrogen and carbon containing gas or liquid, specifically methane (CH₄) for conversion to hydrogen, graphite, silicon or steam with low or zero carbon dioxide emissions. Compressed Natural Gas (CNG) or Liquified Natural Gas (LNG) are flowed into a 1^{st} recuperator, 2^{nd} recuperator, into a turbo expander and then into a wave energy source for converting the hydrogen and carbon containing molecules into hydrogen and graphite. Hydrogen is cooled in the 2^{nd} recuperator, then compressed in a turbo compressor and further cooled in the 1^{st} recuperator. Due to its much higher molecular weight carbon is separated from the hydrogen via a density separator incorporated with the wave energy source. The present invention provides a wave energy system, method and process for converting silicon dioxide to silicon by coupling hydrogen with a wave energy source with a transmitted power density (TPD) greater than 1000 w/cm² for melting the silicon dioxide and then combusting the Oxygen off-gas with hydrogen for producing power. Likewise, the present invention provides for a mobile EV Recharger and Hydrogen fueling station via converting saturated hydrocarbons such as alkanes to hydrogen and carbon and using the expansion thereof for example methane to hydrogen and carbon (expands 4 times by volume) to drive a turbogenerator. The present invention provides a MagnetoHydroDynamic Generator by converting a hydrocarbon to an ionized stream of hydrogen and carbon and using the expansion thereof and the conductive plasma to produce a direct current (DC). Furthermore, the present invention provides for an electrode susceptor for coupling to an induction source, DC source, AC source or any combination thereof. Also, the present invention provides for an air breathing hypersonic scramjet engine. In addition, the present invention includes a metal oxide graphite composite suitable for use as a susceptor, electrode and/or transistor.

It is understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

1. An apparatus comprising:
a wave energy source having a cylindrical hole;
a cylindrical susceptor at least partially disposed within the cylindrical hole of the wave energy source such that a gap is formed between an outside wall of the cylindrical susceptor and an inside wall of the cylindrical hole, wherein an exterior of the cylindrical susceptor is coated or impregnated with a non-oxidizing material; and
wherein the wave energy source generates a wave energy, and the cylindrical susceptor absorbs the wave energy and converts the wave energy to heat.

2. The apparatus of claim 1, further comprising a partial hollow bore along a longitudinal axis of the cylindrical susceptor such that the cylindrical susceptor is open at a first end and closed at a second end.

3. The apparatus of claim 2, wherein the first end of the cylindrical susceptor is enlarged.

4. The apparatus of claim 1, wherein the gap comprises a first gap, and further comprising a pipe, conduit or tube partially inserted into the partial hollow bore of the cylindrical susceptor such that a second gap is formed between an inside of the partial hollow bore and the pipe, conduit or tube, and the pipe, conduit or tube does not extend to a bottom of the partial hollow bore.

5. The apparatus of claim 4, wherein a fluid is heated by flowing the fluid into and through the pipe, conduit or tube such that the fluid exits the pipe, conduit or pipe near a bottom of the partial hollow bore, and flows through the second gap.

6. The apparatus of claim 5, wherein the fluid is further heated by flowing the fluid through the first gap.

7. The apparatus of claim 1, wherein the second end of the cylindrical susceptor comprises a porous tip.

8. The apparatus of claim 7, wherein:
the porous tip is within or close to wave energy source; and
a fuel is fed into the partial hollow bore, and a combustion air or oxidant is fed axially or in a vortex, whirl or swirl flow through the gap.

9. The apparatus of claim 8, wherein the combustion air or oxidant is supersonic.

10. The apparatus of claim 8, further comprising a nozzle attached to the wave energy source.

11. The apparatus of claim 8, wherein the cylindrical susceptor comprises a first cylindrical susceptor having an enlarged first end, and further comprising a second cylindrical susceptor having an enlarged first end attached to the enlarged end of the first cylindrical susceptor.

12. The apparatus of claim 8, further comprising a nose cone attached to the first end of the cylindrical susceptor.

13. The apparatus of claim 1, further comprising a full hollow bore along a longitudinal axis of the cylindrical susceptor such that the cylindrical susceptor is open at a first end and open at a second end.

14. The apparatus of claim 13, further comprising a rotary drive coupled to the cylindrical susceptor.

15. The apparatus of claim 13, further comprising a screw feeder or ram feeder coupled to the first end the cylindrical susceptor.

16. The apparatus of claim 13, further comprising:
an end piece attached to the wave energy source such that the second end of the cylindrical susceptor extends into the end piece, wherein the end piece has a bottom outlet; and
a gas outlet connected to the gap.

17. The apparatus of claim 13, wherein a solid material is fed into the first end of the cylindrical susceptor.

18. The apparatus of claim 17, wherein the solid material comprises rawmix, sand, silica, metal shavings, pelletized material, wood chips, biomass, biosolids, sludge briquettes, or granular material.

19. The apparatus of claim 7, further comprising:
a column having a top, an upper side outlet, an upper side inlet and a bottom outlet;
the wave energy source disposed within, integrated into, or attached to a portion of the column;
a riser feeder partially disposed within the column and extending through the top of the column, the riser feeder having a top inlet and a bottom outlet; and
the first end of the cylindrical susceptor attached to the bottom outlet of the riser feeder.

20. The apparatus of claim 19, wherein the wave energy source and the cylindrical susceptor are position within a middle portion of the column or a lower portion of the column.

21. The apparatus of claim 19, wherein the riser feeder is moveable within the column.

22. The apparatus of claim 19, wherein the column further comprises a lower side inlet.

23. The apparatus of claim 19, further comprising:
a heat exchanger coupled to the upper inlet of the column; and
a vapor compressor having an inlet coupled to the upper outlet of the column and an output coupled to the top inlet of the feeder riser and the heat exchanger.

24. The apparatus of claim 23, wherein saltwater is fed into the heat exchanger, distilled water exits the heat exchanger, brine exits the lower outlet of the column, and steam exits the upper side outlet of the column.

25. The apparatus of claim 7, wherein:
hydrogen is fed into the first end of the cylindrical susceptor, heated by the cylindrical susceptor and exits the porous tip of the cylindrical susceptor; and
silica is fed into the gap and reacts with the heated hydrogen to produce steam and silicon.

26. A method comprising:
providing a wave energy source having a cylindrical hole, and a cylindrical susceptor at least partially disposed within the cylindrical hole of the wave energy source such that a gap is formed between an outside wall of the cylindrical susceptor and an inside wall of the cylindrical hole, wherein an exterior of the cylindrical susceptor is coated or impregnated with a non-oxidizing material;
generating a wave energy using the wave energy source;
heating the cylindrical susceptor using the wave energy; and
heating a gas, liquid or solid using the cylindrical susceptor, the wave energy or both.

27. The method of claim 26, wherein the cylindrical susceptor further comprises a partial hollow bore along a longitudinal axis of the cylindrical susceptor such that the cylindrical susceptor is open at a first end and closed at a second end.

28. The method of claim 27, wherein the first end of the cylindrical susceptor is enlarged.

29. The method of claim 26, wherein the gap comprises a first gap, and further comprising a pipe, conduit or tube partially inserted into the partial hollow bore of the cylindrical susceptor such that a second gap is formed between an inside of the partial hollow bore and the pipe, conduit or tube, and the pipe, conduit or tube does not extend to a bottom of the partial hollow bore.

30. The method of claim 29, wherein the fluid is heated by flowing the fluid into and through the pipe, conduit or tube such that the fluid exits the pipe, conduit or pipe near a bottom of the partial hollow bore, and flows through the second gap.

31. The method of claim 30, wherein the fluid is further heated by flowing the fluid through the first gap.

32. The method of claim 26, wherein the second end of the cylindrical susceptor comprises a porous tip.

33. The method of claim 32, wherein:
the porous tip is within or close to wave energy source; and
a fuel is fed into the partial hollow bore, and a combustion air or oxidant is fed axially or in a vortex, whirl or swirl flow through the gap.

34. The method of claim 33, wherein the combustion air or oxidant is supersonic.

35. The method of claim 33, further comprising a nozzle attached to the wave energy source.

36. The method of claim 33, wherein the cylindrical susceptor comprises a first cylindrical susceptor having an enlarged first end, and further comprising a second cylindrical susceptor having an enlarged first end attached to the enlarged end of the first cylindrical susceptor.

37. The method of claim 33, further comprising a nose cone attached to the first end of the cylindrical susceptor.

38. The method of claim 26, wherein the cylindrical susceptor further comprises a full hollow bore along a longitudinal axis of the cylindrical susceptor such that the cylindrical susceptor is open at a first end and open at a second end.

39. The method of claim 38, further comprising rotating the cylindrical susceptor using a rotary drive coupled to the cylindrical susceptor.

40. The method of claim 38, further comprising feeding the solid or a semi-solid into the first end of the cylindrical susceptor using a screw feeder or ram feeder coupled to the first end the cylindrical susceptor.

41. The method of claim 38, further comprising:
an end piece attached to the wave energy source such that the second end of the cylindrical susceptor extends into the end piece, wherein the end piece has a bottom outlet; and
a gas outlet connected to the gap.

42. The method of claim 38, further comprising feeding a solid material into the first end of the cylindrical susceptor.

43. The method of claim 42, wherein the solid material comprises rawmix, sand, silica, metal shavings, pelletized material, wood chips, biomass, biosolids, sludge briquettes, or granular material.

44. The method of claim 42, further comprising:
a column having a top, an upper side outlet, an upper side inlet and a bottom outlet;
the wave energy source disposed within, integrated into, or attached to a portion of the column;
a riser feeder partially disposed within the column and extending through the top of the column, the riser feeder having a top inlet and a bottom outlet; and
the first end of the cylindrical susceptor attached to the bottom outlet of the riser feeder.

45. The method of claim 44, wherein the wave energy source and the cylindrical susceptor are position within a middle portion of the column or a lower portion of the column.

46. The method of claim 44, further comprising moving the riser feeder within the column.

47. The method of claim 44, wherein the column further comprises a lower side inlet.

48. The method of claim 44, further comprising:
a heat exchanger coupled to the upper inlet of the column; and
a vapor compressor having an inlet coupled to the upper outlet of the column and an output coupled to the top inlet of the feeder riser and the heat exchanger.

49. The method of claim 48, wherein saltwater is fed into the heat exchanger, distilled water exits the heat exchanger, brine exits the lower outlet of the column, and steam exits the upper side outlet of the column.

50. The method of claim 32, further comprising:
feeding hydrogen into the first end of the cylindrical susceptor such that the hydrogen is heated by the cylindrical susceptor and exits the porous tip of the cylindrical susceptor; and
feeding silica into the gap such that the silica reacts with the heated hydrogen to produce steam and silicon.

51-73. (canceled)
